(19) United States
(12) Patent Application Publication
(10) Pub. No.: US 2011/0063473 A1
(43) Pub. Date: Mar. 17, 2011

(54) IMAGE PROCESSING DEVICE, IMAGE PROCESSING METHOD, AND IMAGING DEVICE

(75) Inventors: Norikazu Tsunekawa, Osaka (JP); Seiji Okada, Osaka (JP); Akihiro Maenaka, Osaka (JP)

(73) Assignee: SANYO ELECTRIC CO., LTD., Osaka (JP)

(21) Appl. No.: 12/994,843

(22) PCT Filed: Oct. 6, 2009
(86) PCT No.: PCT/US09/59627

§ 371 Date: Nov. 26, 2010

(30) Foreign Application Priority Data
Oct. 6, 2008 (US) 12245951

(51) Int. Cl. H04N 5/225

(52) U.S. Cl. 348/222.1; 348/E05.024

(57) ABSTRACT

A color interpolation process unit (51) successively acquires from an AFE (12), a plurality of original images in which the pixel positions having pixel signals are different and executes a color interpolation process on the original images to generate a color-interpolated image. An image synthesis unit (54) combines the color-interpolated image (current frame) to be generated and a synthesis image (previous frame) outputted previously so as to generate a synthesis image. The synthesis image is inputted to a color synchronization process unit (55) to output a video signal and stored in a frame memory (52) so as to be used for synthesis of the next frame.

### TECHNICAL FIELD

The present invention relates to a device and a method for performing image processing on an acquired source image (original image), and also relates to an imaging device (image taking, shooting, or otherwise acquiring device) such as a digital video camera.

### BACKGROUND ART

In a case where a moving image (motion picture, movie, video) is shot by use of an image sensor (image sensing device) that is capable of shooting a still image (still picture, photograph) with a large number of pixels, the frame rate needs to be held low in accordance with the rate at which pixel signals are read from the image sensor. To achieve a high frame rate, the amount of image data needs to be reduced by binned (additive) reading or skipped (thinned-out) reading of pixel signals.

A problem here is that, while the pixel intervals on the image sensor are even in both the horizontal and vertical directions, performing binned or skipped reading causes pixel signals to be present at uneven intervals. If an image having such unevenly arrayed pixel signals is displayed unprocessed, jaggies and false colors result. As a technique for avoiding the problem, there has been proposed one involving interpolation that is so performed as to make pixel signals present at even intervals (for example, see Patent Documents 1 and 2 listed below).

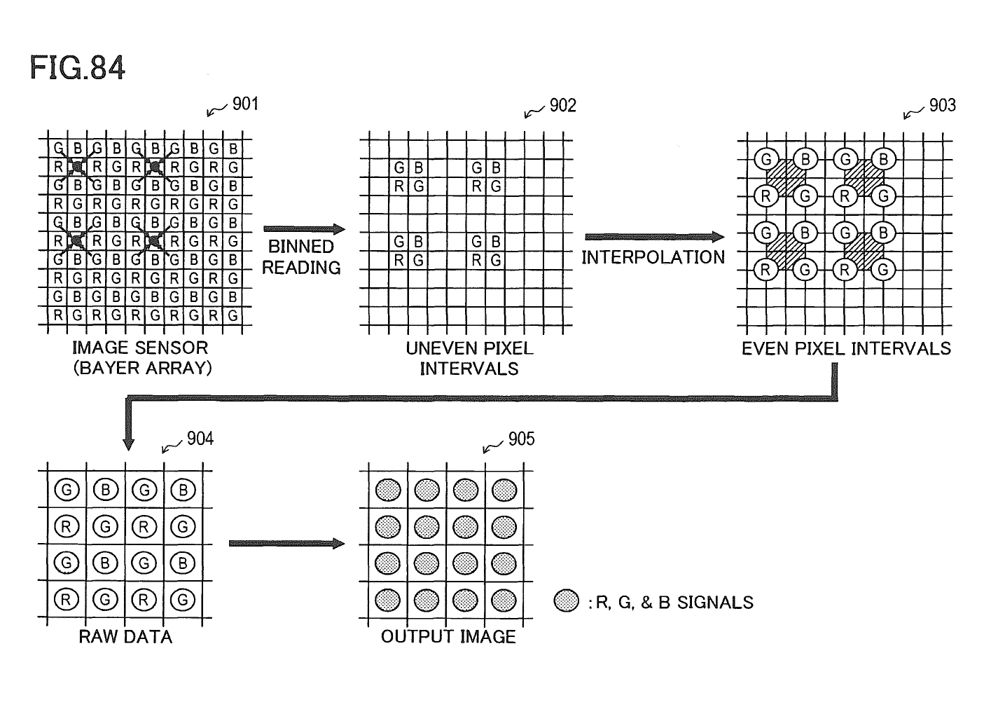

This technique will now be described with reference to FIG. 84. In FIG. 84, block 901 shows a color filter array (Bayer array) placed in front of photosensitive pixels of an image sensor for a single-panel configuration. Block 902 shows the positions of R, G, and B signals obtained from the image sensor by binned reading. In binned reading, the pixel signals of pixels close to a position of attention are added up, and the resulting sum signal is read, as the pixel signal at the position of attention, from the image sensor. For example, with respect to a position of attention at which a G signal is to be generated, the pixel signals of real photosensitive pixels adjacent to that position on its upper left, upper right, lower left, and lower right are added up, and thereby the G signal at the position of attention is generated. In FIG. 84, solid black circles indicate positions of attention with respect to G signals, and arrows pointing to those circles indicate how signals are added up; with respect to B and R signals too, similar binned reading is performed.

As shown in block 902, in an image obtained by binned reading, pixel intervals are uneven. Through interpolation that is so performed as to correct the uneven pixel intervals to even ones, an image is obtained that has a pixel signal array as shown in blocks 903 and 904, that is, an image that has R, G, and B signals arrayed like a Bayer array. The image (RAW data) shown in block 904 is subjected to so-called demosaicing (color reconstruction, color synchronization), and thereby an output image as shown in block 905 is obtained. The output image is a two-dimensional image having pixels arrayed at even intervals in both the horizontal and vertical directions. In the output image, every pixel is assigned an R, a G, and a B signal.

On the other hand, as a technique for reducing noise contained in an output image obtained in a way as described above, there has been proposed one that achieves noise elimination by use of images of a plurality of fields (frames) (see, for example, Patent Document 3 listed below).

### Citation List

### Patent Literature

Patent Document 1: JP-A-2003-092764
Patent Document 2: JP-A-2003-299112
Patent Document 3: JP-A-2000-201283

### SUMMARY OF THE INVENTION

### Technical Problem

Certainly, in an output image obtained by use of a conventional technique like that shown in FIG. 84, the pixel intervals at which R, G, and B signals are present are even, and this suppresses jaggies and false colors. However, canceling the unevenness in pixel intervals resulting from binned reading requires performing interpolation for making pixel intervals even. Performing such interpolation inevitably invites degradation in perceived resolution (degradation in practical resolution). Skipped reading of pixel signals suffers from a similar problem.

Certainly, to reduce noise in an output image, since noise occurs randomly, it is suitable to use images of a plurality of frames as in a conventional technique. However, that requires frame memories for temporarily storing images to be used for noise reduction, leading to the problem of an increased circuit scale. In particular, since processing other than noise reduction (for example, resolution enhancement) also requires stored images and hence frame memories, a large number of frame memories need to be provided overall, resulting in an increased circuit scale.

In view of the foregoing, an object of the present invention is to provide an image processing device, an imaging device, and an image processing method that contribute to suppression of degradation in perceived resolution possibly resulting from binned or skipped reading of pixel signals as well as to reduction of noise and that help suppress an increase in circuit scale.

### Solution to Problem

To achieve the above object, according to the present invention, an image processing device includes: a source image acquiring section which performs binned reading or skipped reading of pixel signals of a group of photosensitive pixels arrayed two-dimensionally in an image sensor for a single-panel configuration, and which thereby acquires source images sequentially; a color interpolation section which, for each of the source images, mixes pixel signals of a same color included in a group of pixel signals of the source images, and which thereby generates color-interpolated images sequentially that have pixel signals obtained by the mixing; and a destination image generation section which generates destination images based on the color-interpolated images. Here, the source image acquiring section uses a plurality of reading patterns having different combinations of photosensitive pixels targeted by binning or skipping, so as to generate the source images sequentially such that pixel positions at which pixel signals are present differ between frames.

In the description of embodiments below, as examples of the destination images, output blended images and converted images will be taken up.

Preferably, for example, the destination image generation section includes: a storage section which temporarily stores a predetermined image inputted thereto and then outputs the predetermined image; and an image blending section which blends together the predetermined image outputted from the storage section and the color-interpolated images, and which thereby generates preliminary images. Moreover, the destination images are generated based on the preliminary images, or the preliminary images are taken as the destination images.

With this configuration, by blending the predetermined image, which was generated in the past, with the color-interpolated images, the preliminary images are generated. For example, the image blending section may blend together the color-interpolated image of the nth frame and the predetermined image of the (n−1)th to generate the destination image of the nth frame. In the description of embodiments below, as examples of the predetermined image, blended images and color-interpolated images will be taken up; as examples of the preliminary images, blended images and output blended images will be taken up.

Furthermore, with this configuration, the images that are blended together by the image blending section are, other than the color-interpolated images inputted sequentially, the predetermined image alone. Thus, performing the above blending only requires the provision of a storage section that stores one predetermined image. It is thus possible to suppress an increase in circuit scale.

Preferably, for example, the destination image generation section further includes a motion detection section which detects a motion of an object between the color-interpolated images and the predetermined image that are blended together at the image blending section. Moreover, the image blending section generates the preliminary images based on the magnitude of the motion.

For example, the motion detection section may detect a motion of an object by finding an optical flow between the color-interpolated images and the predetermined image.

Preferably, for example, the image blending section includes: a weight coefficient calculation section which calculates a weight coefficient based on the magnitude of the motion detected by the motion detection section; and a blending section which generates the preliminary images by mixing pixel signals of the color-interpolated images and the predetermined image according to the weight coefficient.

In this way, it is possible to suppress blurred edges and double images in the preliminary images and the destination images.

Preferably, for example, the image blending section further includes an image characteristics amount calculation section which calculates, with respect to the color-interpolated images, an image characteristics amount indicating a characteristic of pixels neighboring a pixel of attention. Moreover, the weight coefficient calculation section sets the weight coefficient based on the magnitude of the motion and the image characteristics amount.

As the image characteristics amount, it is possible to use, for example, the standard deviation of pixel signals of a color-interpolated image, a high-frequency component (for example, a result of applying a high-pass filter to a color-interpolated image), or an edge component (for example, a result of applying a differential filter to a color-interpolated image). The image characteristics amount calculation section may calculate the image characteristics amount from pixel signals representing the luminance of a color-interpolated image.

Preferably, for example, the image blending section further includes a contrast amount calculation section which calculates a contrast amount of at least one of the color-interpolated images and the predetermined image. Moreover, the weight coefficient calculation section sets the weight coefficient based on the magnitude of the motion of the object as detected by the motion detection section and the contrast amount.

Preferably, the color-interpolated images and the preliminary images are images having one pixel signal present at every interpolated pixel position and, between the color-interpolated images and the preliminary images, locations of corresponding pixel signals within the images are equal or shifted by a predetermined magnitude; the destination image generation section further includes a color reconstruction section which applies color reconstruction to the preliminary images to make a plurality of pixel signals of different colors present at every interpolated pixel position, and which thereby generates the destination images; the storage section temporarily stores the preliminary images as the predetermined image and then outputs the preliminary images to the image blending section; and the image blending section mixes corresponding pixel signals of the color-interpolated images and the preliminary images, and thereby generates new preliminary images.

In this way, it is possible to prevent pixel signals that do not correspond between the color-interpolated images and the preliminary images from being blended together, and thereby to suppress degradation in the new preliminary images and the destination images. In the description of Examples 1 to 6 of Embodiment 1 below, as an example of the position of a pixel signal within an image, the horizontal and vertical pixel numbers i and j will be taken up.

Preferably, for example, the color-interpolated images are images having one pixel signal present at every interpolated pixel position; the destination image generation section further includes: a color reconstruction section which applies color reconstruction to the color-interpolated images to make a plurality of pixel signals of different colors present at every interpolated pixel position, and which thereby generates color-reconstructed images; a storage section which temporarily stores the destination images outputted from the destination image generation section, and which then outputs the destination images; and an image blending section which blends together the destination images outputted from the storage section and the color-reconstructed images, and which thereby generates new destination images. Moreover, between the color-reconstructed images and the destination images, locations of corresponding pixel signals within the images are equal or shifted by a predetermined magnitude; the image blending section mixes corresponding pixel signals of the color-reconstructed images and the destination images, and thereby generates the new destination images.

In this way, it is possible to prevent pixel signals that do not correspond between the color-reconstructed images and the destination images from being blended together, and thereby to suppress degradation in the new destination images. In the description of Example 7 of Embodiment 1 below, as an example of the position of a pixel signal within an image, the horizontal and vertical pixel numbers i and j will be taken up.

Preferably, for example, the color-interpolated images outputted from the color interpolation section are inputted to the image blending section, and are also inputted as the predetermined image to the storage section; the image blending section blends together the color-interpolated images outputted from the color interpolation section and the color-interpolated images outputted from the storage section, and thereby generates the destination images.

Preferably, for example, the destination image generation section include an image conversion section which applies image conversion to the color-interpolated images to make a plurality of pixel signals of different colors present at every interpolated pixel position, and thereby generates the destination images.

Preferably, for example, a group of pixel signals of the color-interpolated images includes pixel signals of a plurality of colors including a first color; intervals of particular interpolated pixel positions at which pixel signals of the first color are present are uneven.

With this configuration, it is possible to obtain an uneven color-interpolated image without performing processing corresponding to the interpolation shown in FIG. 84 for making pixel position intervals even. It is thus possible to suppress degradation in perceived resolution resulting from the interpolation shown in FIG. 84. The problems that can result from not performing the interpolation can be coped with, for example, by blending together a plurality of color-interpolated images generated from a plurality of source images, or by outputting a plurality of destination images as a moving image.

Preferably, for example, when one of the source images on which interest is currently being focused is called a source image of interest, the one of the color-interpolated images which is generated from the source image of interest is called a color-interpolated image of interest, and pixel signals of one color on which interest is currently being focused is called pixel signals of a color of interest, the color interpolation section sets the particular interpolated pixel positions at positions different from pixel positions at which the pixel signals of the color of interest are present on the source image of interest, and generates as the color-interpolated image of interest an image having the pixel signals of the color of interest at the particular interpolated pixel positions; when the color-interpolated image of interest is generated, based on a plurality of pixel positions on the source image of interest at which the pixel signals of the color of interest are present, a plurality of the pixel signals of the color of interest at those pixel positions are mixed, and thereby the pixel signals of the color of interest at the particular interpolated pixel positions are generated; and the particular interpolated pixel positions are set at center-of-gravity positions of a plurality of pixel positions at which the pixel signals of the color of interest are present on the source image of interest.

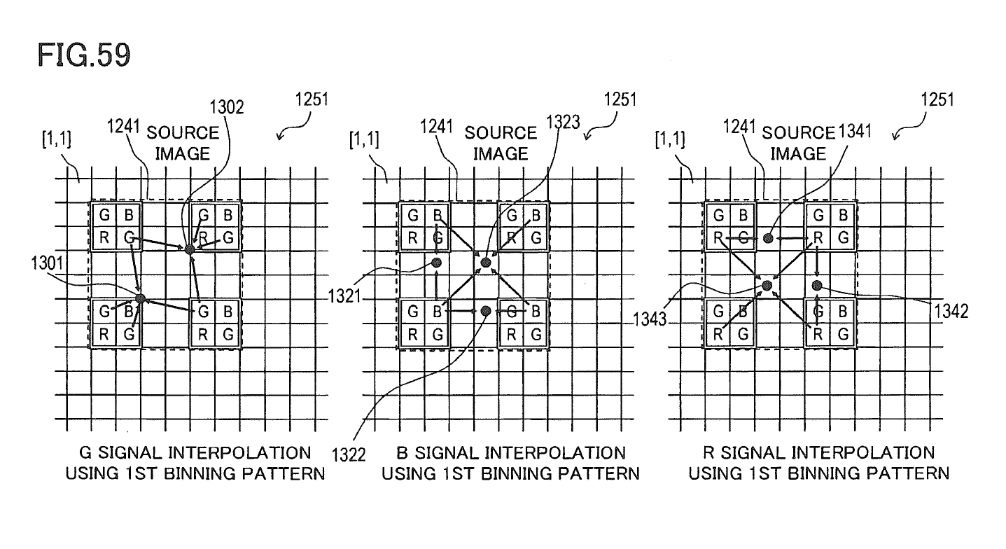

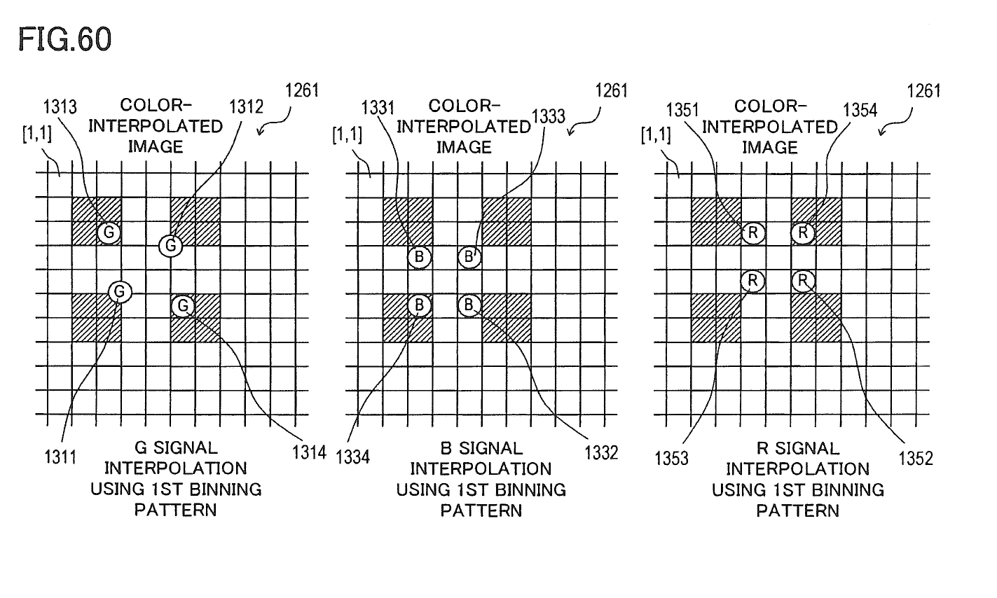

For example, in a case where the source image of interest and the color-interpolated image of interest are the source image 1251 shown in FIG. 59 and the color-interpolated image 1261 shown in FIG. 60 respectively, and where the color of interest is green and the interpolated pixel position is the interpolated pixel position 1301 shown in the left portion of FIG. 59, a particular interpolated pixel position (1301) is set at a position different from the pixel position at which a pixel of the color of interest (G signal) is present on the source image (1251), and an image having a pixel of the color of interest (G signal) at the particular interpolated pixel position (1301) is generated as the color-interpolated image of the color of interest (1261). At this time, attention is paid to a plurality of pixel positions on the source image of interest (1251) at which pixel signals of the color of interest (G signals) are present, and by mixing the plurality of pixel signals of the color of interest at the plurality of pixel positions, the pixel signal with respect to the particular interpolated pixel position (1301) is generated. And the particular interpolated pixel position (1301) is set at the center-of-gravity position of the plurality of pixel positions.

Preferably, for example, the color interpolation section mixes a plurality of the pixel signals of the color of interest of the source image of interest in an equal ratio, and thereby generates the pixel signals of the color of interest at the particular interpolated pixel positions.

By such mixing, the intervals of the pixel positions at which pixel signals of the first color are present are made uneven.

Preferably, for example, the destination image generation section generates each of the destination images based on a plurality of the color-interpolated images generated from a plurality of the source images; the destination images have pixel signals of a plurality of colors at each of interpolated pixel positions arrayed evenly; and the destination image generation section generates the destination images based on differences in the particular interpolated pixel positions among a plurality of the color-interpolated images due to a plurality of the color-interpolated images corresponding to different reading patterns.

Since the pixel intervals on the destination images are even, jaggies and false colors are suppressed in the destination images.

Preferably, for example, acquisition of a plurality of the source images by use of a plurality of the reading patterns is performed repeatedly, and thereby a series of chronologically ordered destination images is generated at the destination image generation section; the image processing device further includes an image compression section which applies image compression to the series of destination images, and which thereby generates a compressed moving image including an intra-coded picture and a predictive-coded picture; and based on how the destination images constituting the series of destination images are generated, the image compression section selects from the series of destination images a destination image to be handled as a target of the intra-coded picture.

This contributes to enhancement of the overall image quality of the compressed moving image.

Preferably, for example, a plurality of the destination images generated by the destination image generation section are outputted as a moving image.

Preferably, for example, there are a plurality of groups each including a plurality of reading patterns having different combinations of photosensitive pixels targeted by binning or skipping; the image processing device further includes a motion detection section which detects a motion of an object between a plurality of the color-interpolated images; and based on the direction of the motion detected by the motion detection section, a group of reading patterns used to acquire the source images is set variably.

In this way, a group of reading patterns fit for a motion of an object on the images is set variably in a dynamic fashion.

According to the invention, an imaging device includes: an image sensor for a single-panel configuration; and any one of the image processing devices described above.

According to the invention, an image processing method includes: a first step of performing binned reading or skipped reading of pixel signals of a group of photosensitive pixels arrayed two-dimensionally in an image sensor for a single-panel configuration by use of a plurality of reading patterns having different combinations of photosensitive pixels targeted by binning or skipping, and thereby acquiring source images sequentially such that pixel positions at which pixel signals are present differ between frames; a second step of mixing pixel signals of a same color included in a group of pixel signals of the source images obtained in the first step, and thereby generating color-interpolated images sequentially that have pixel signals obtained by the mixing; and a third step of generating destination images based on the color-interpolated images generated in the second step.

### Advantages of the Invention

According to the present invention, it is possible to provide an image processing device, an imaging device, and an image processing method that contribute to suppression of degradation in perceived resolution possibly resulting from binned or skipped reading of pixel signals and that help suppress an increase in circuit scale.

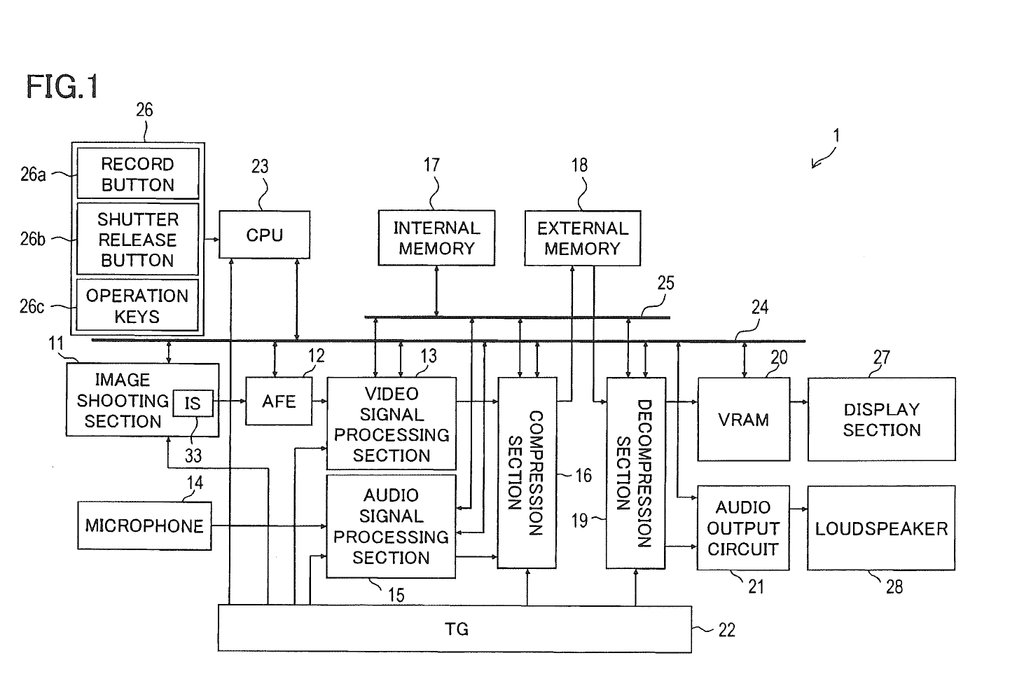

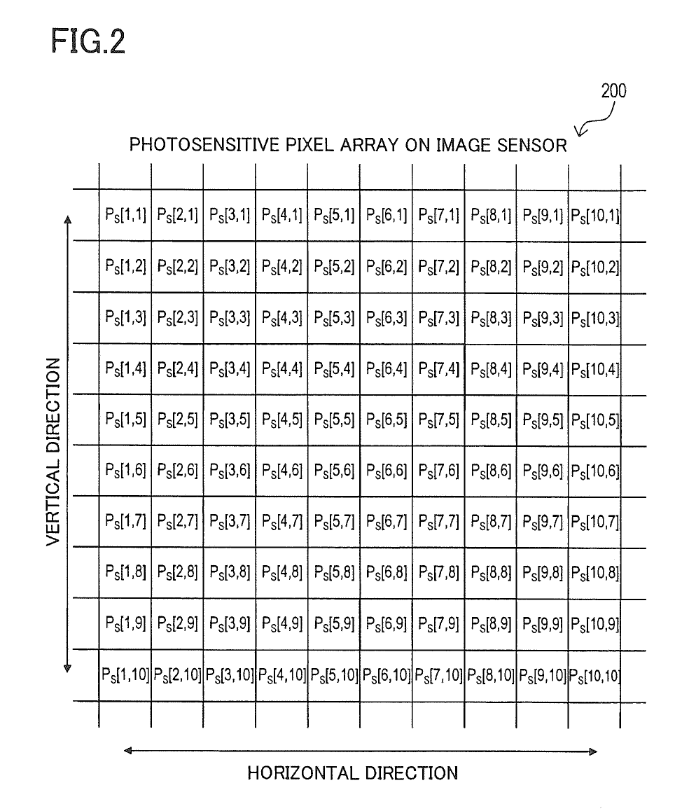

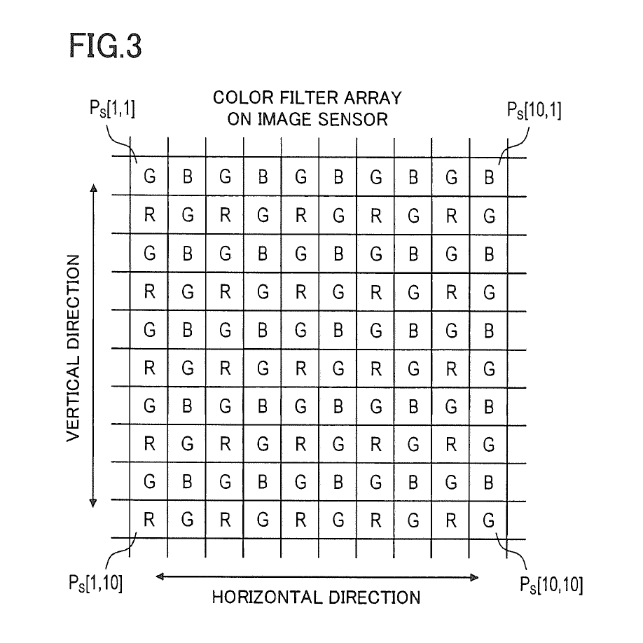

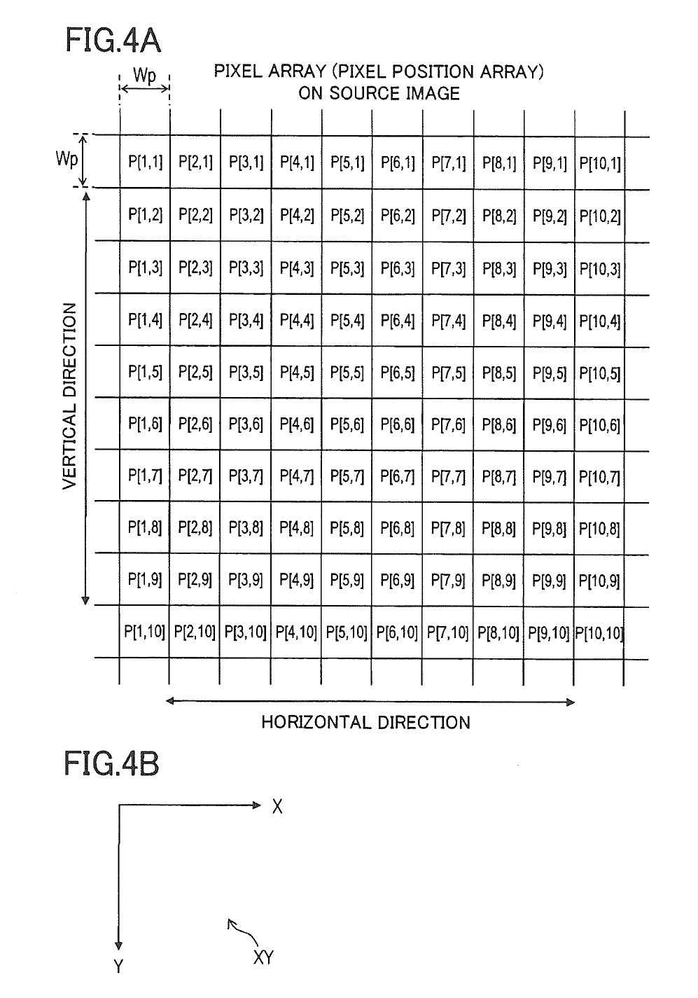

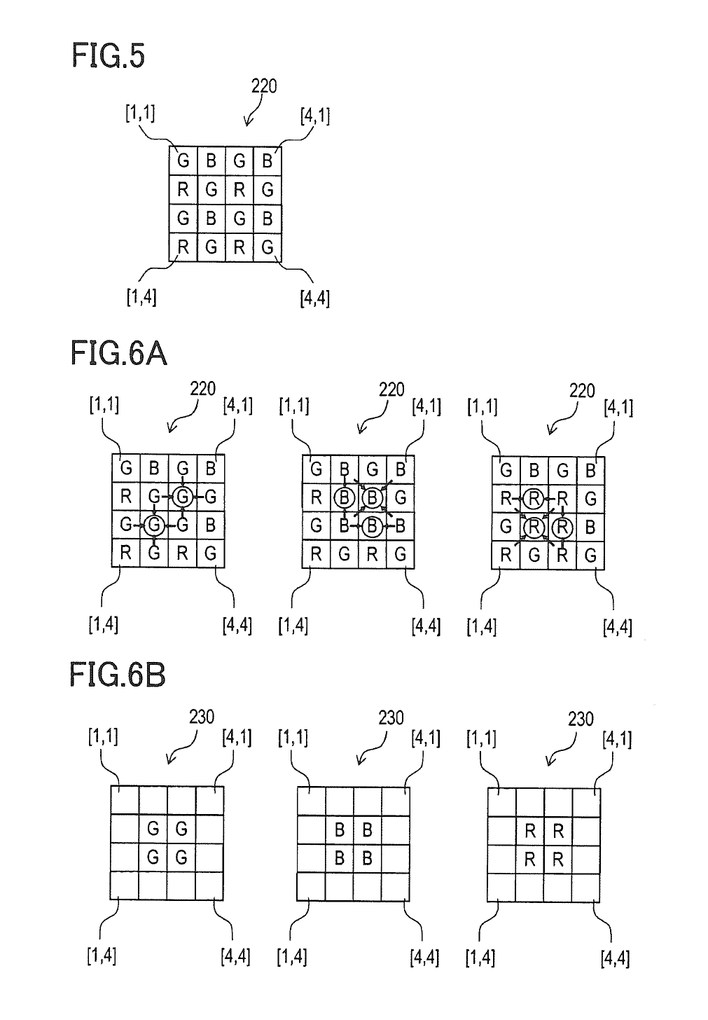

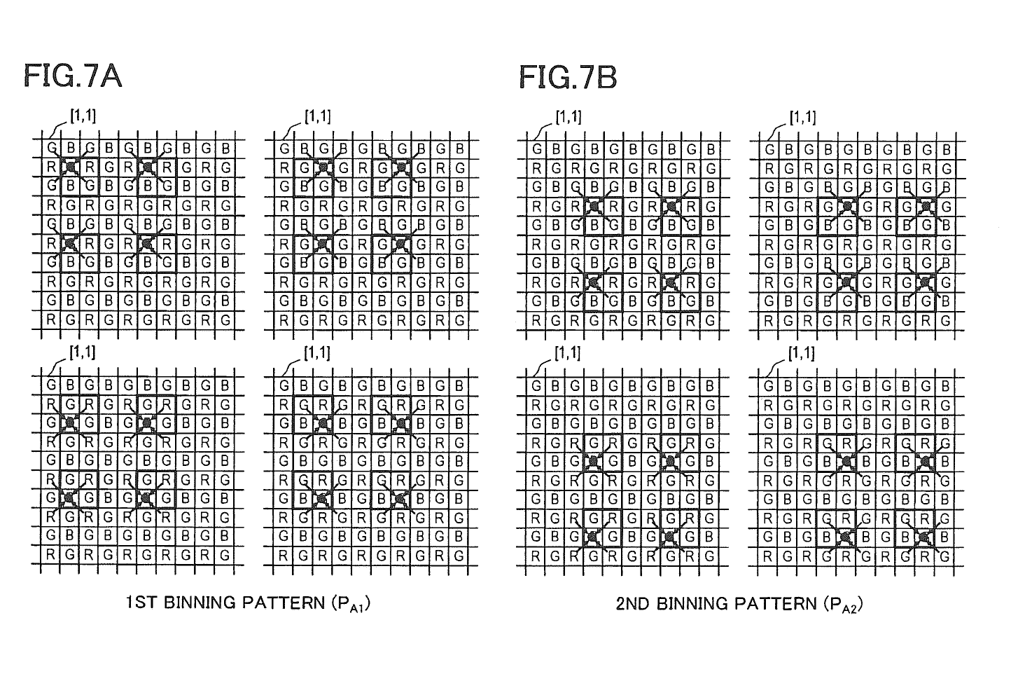

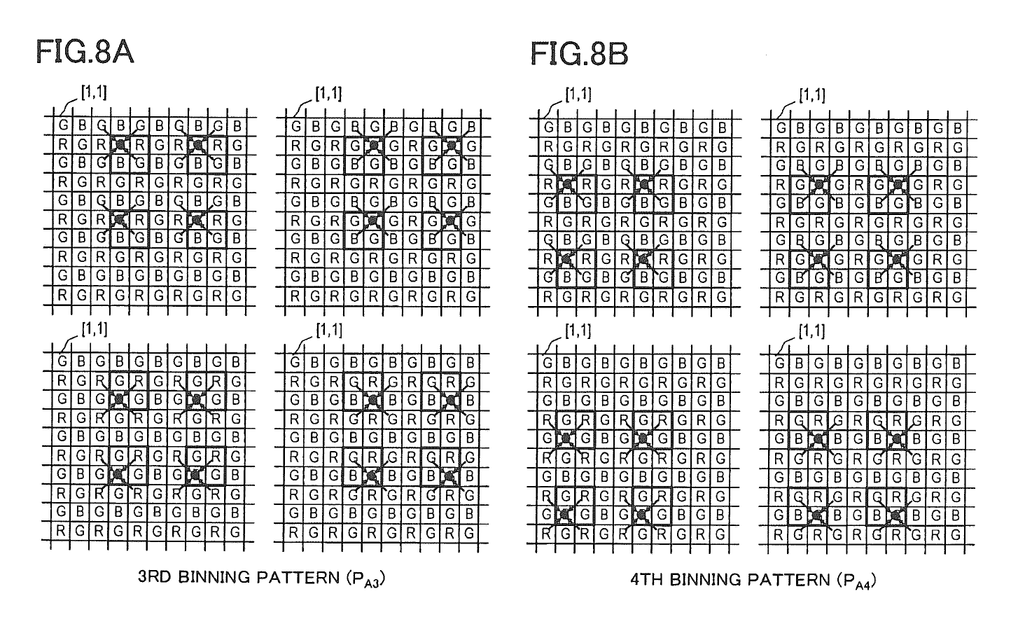

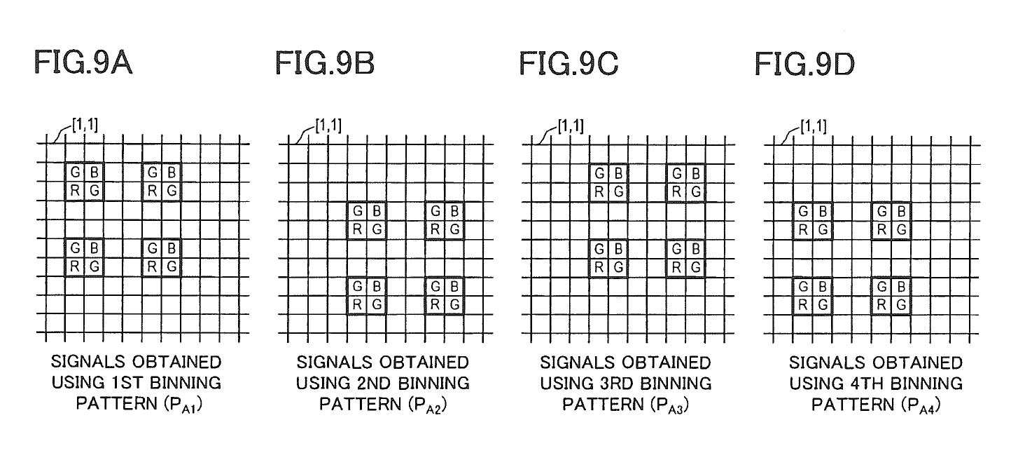

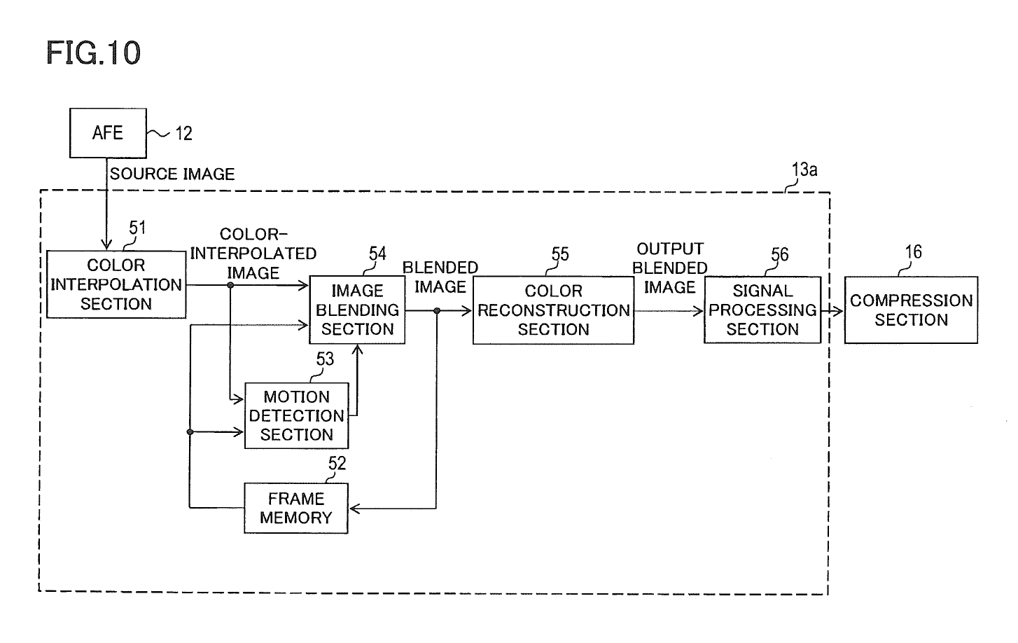

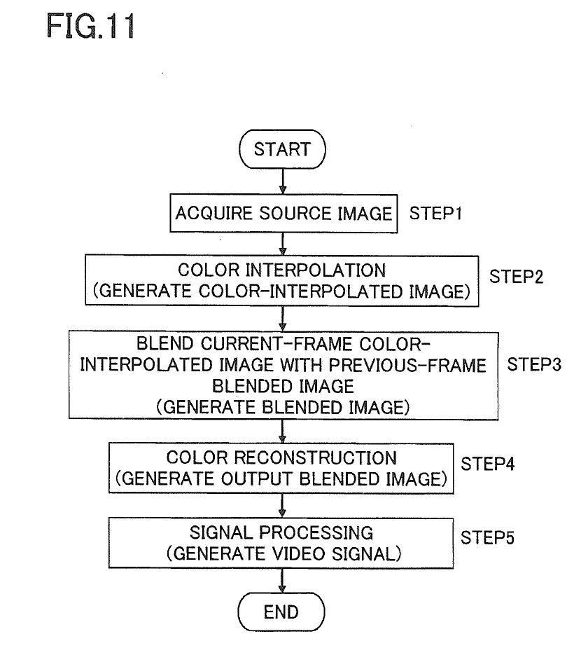

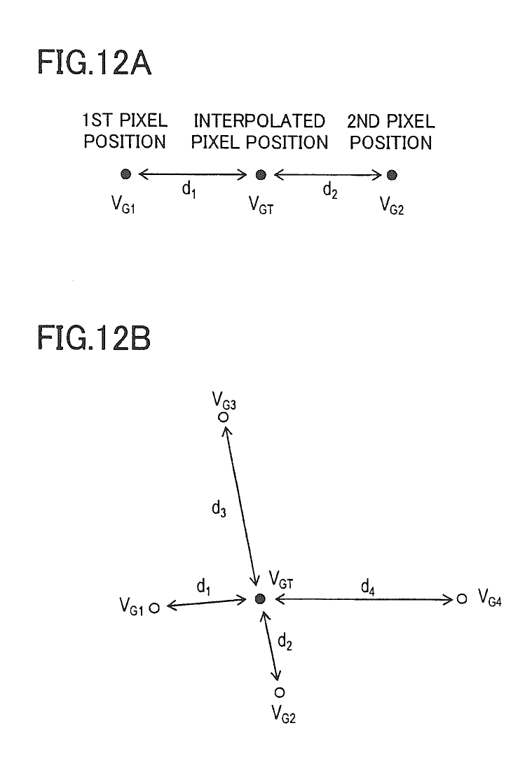

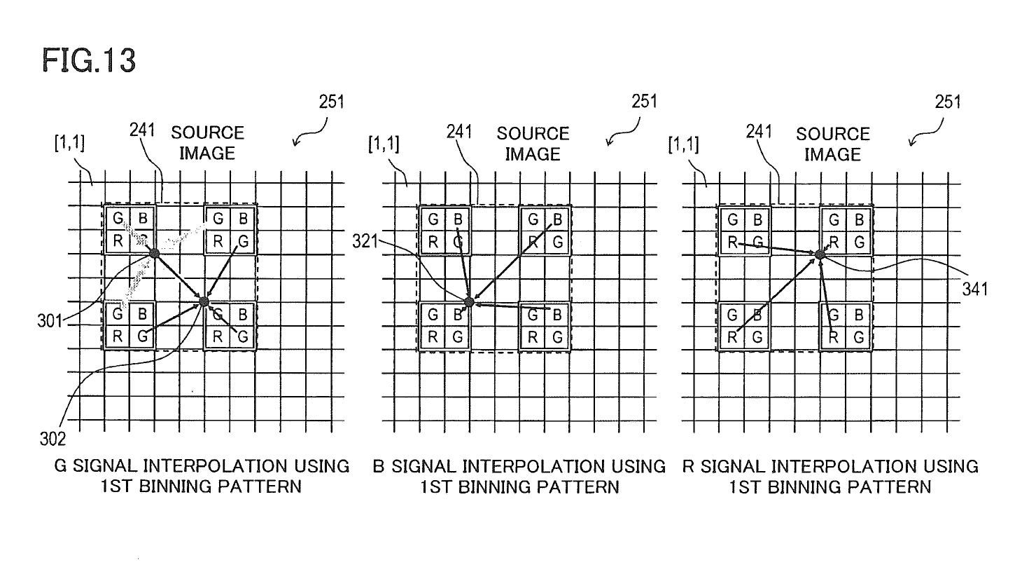

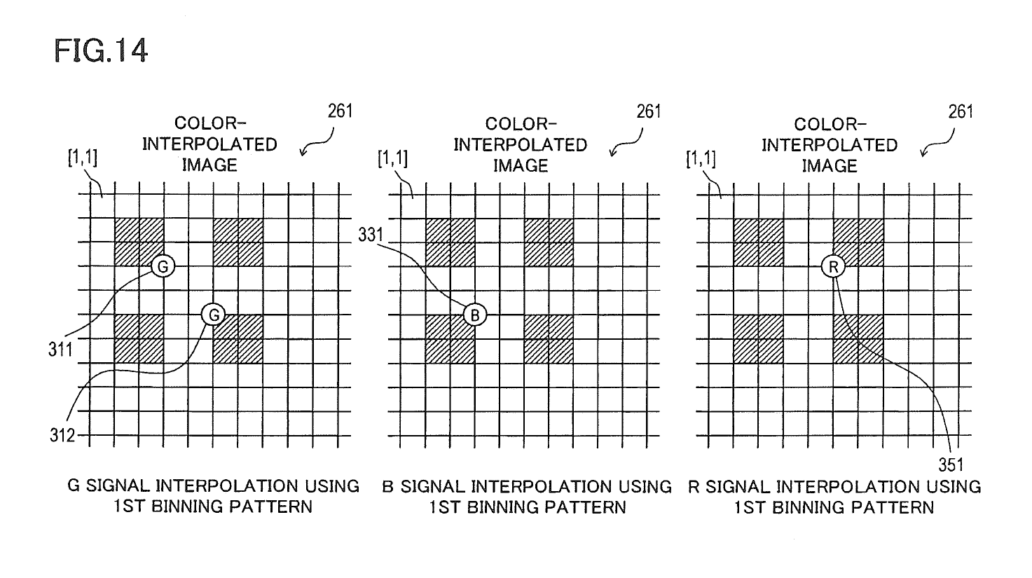

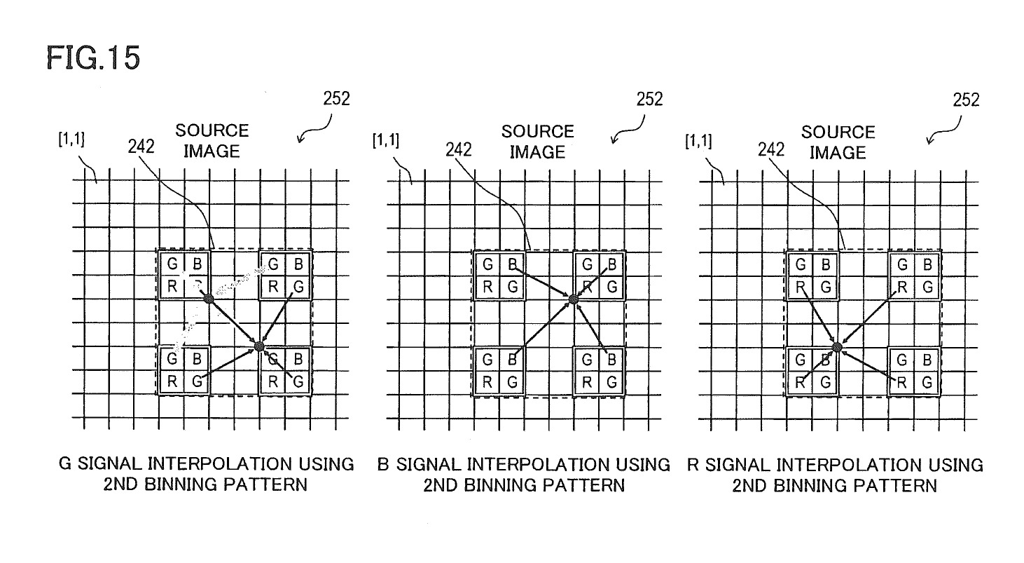

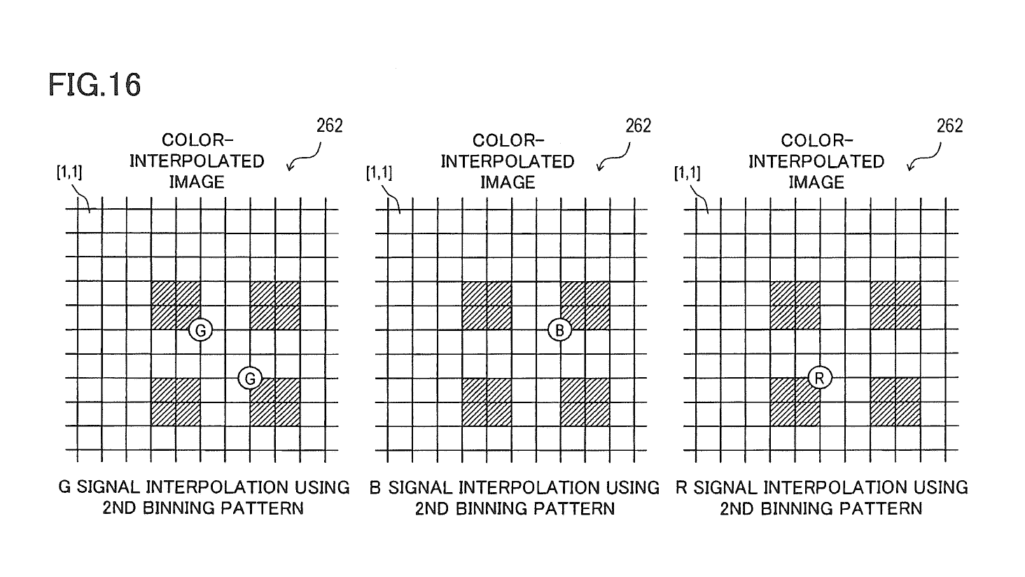

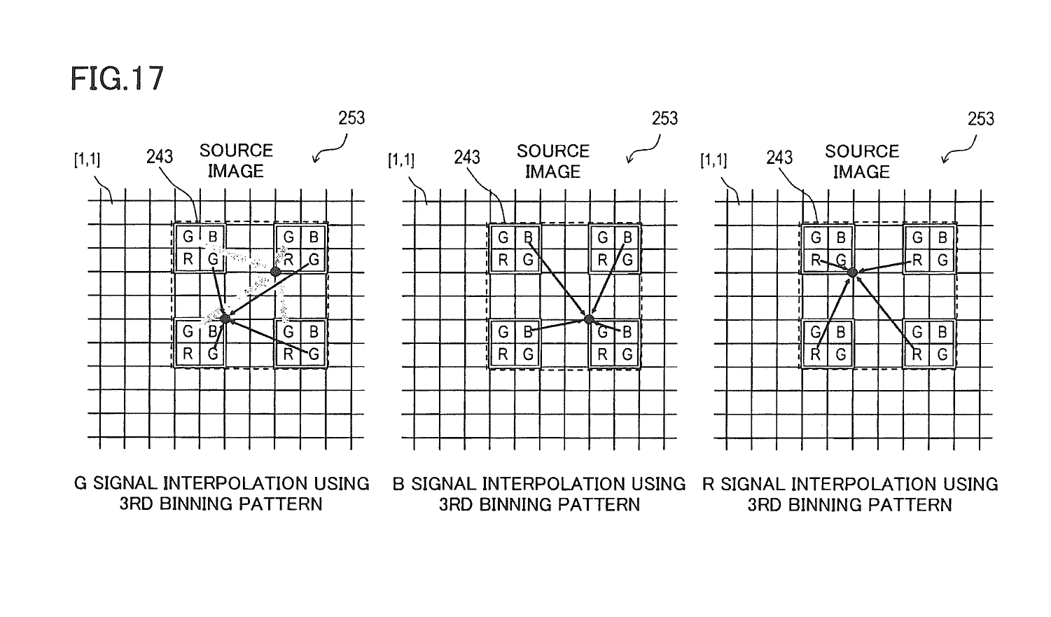

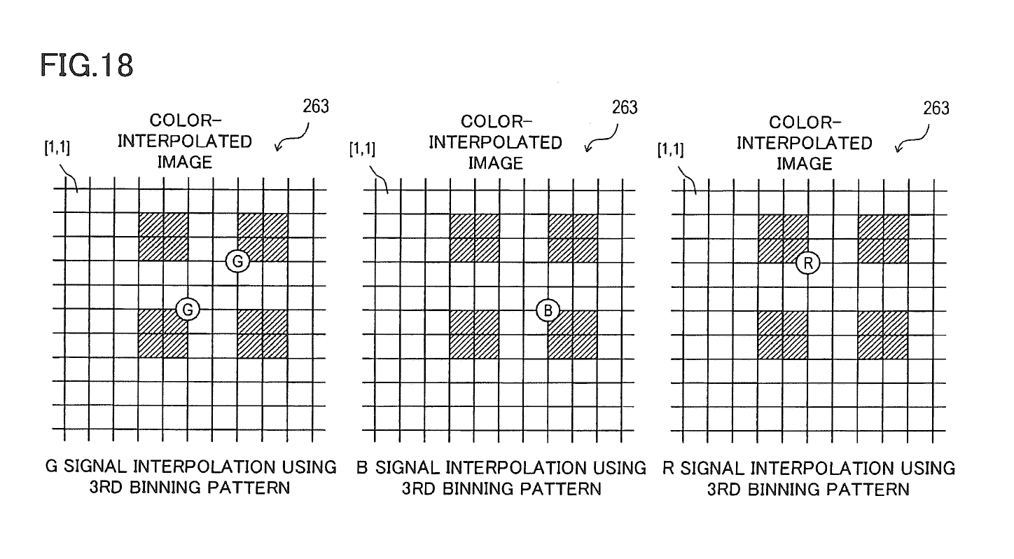

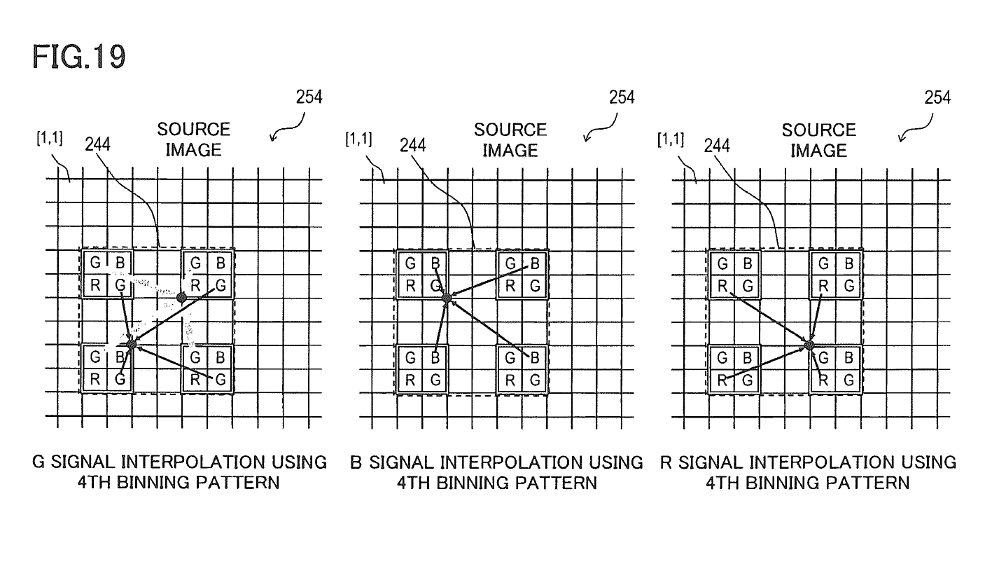

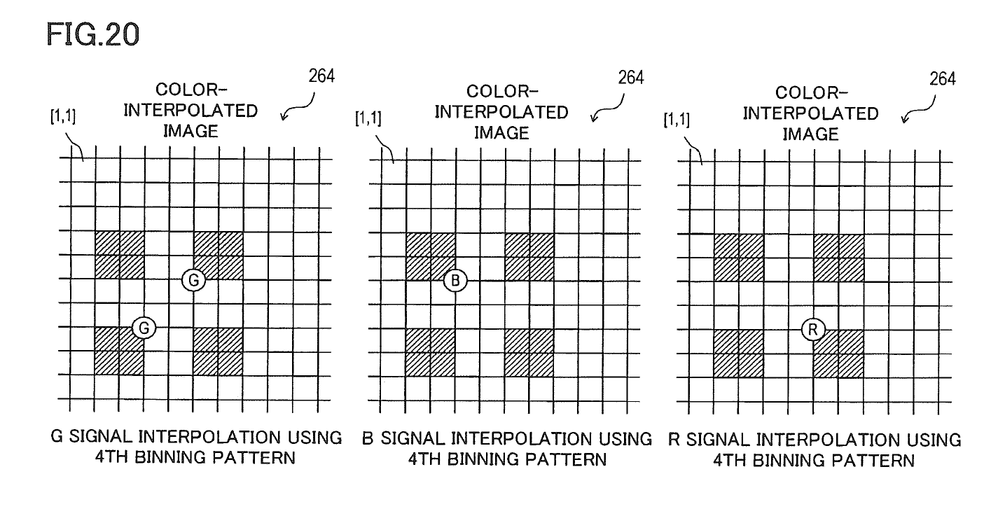

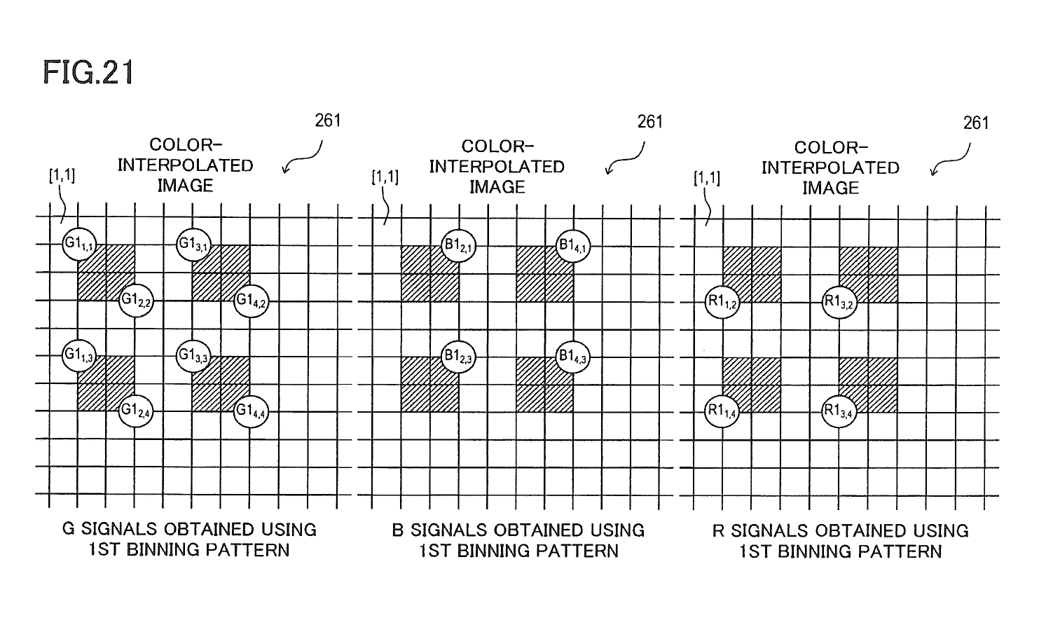

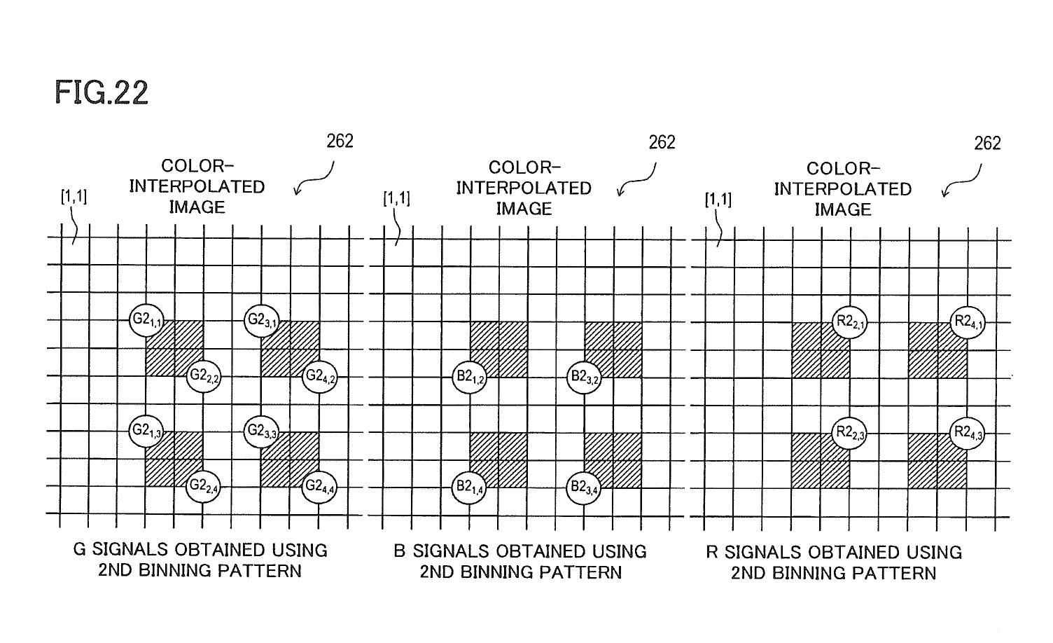

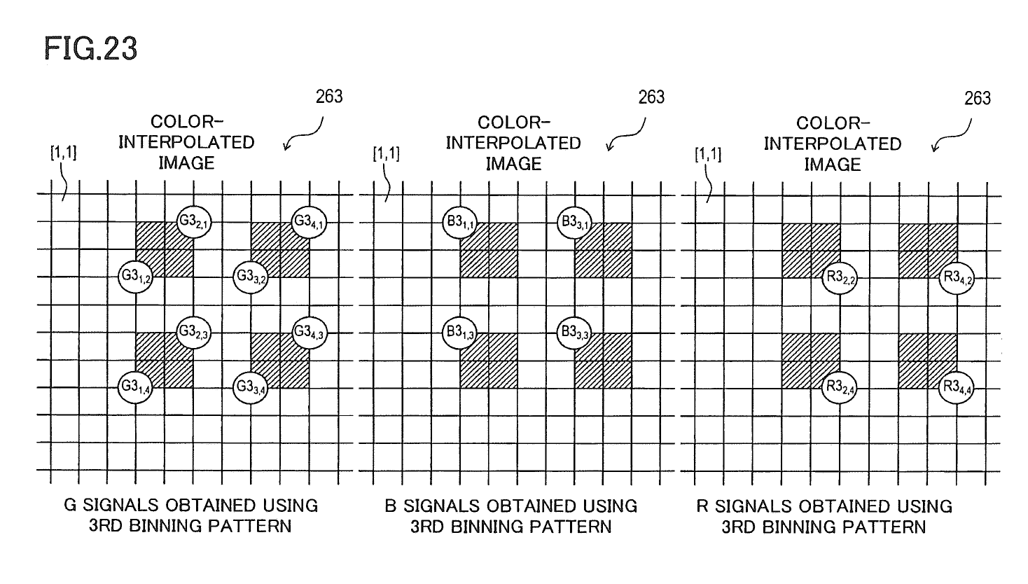

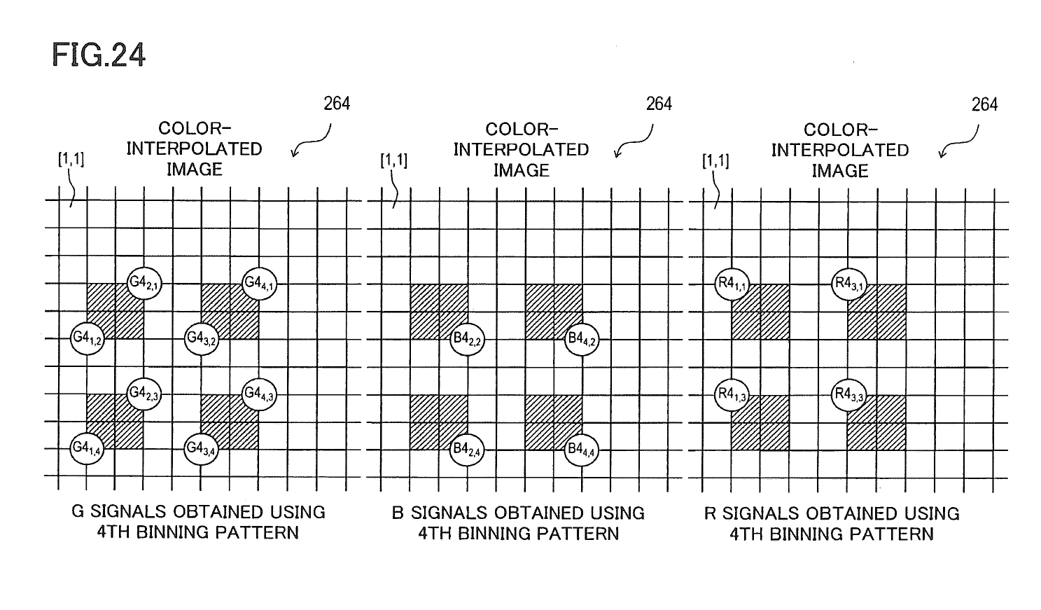

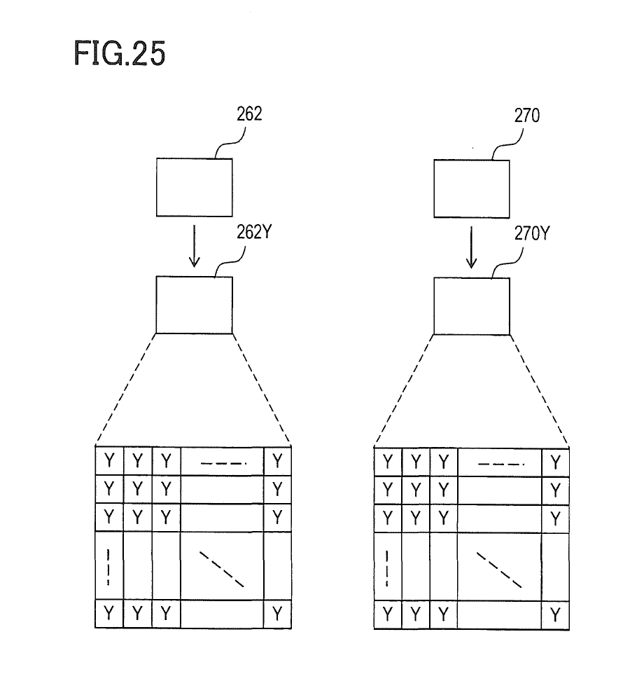

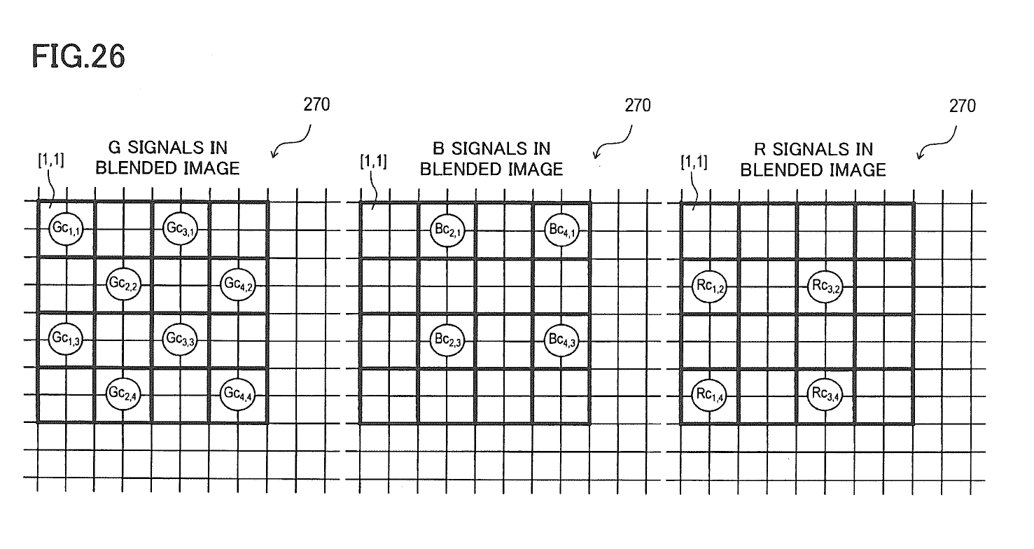

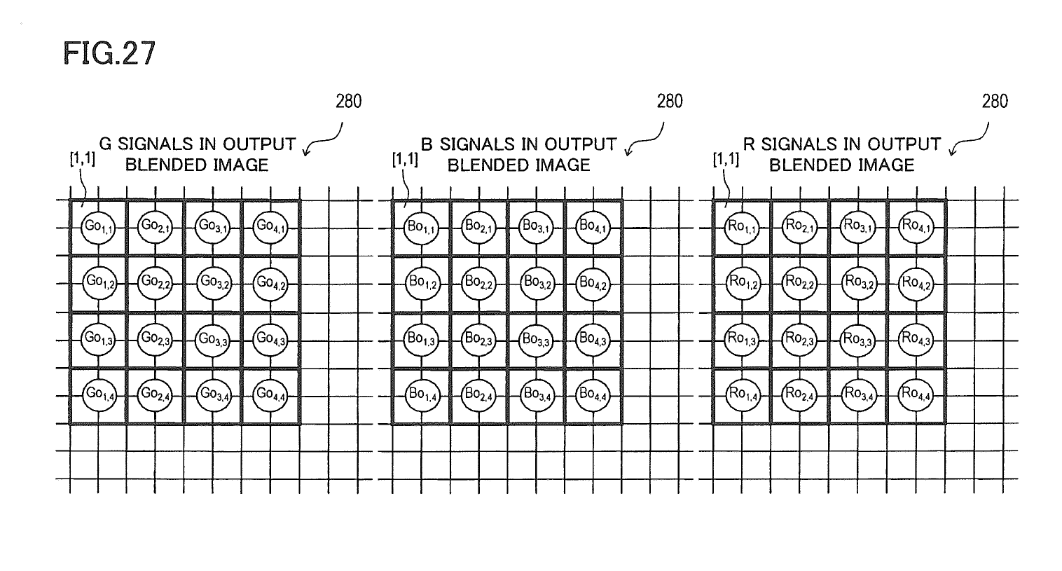

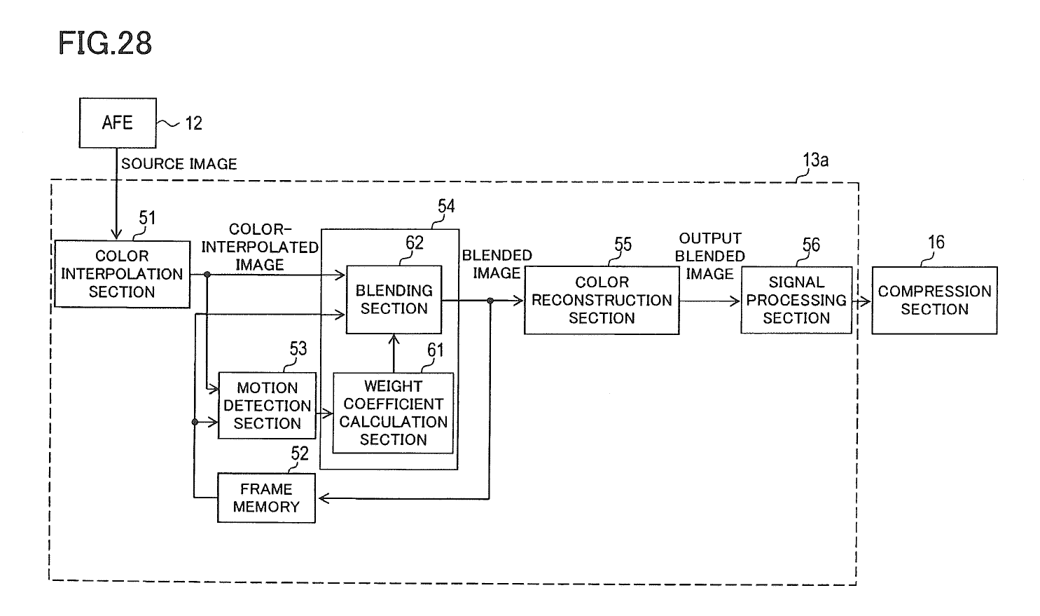

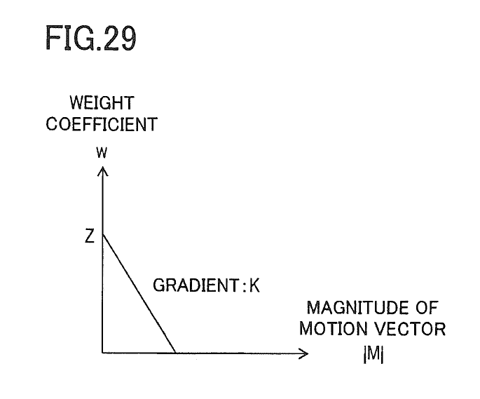

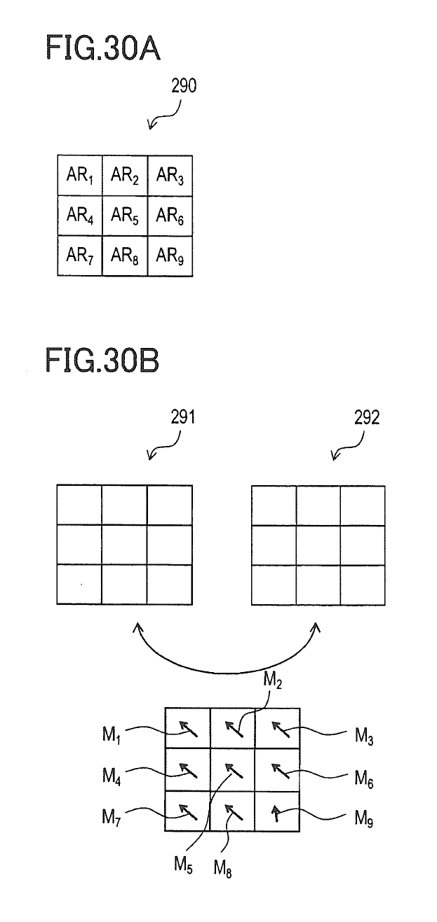

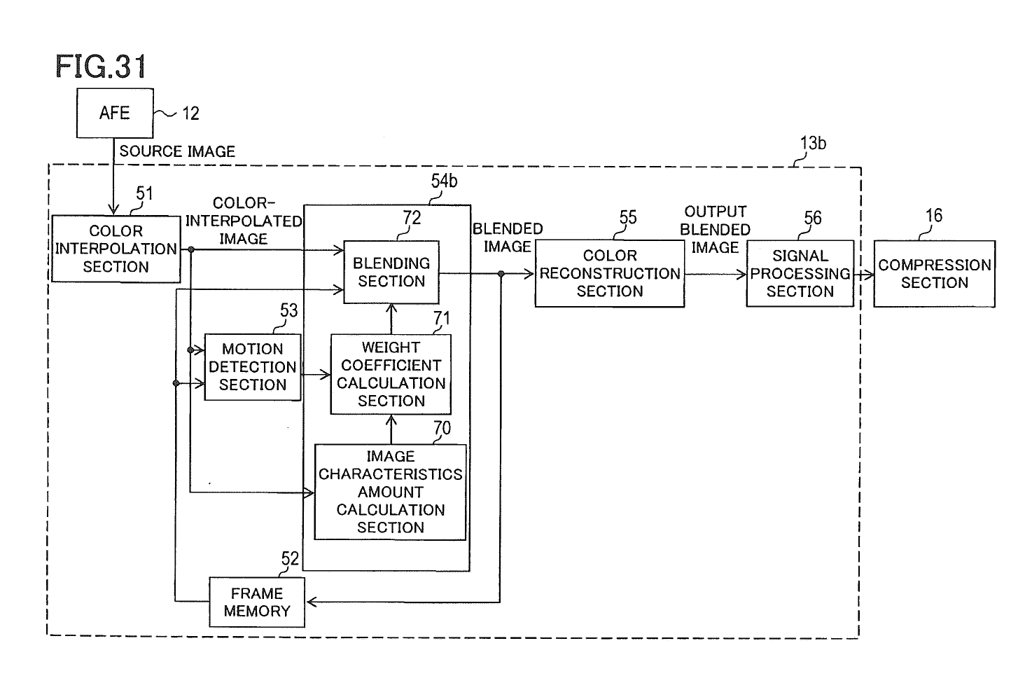

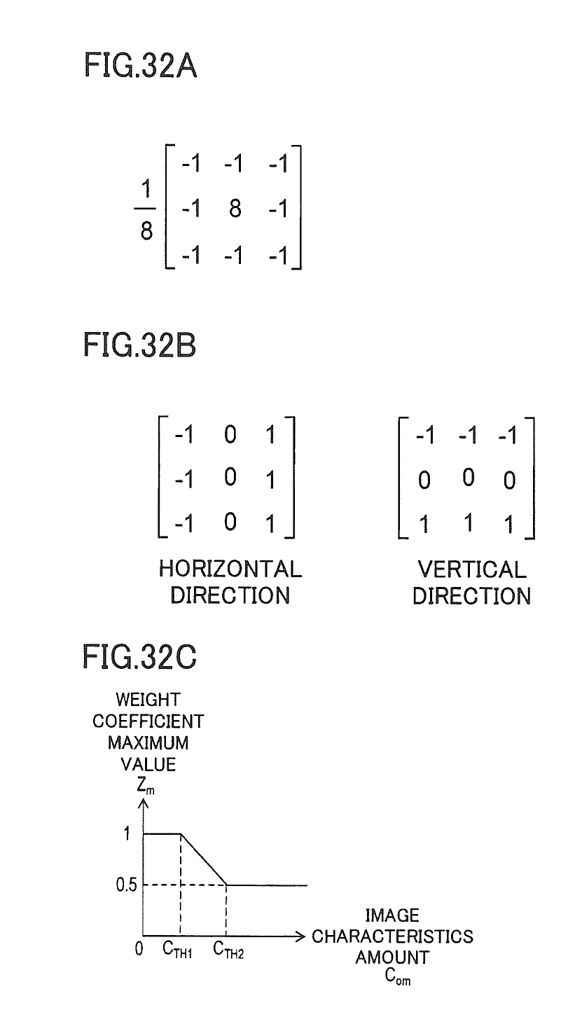

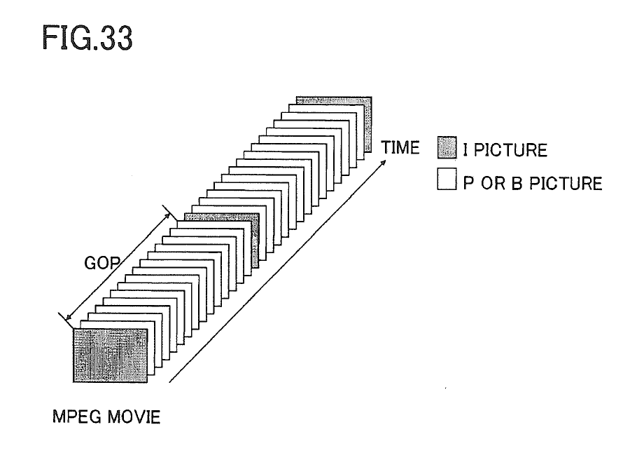

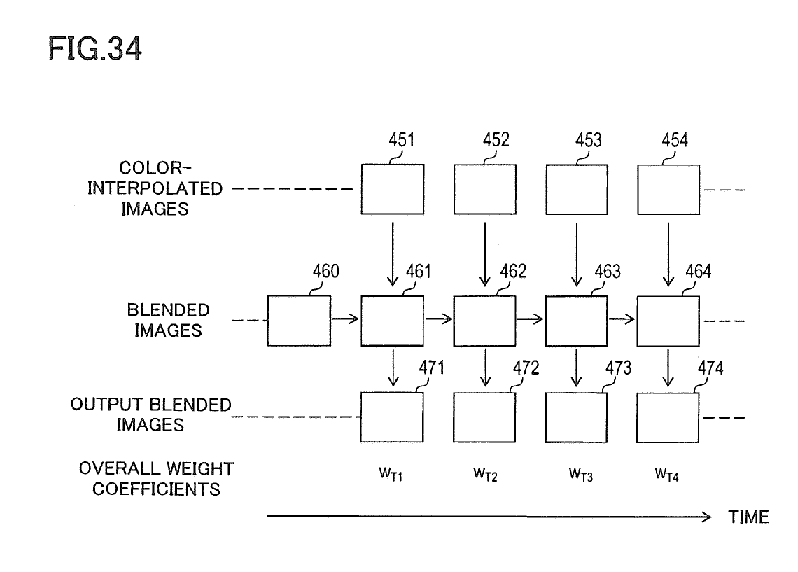

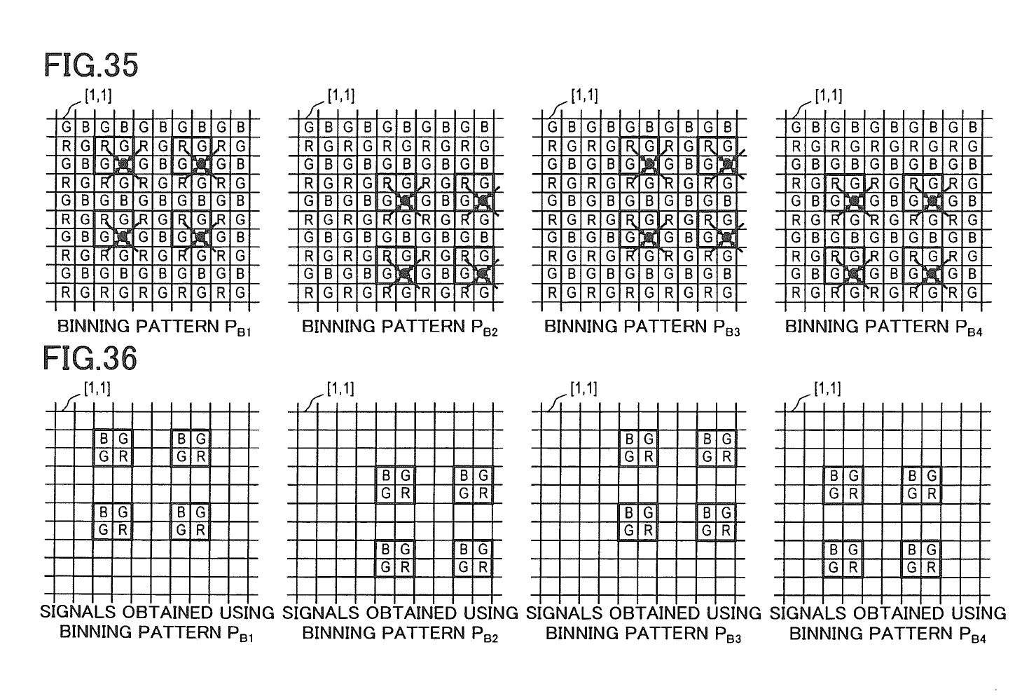

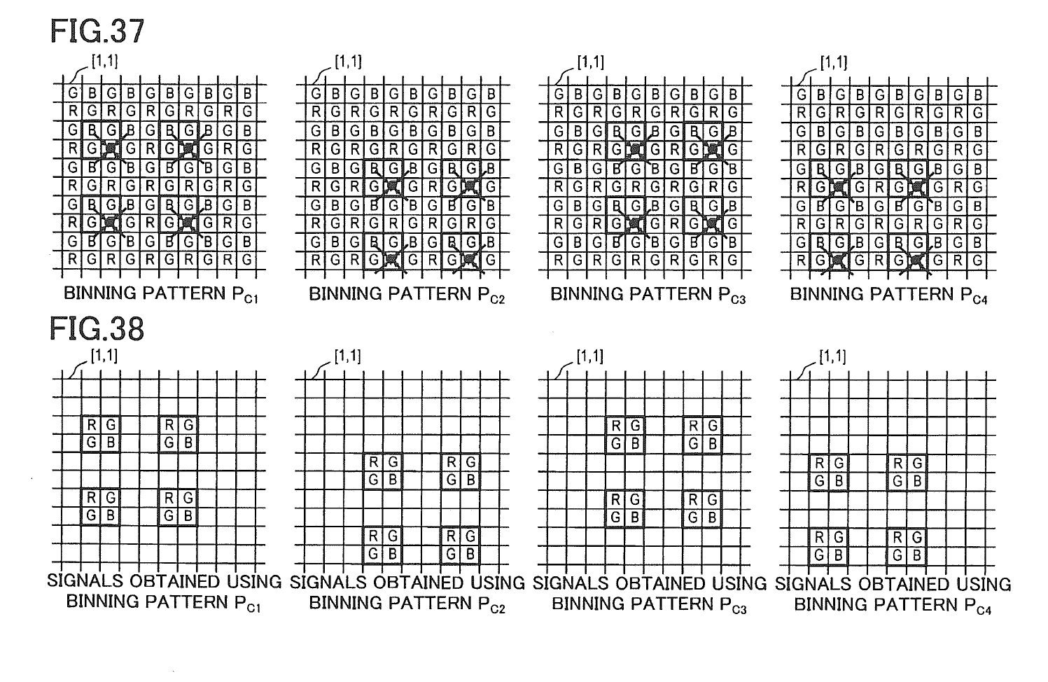

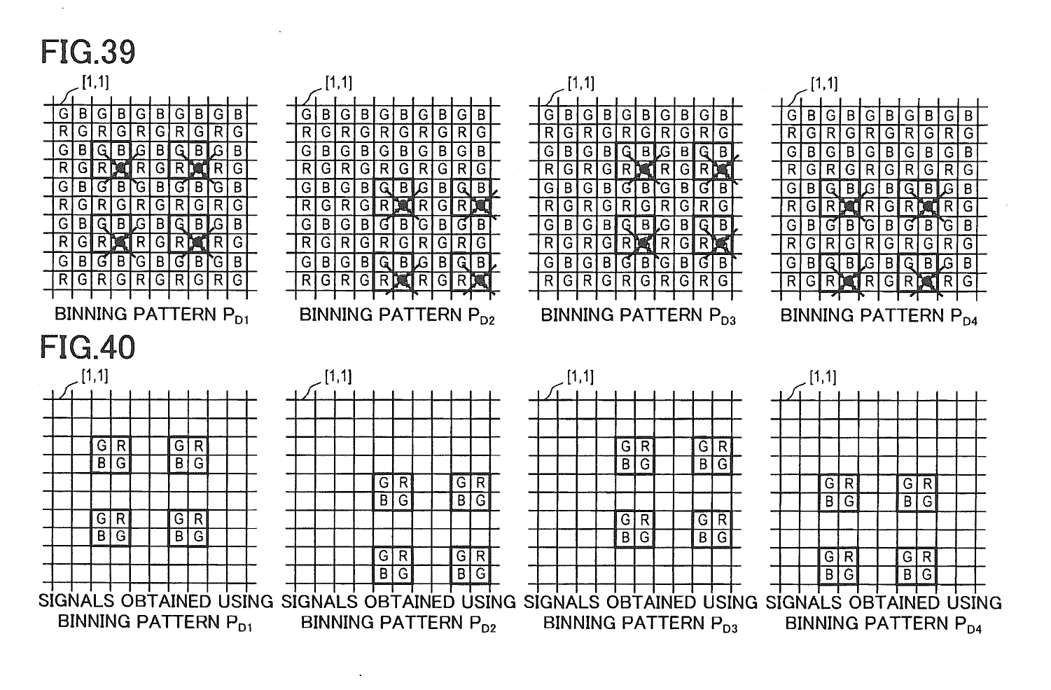

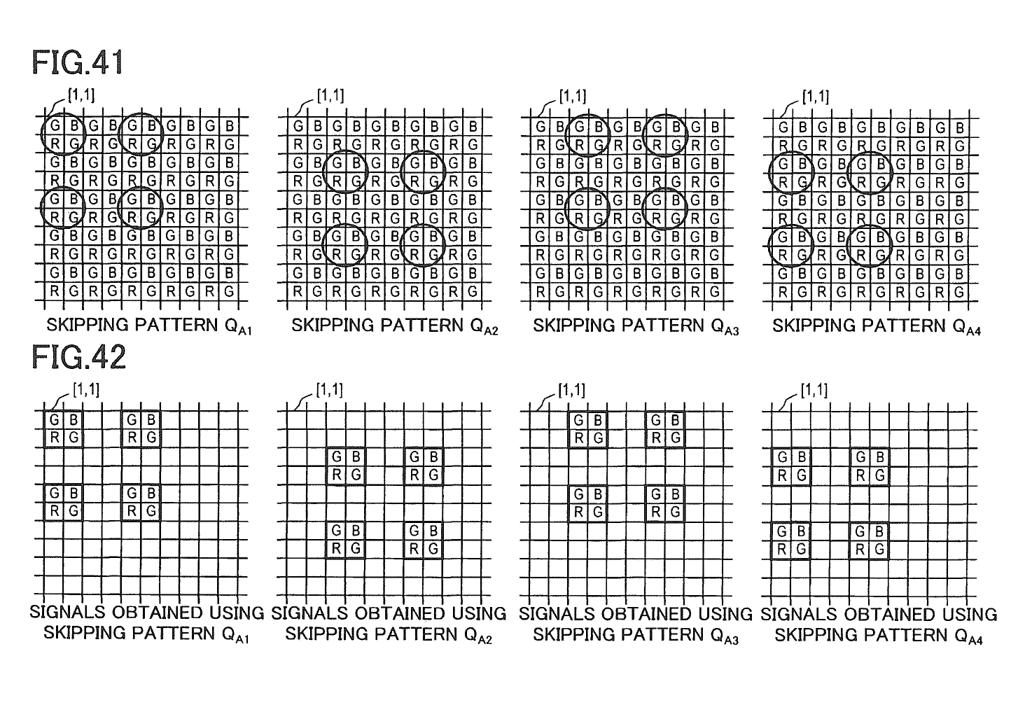

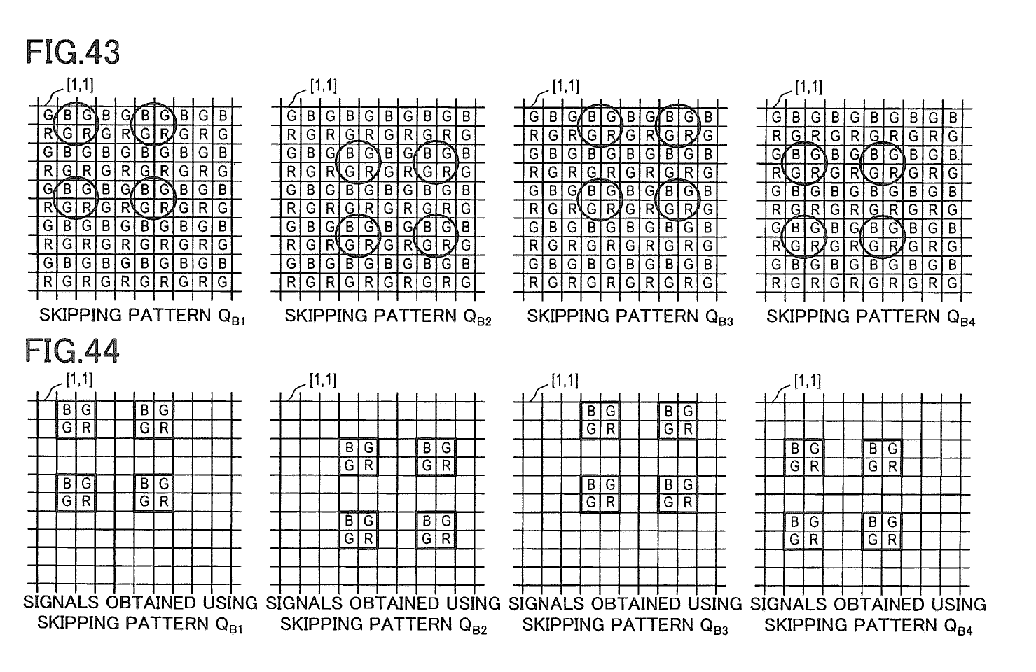

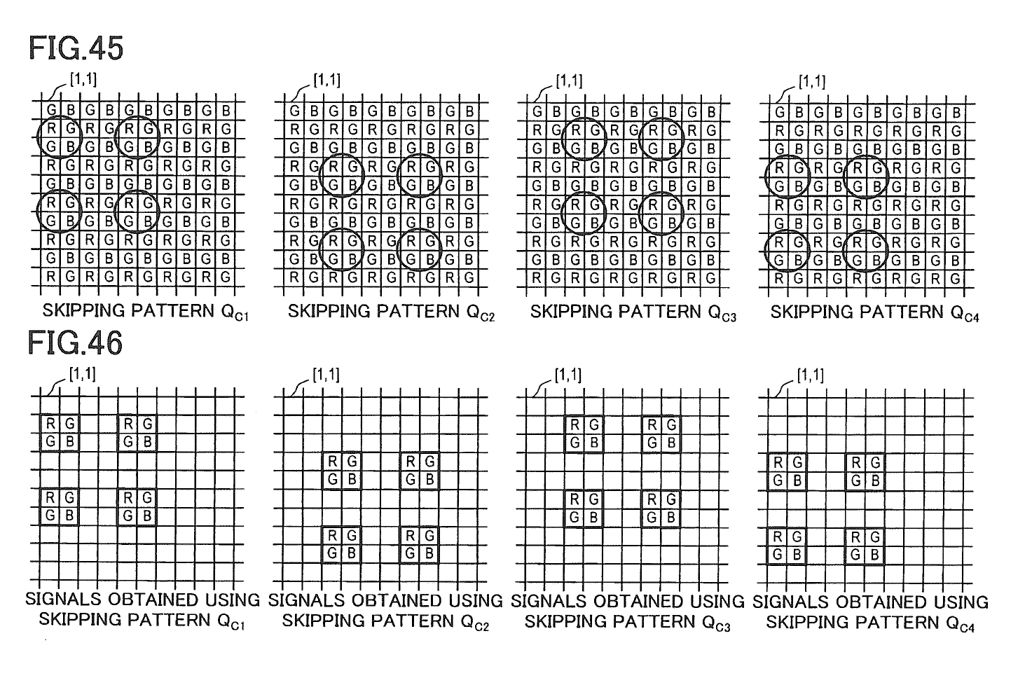

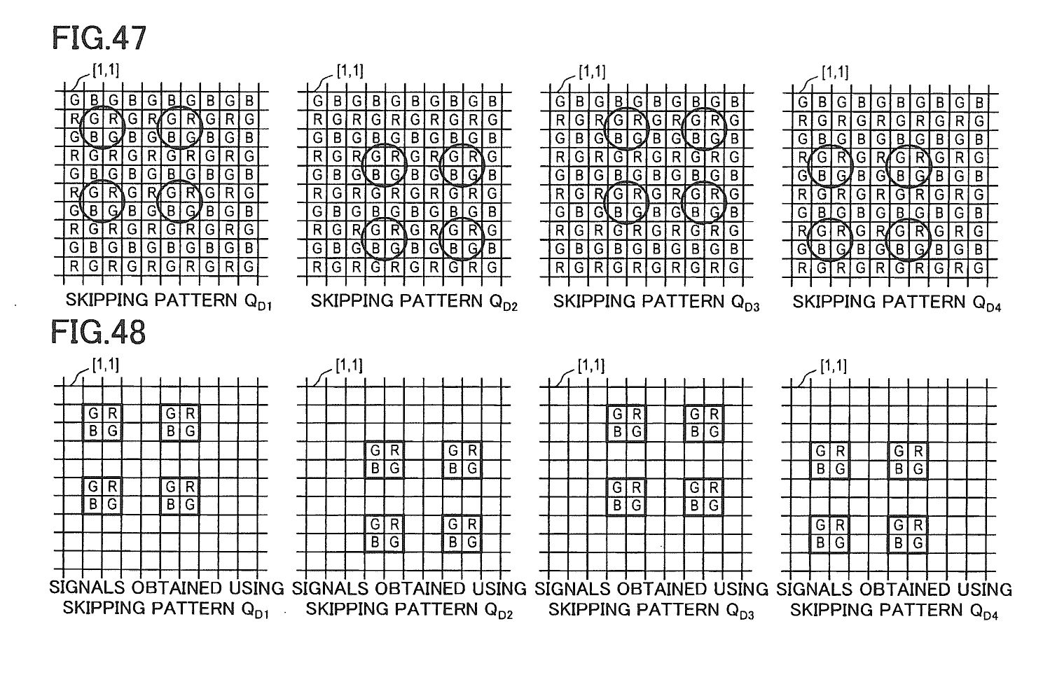

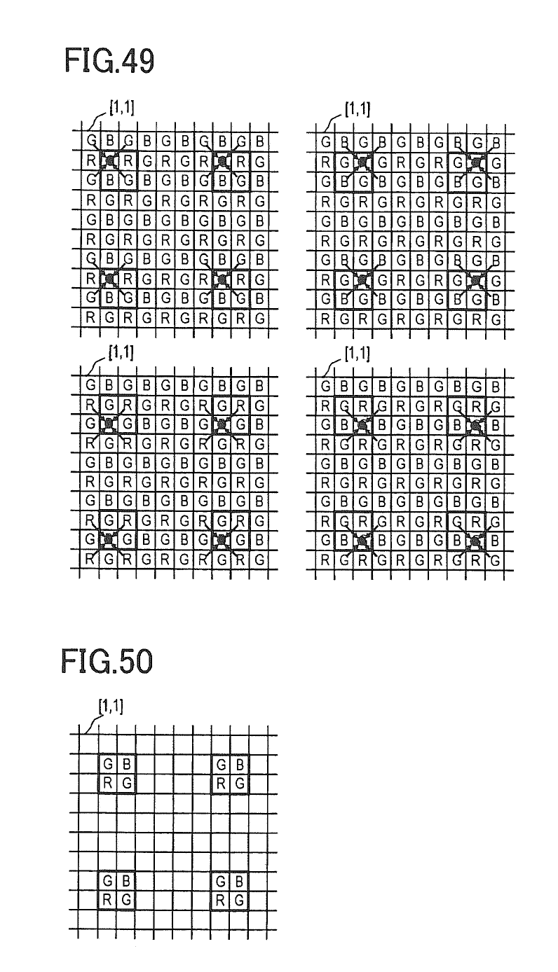

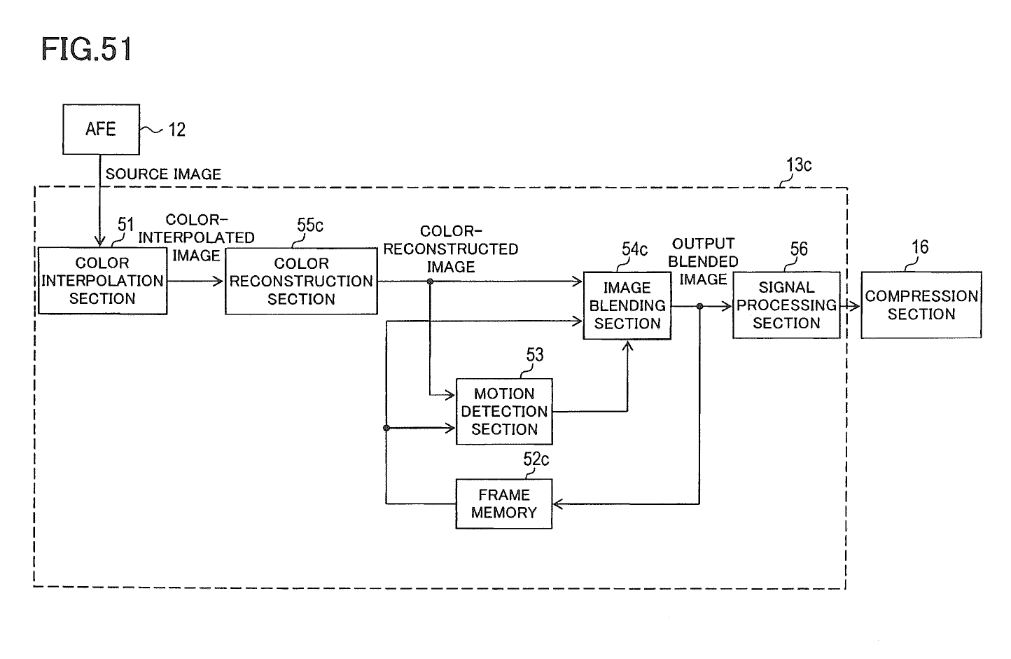

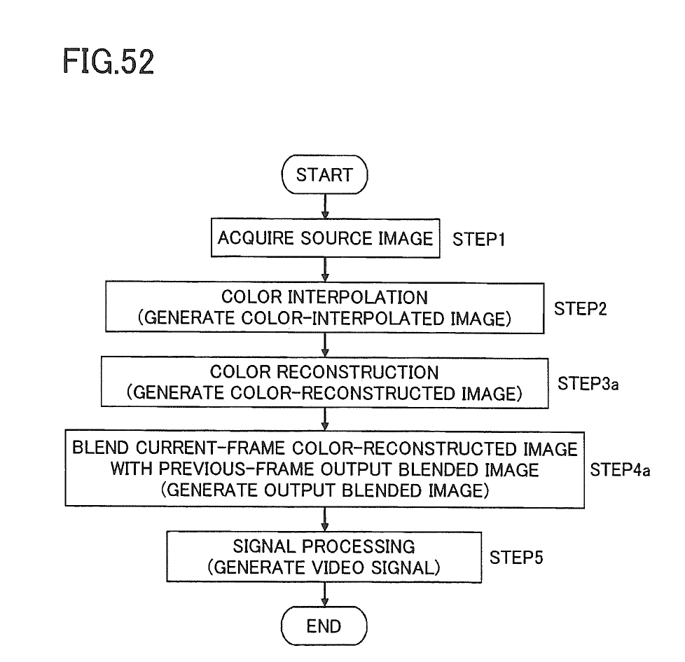

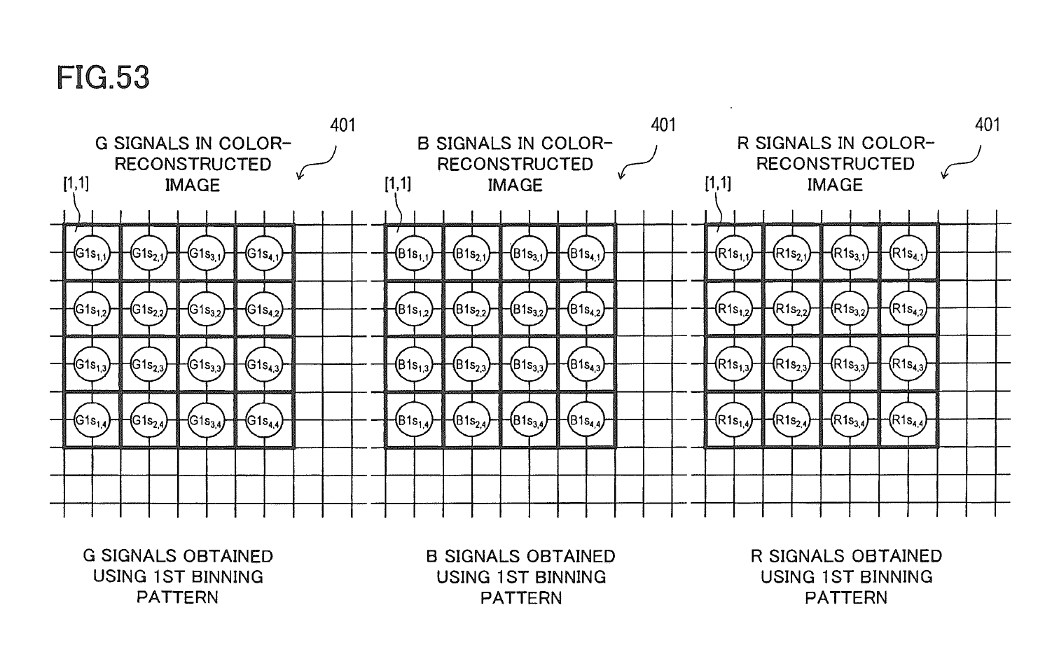

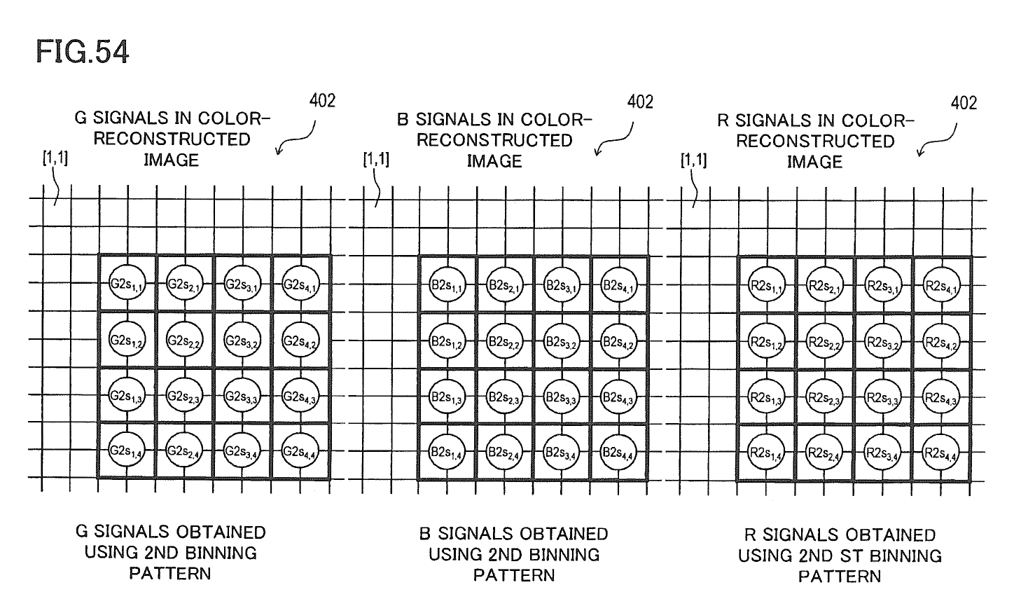

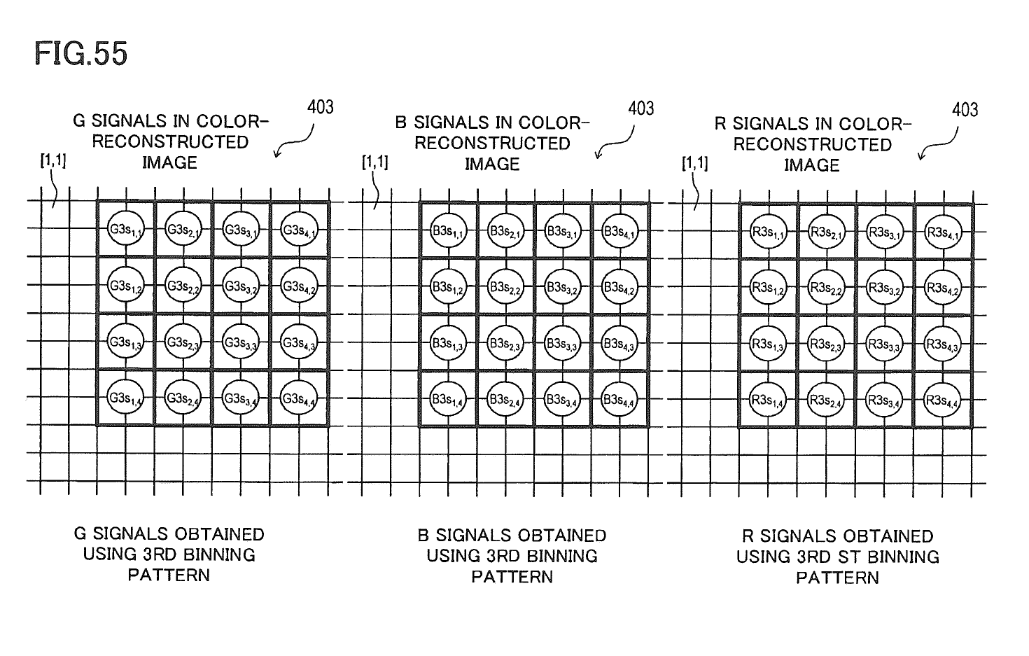

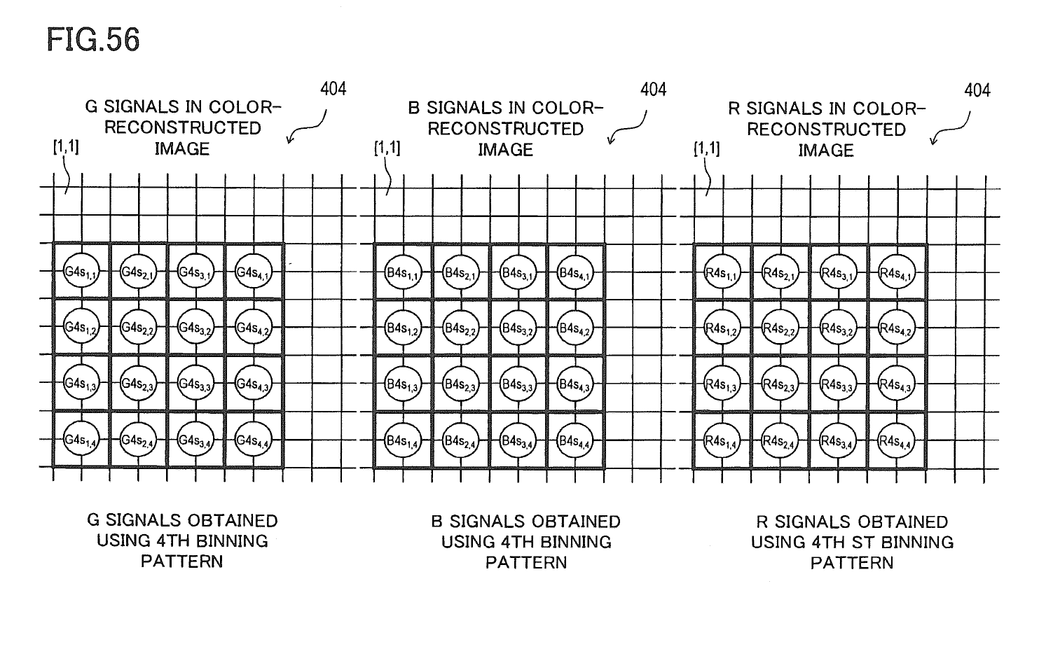

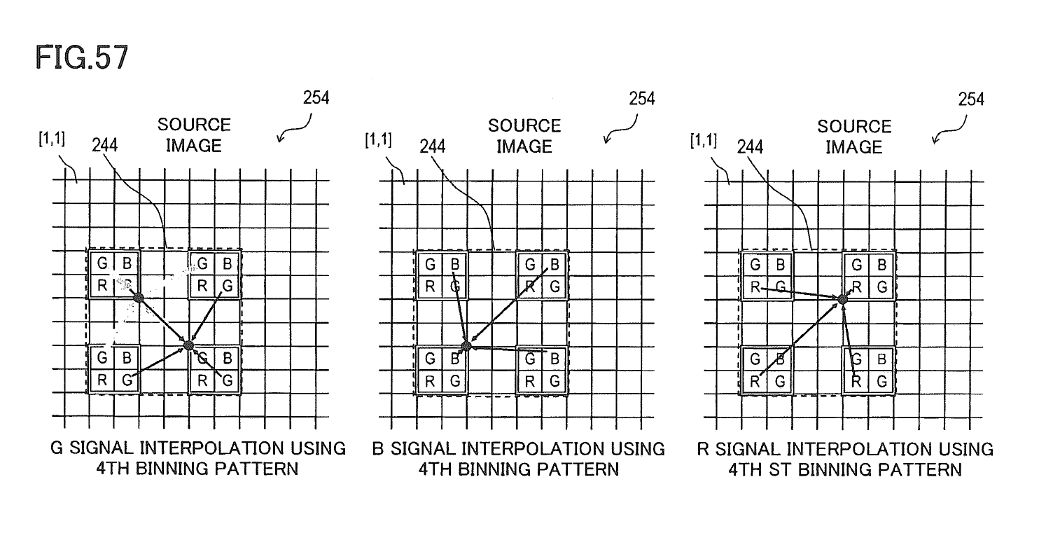

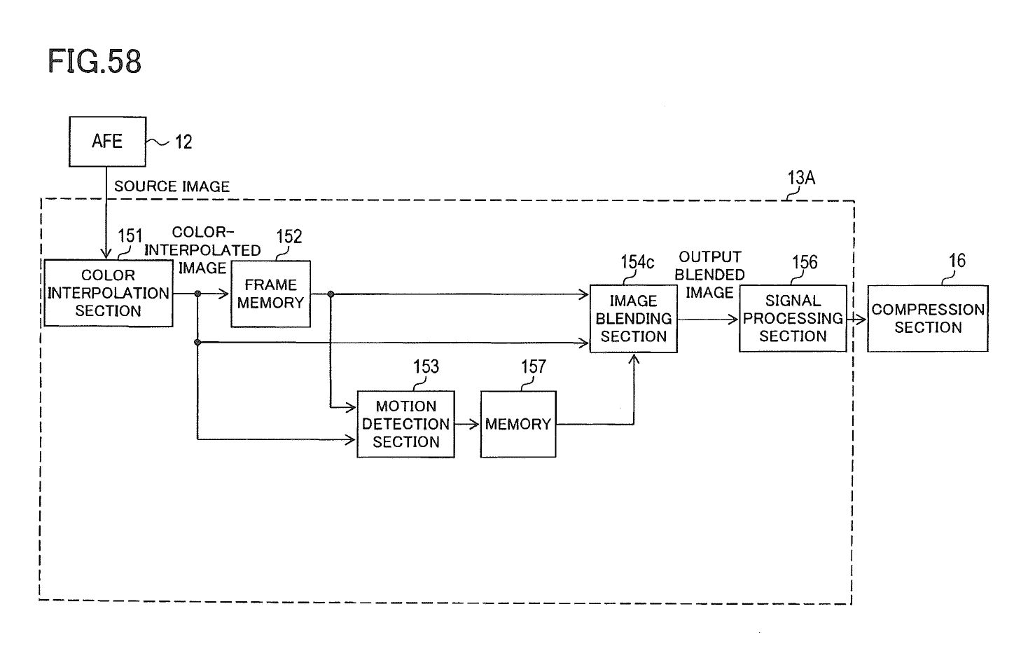

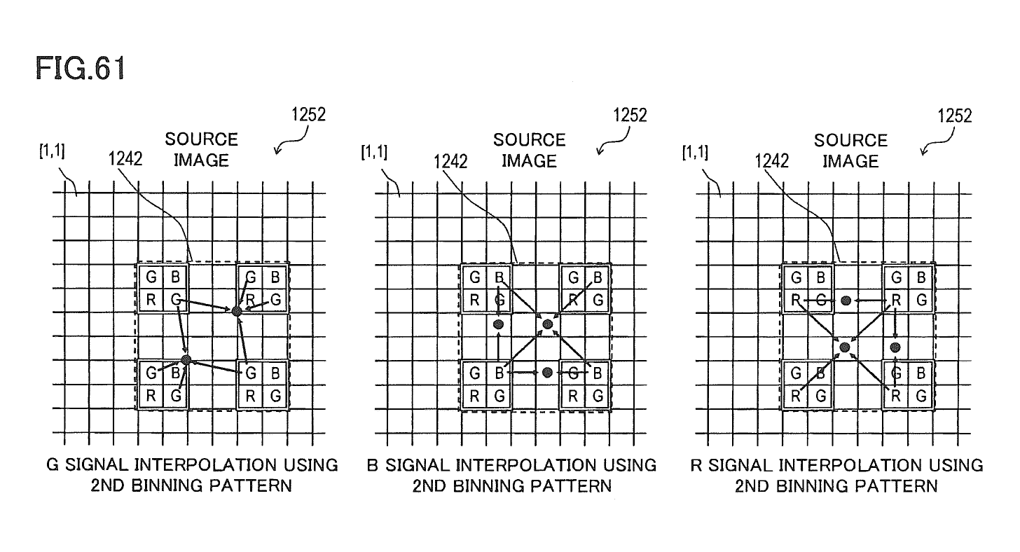

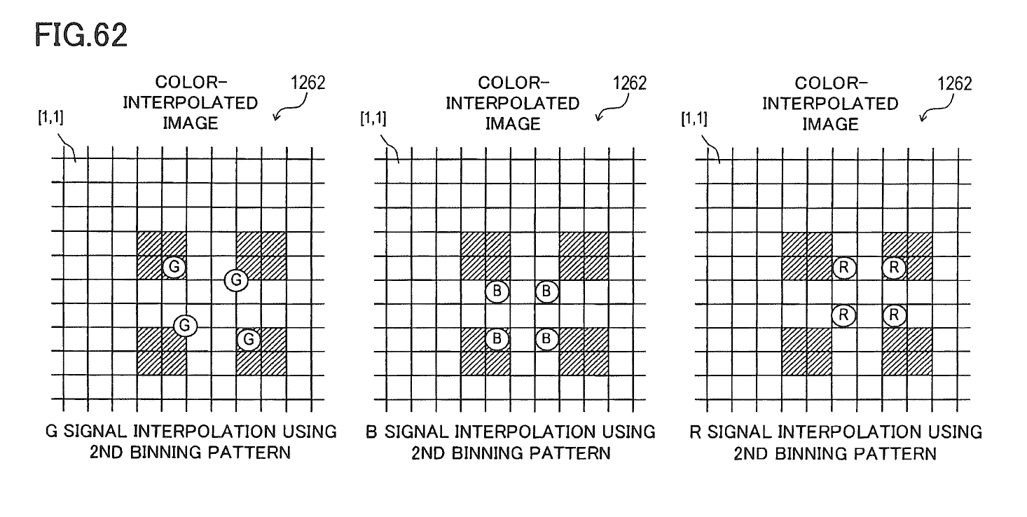

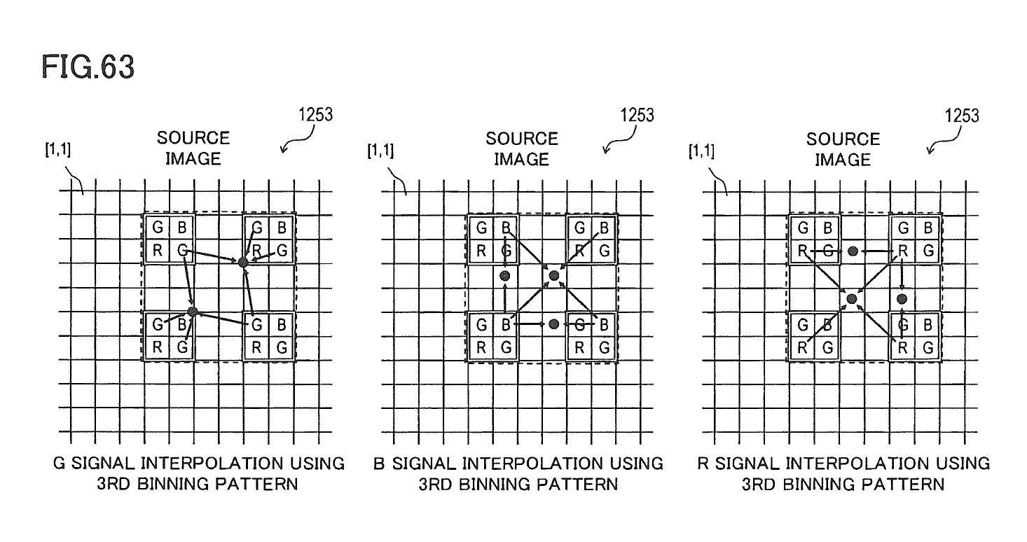

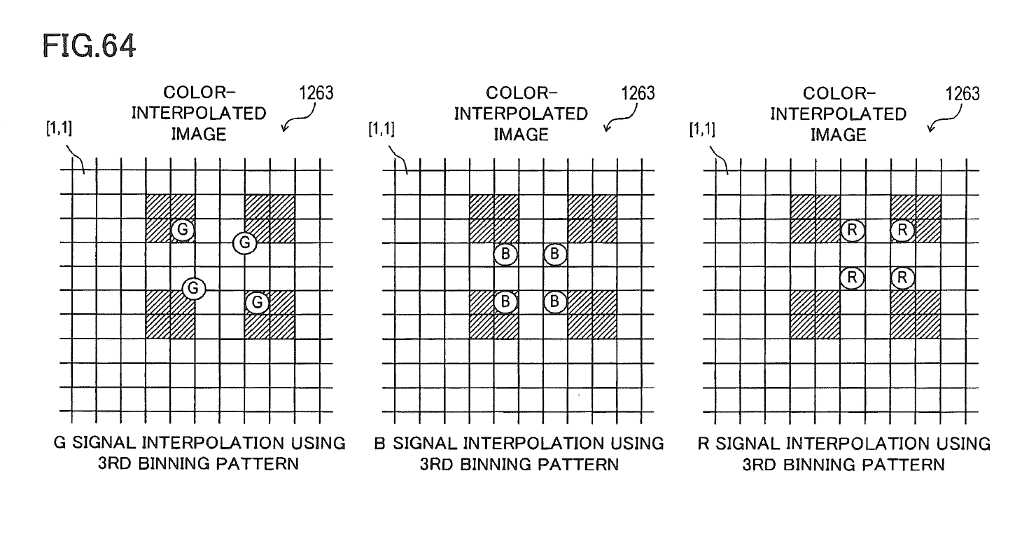

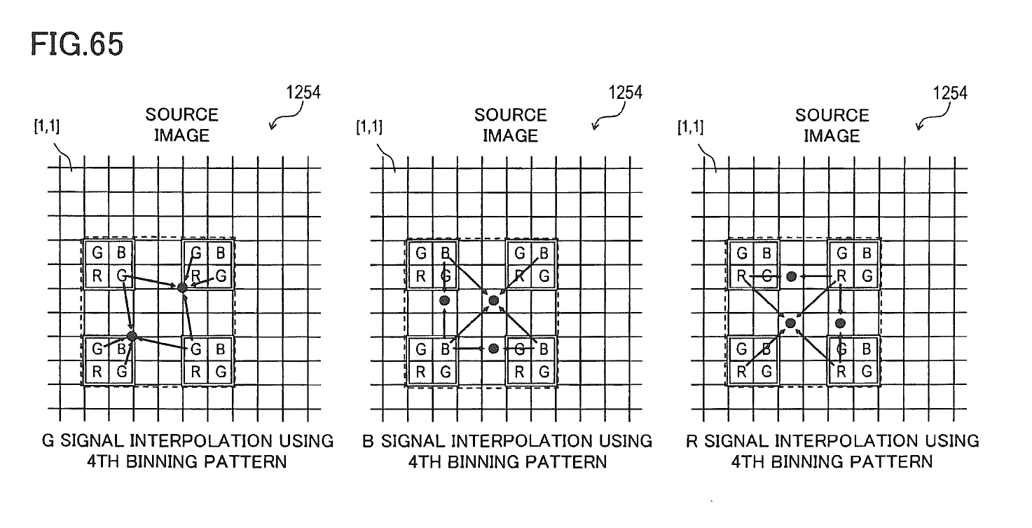

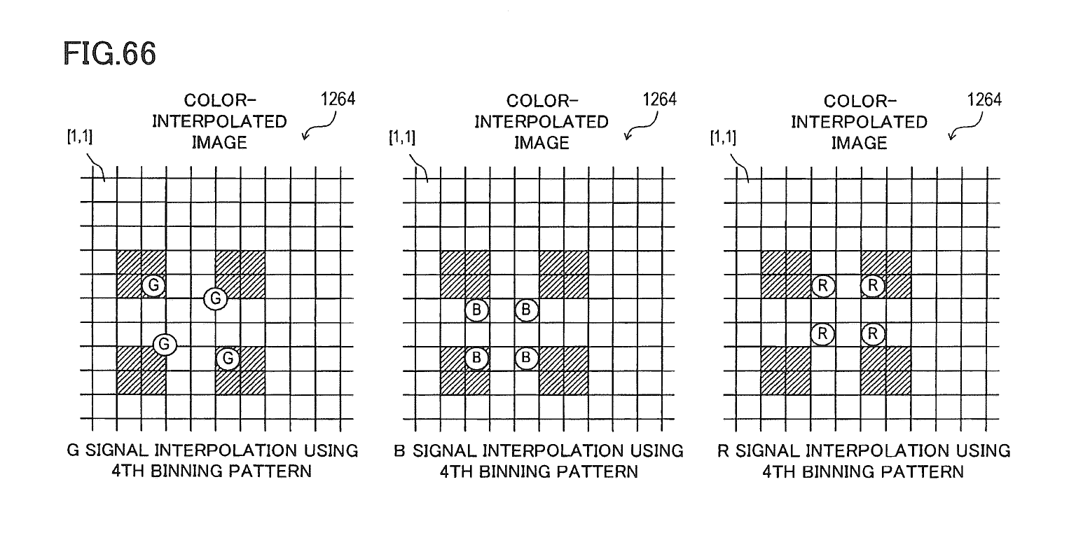

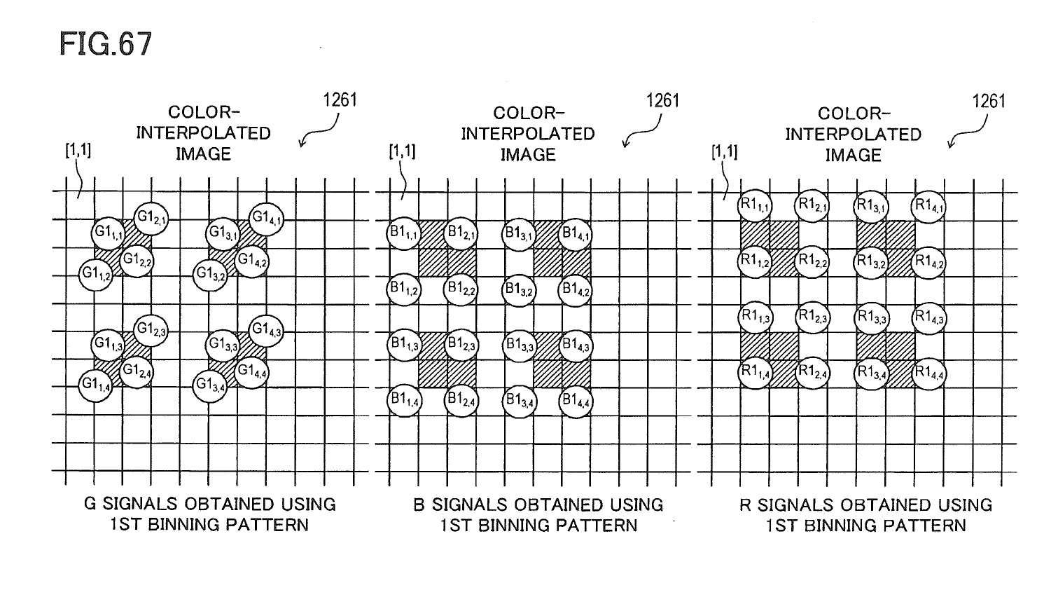

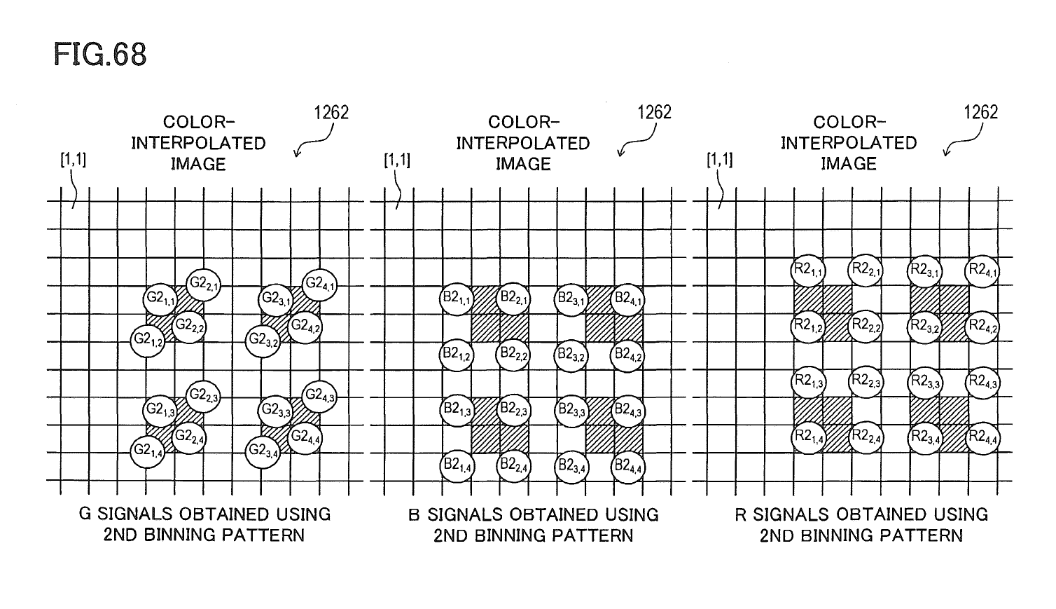

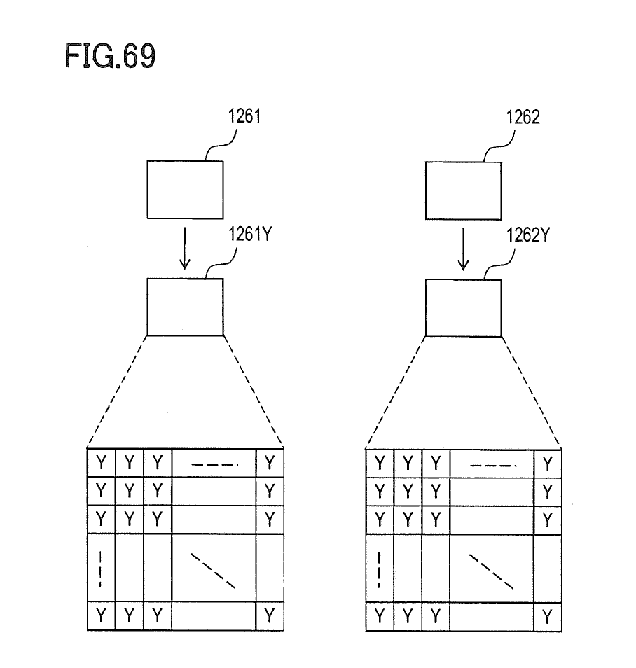

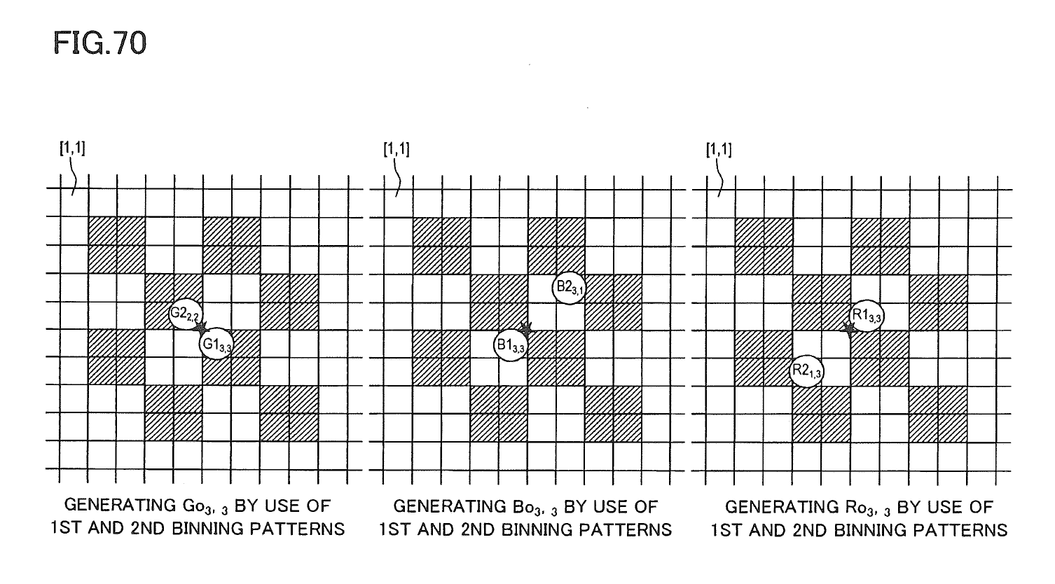

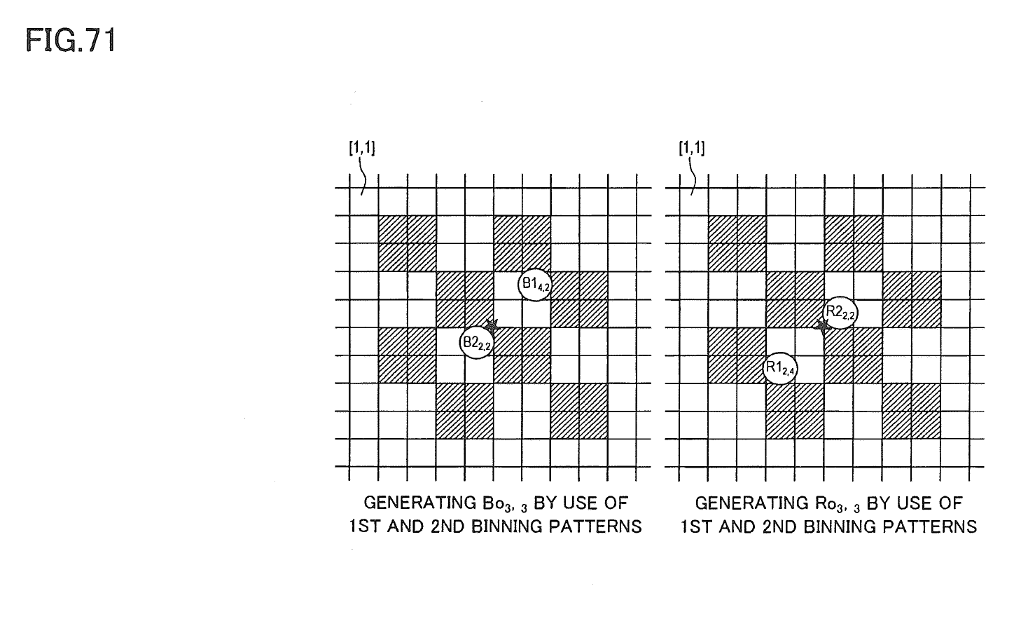

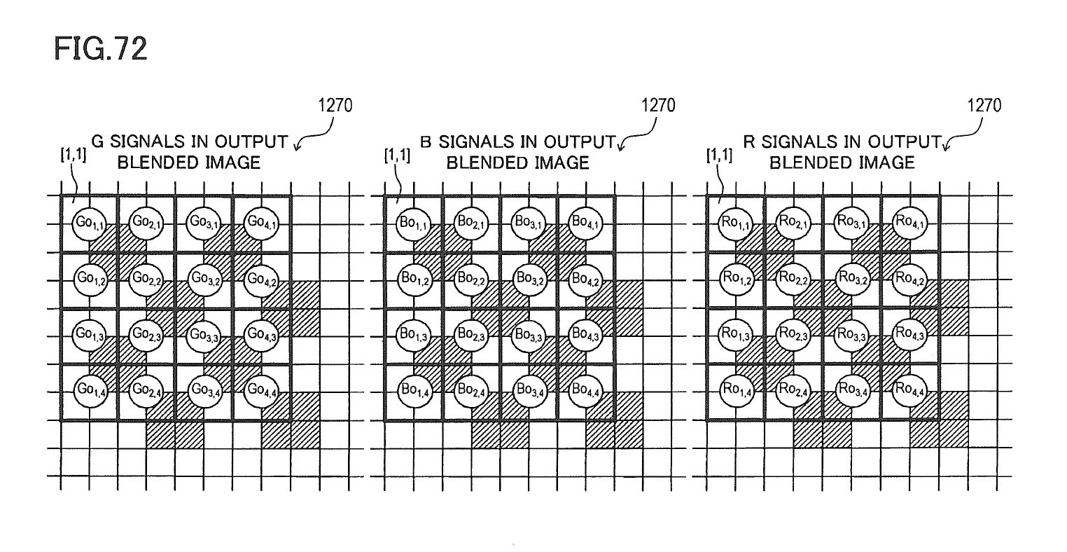

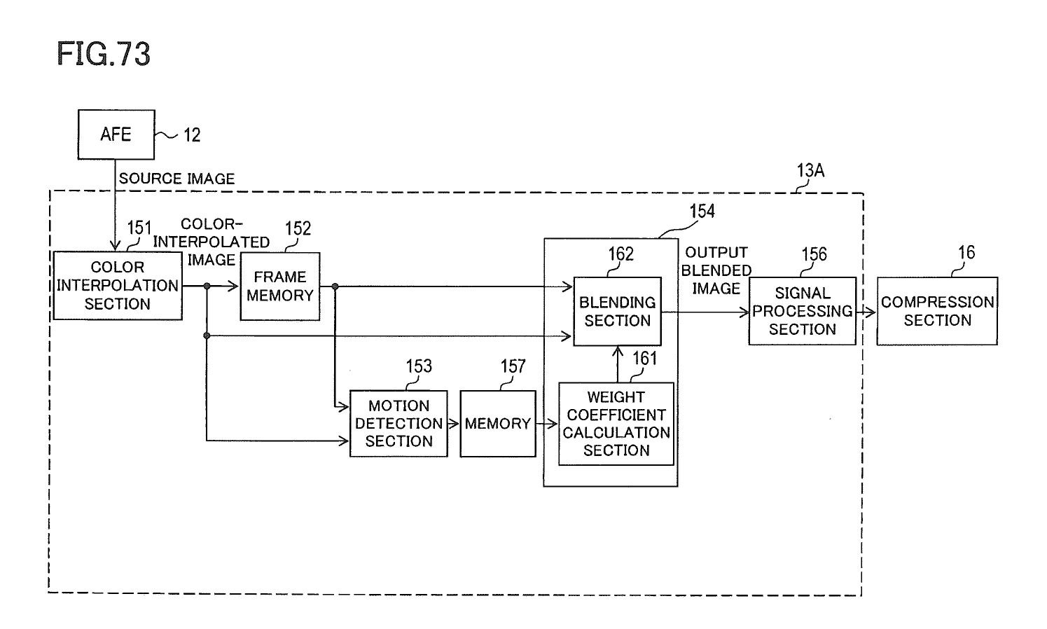

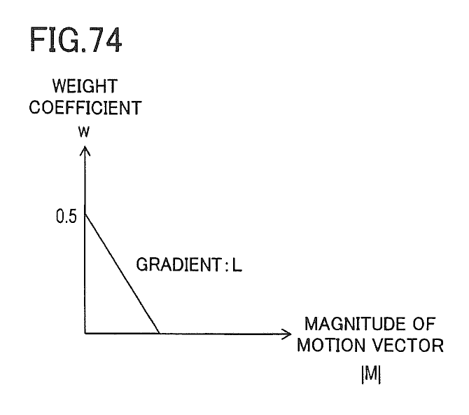

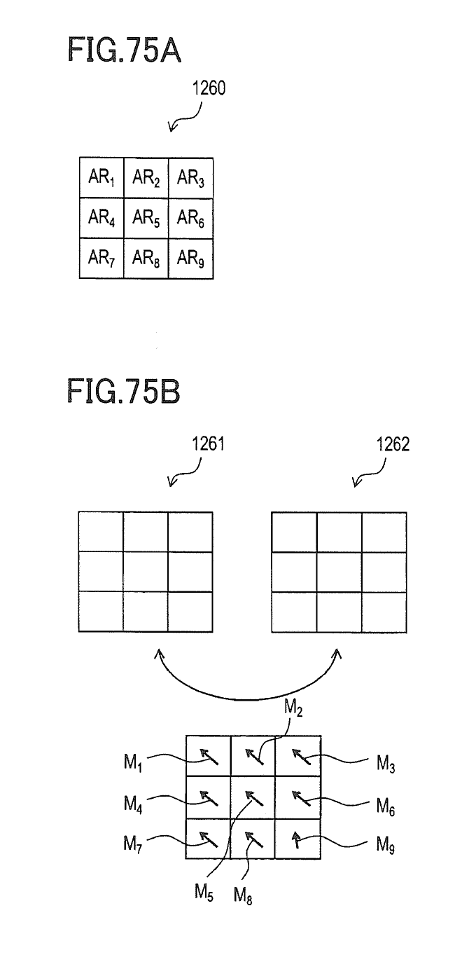

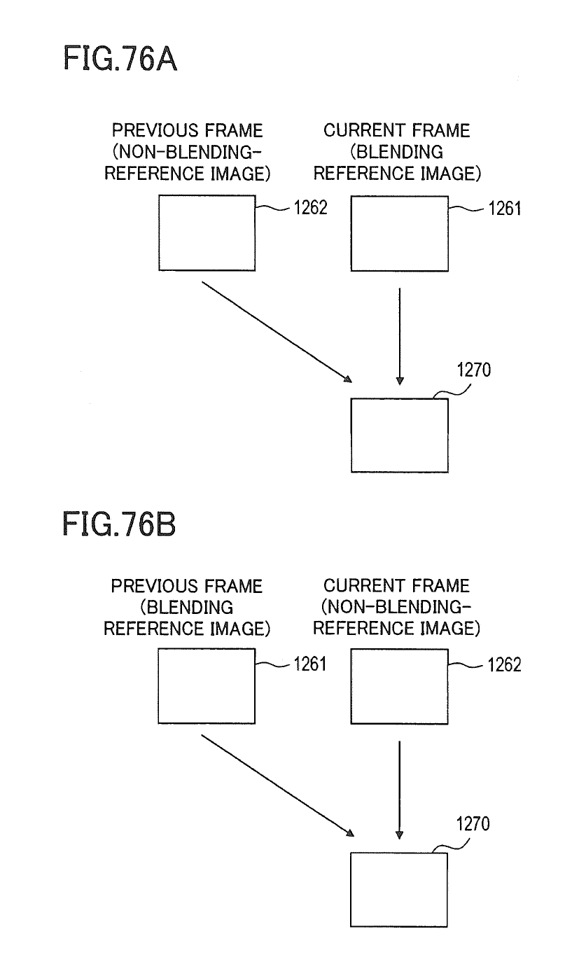

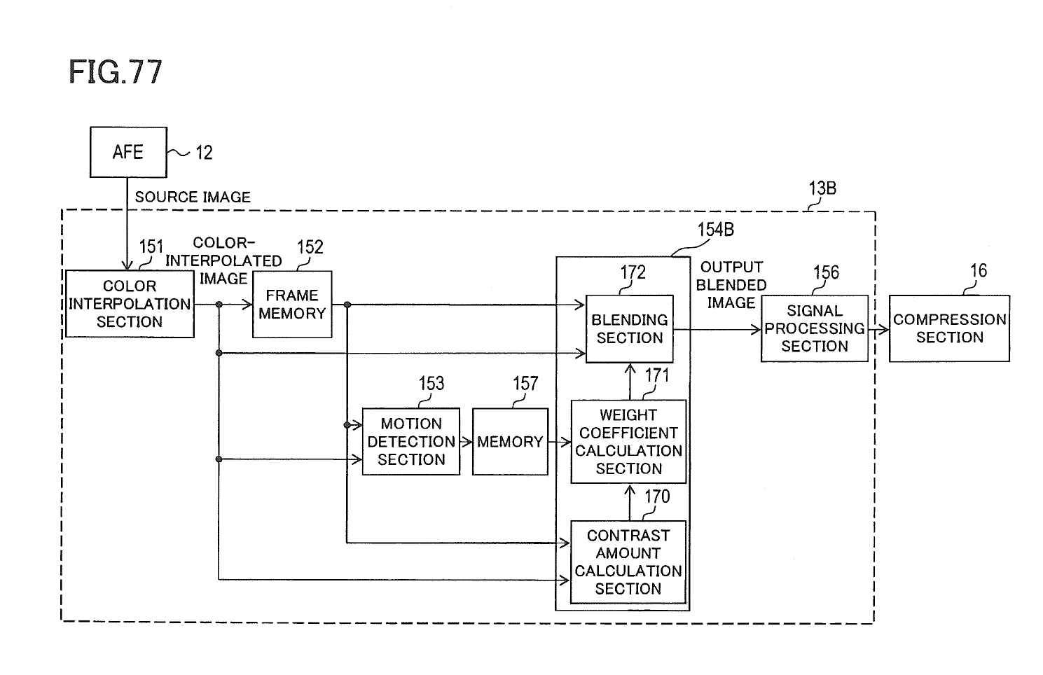

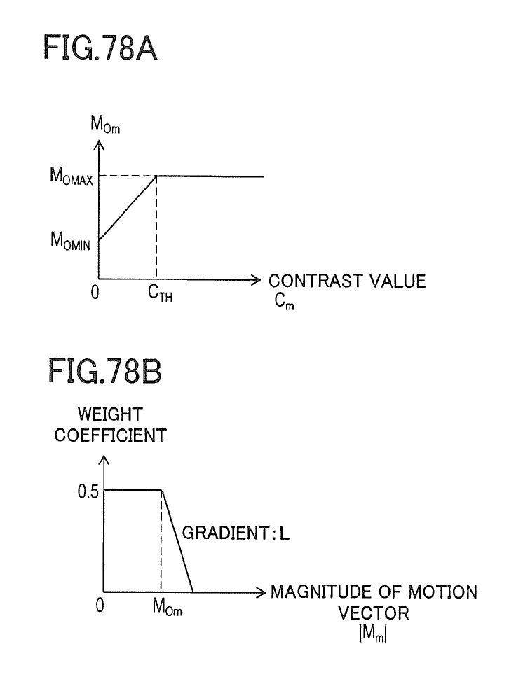

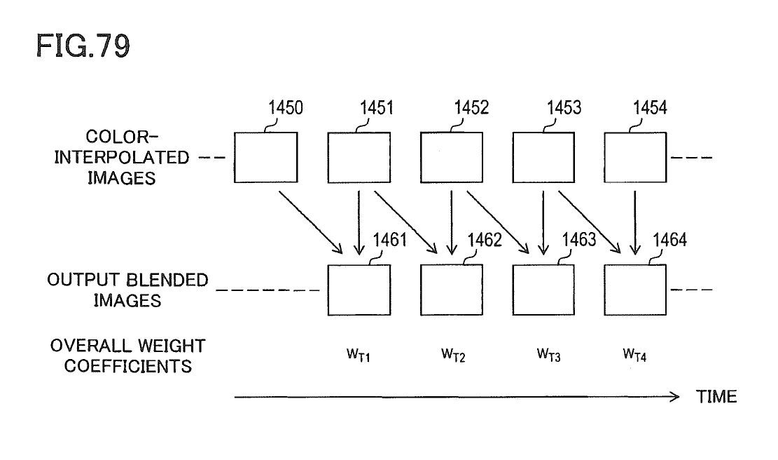

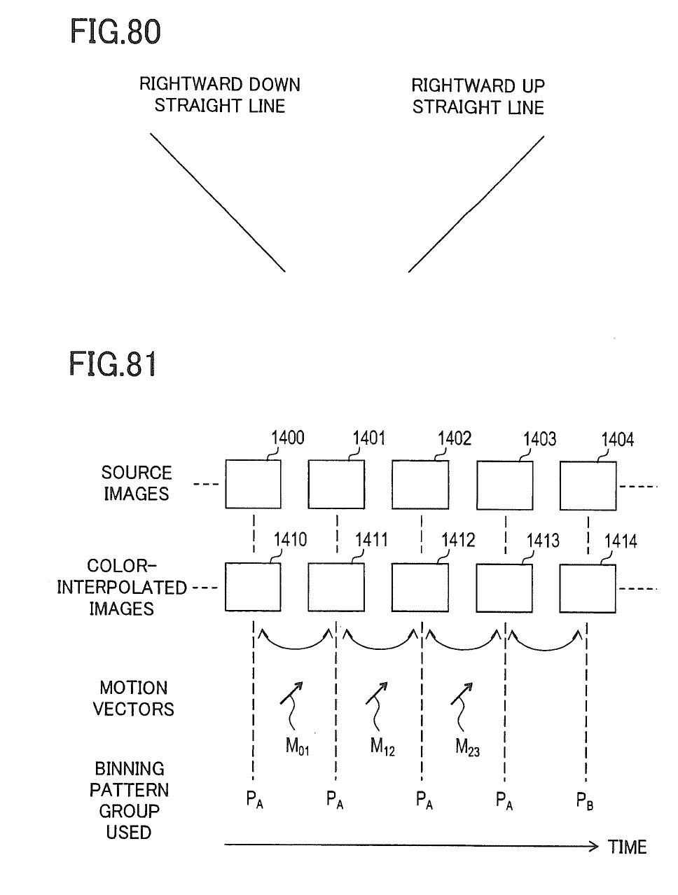

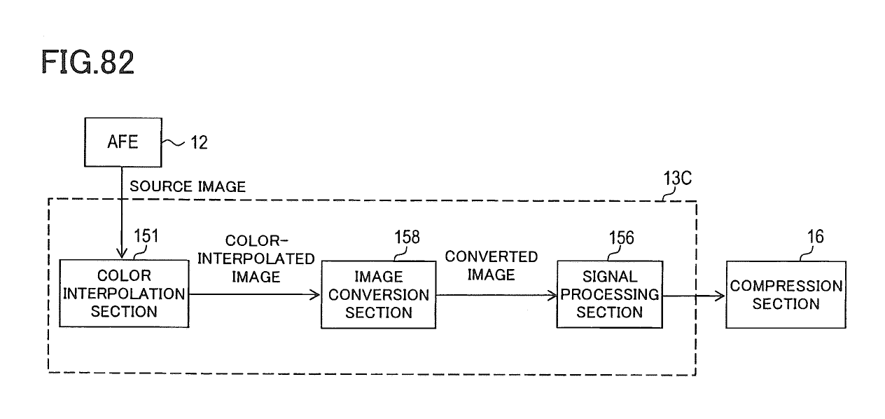

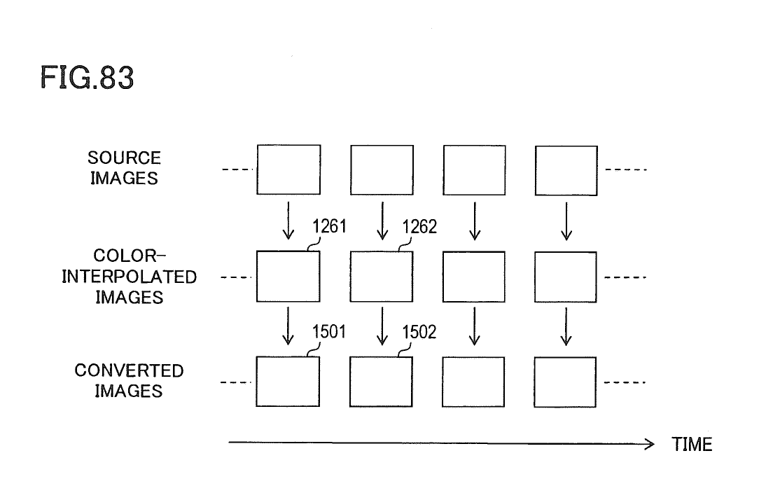

### BRIEF DESCRIPTION OF DRAWINGS

[FIG. 1] is an overall block diagram of an imaging device according to embodiments of the invention.

[FIG. 2] is a diagram showing a photosensitive pixel array within an effective region of the image sensor in FIG. 1.

[FIG. 3] is a diagram showing a color filter array for the image sensor in FIG. 1.

[FIG. 4A] is a diagram showing a pixel array in a source image shot by the imaging device in FIG. 1.

[FIG. 4B] is a diagram showing an image coordinate plane for any image including source images.

[FIG. 5] is an exemplary diagram of pixel signals in a source image obtained by an all-pixel reading method.

[FIG. 6A] is a conceptual diagram of color interpolation applied to the source image in FIG. 5.

[FIG. 6B] is an exemplary diagram of a color-interpolated image obtained by applying color interpolation to the source image in FIG. 5.

[FIG. 7A] relates to Example 1 of Embodiment 1 of the invention, and is a diagram showing how signals are added up when the first binning pattern is used.

[FIG. 7B] relates to Example 1 of Embodiment 1 of the invention, and is a diagram showing how signals are added up when the second binning pattern is used.

[FIG. 8A] relates to Example 1 of Embodiment 1 of the invention, and is a diagram showing how signals are added up when the third binning pattern is used.

[FIG. 8B] relates to Example 1 of Embodiment 1 of the invention, and is a diagram showing how signals are added up when the fourth binning pattern is used.

[FIG. 9A] relates to Example 1 of Embodiment I of the invention, and is a diagram showing how pixel signals in a source image appear when binned reading is performed by use of the first binning pattern.

[FIG. 9B] relates to Example 1 of Embodiment 1 of the invention, and is a diagram showing how pixel signals in a source image appear when binned reading is performed by use of the second binning pattern.

[FIG. 9C] relates to Example 1 of Embodiment 1 of the invention, and is a diagram showing how pixel signals in a source image appear when binned reading is performed by use of the third binning pattern.

[FIG. 9D] relates to Example 1 of Embodiment 1 of the invention, and is a diagram showing how pixel signals in a source image appear when binned reading is performed by use of the fourth binning pattern.

[FIG. 10] relates to Example 1 of Embodiment 1 of the invention, and is a block diagram of part of the imaging device, including an internal block diagram of the video signal processing section in FIG. 1.

[FIG. 11] relates to Example 1 of Embodiment 1 of the invention, and is a flow chart showing the operation of the video signal processing section in FIG. 10.

[FIG. 12A] relates to Example 1 of Embodiment 1 of the invention, and is a diagram illustrating a method of calculating the pixel at an interpolated pixel position from a plurality of pixel signals.

[FIG. 12B] relates to Example 1 of Embodiment 1 of the invention, and is a diagram illustrating a method of calculating the pixel at an interpolated pixel position from a plurality of pixel signals.

[FIG. 13] relates to Example 1 of Embodiment 1 of the invention, and is a diagram showing how G, B, and R signals are mixed in a source image acquired by use of the first binning pattern.

[FIG. 14] relates to Example 1 of Embodiment 1 of the invention, and is a diagram showing G, B, and R signals in a color-interpolated image generated from the source image in FIG. 13.

[FIG. 15] relates to Example 1 of Embodiment 1 of the invention, and is a diagram showing how G, B, and R signals are mixed in a source image acquired by use of the second binning pattern.

[FIG. 16] relates to Example 1 of Embodiment 1 of the invention, and is a diagram showing G, B, and R signals in a color-interpolated image generated from the source image in FIG. 15.

[FIG. 17] relates to Example 1 of Embodiment 1 of the invention, and is a diagram showing how G, B, and R signals are mixed in a source image acquired by use of the third binning pattern.

[FIG. 18] relates to Example 1 of Embodiment 1 of the invention, and is a diagram showing G, B, and R signals in a color-interpolated image generated from the source image in FIG. 17.

[FIG. 19] relates to Example 1 of Embodiment 1 of the invention, and is a diagram showing how G, B, and R signals are mixed in a source image acquired by use of the fourth binning pattern.

[FIG. 20] relates to Example 1 of Embodiment 1 of the invention, and is a diagram showing G, B, and R signals in a color-interpolated image generated from the source image in FIG. 19.

[FIG. 21] relates to Example 1 of Embodiment 1 of the invention, and is a diagram showing G, B, and R signals in a color-interpolated image generated from the source image in FIG. 13.

[FIG. 22] relates to Example 1 of Embodiment 1 of the invention, and is a diagram showing G, B, and R signals in a color-interpolated image generated from the source image in FIG. 15.

[FIG. 23] relates to Example 1 of Embodiment 1 of the invention, and is a diagram showing G, B, and R signals in a color-interpolated image generated from the source image in FIG. 17.

[FIG. 24] relates to Example 1 of Embodiment 1 of the invention, and is a diagram showing G, B, and R signals in a color-interpolated image generated from the source image in FIG. 19.

[FIG. 25] relates to Example 1 of Embodiment 1 of the invention, and is a diagram showing a color-interpolated image, a blended image, and a corresponding luminance image.

[FIG. 26] relates to Example 1 of Embodiment 1 of the invention, and is a diagram showing the locations of G, B, and R signals in a blended image.

[FIG. 27] relates to Example 1 of Embodiment 1 of the invention, and is a diagram showing the locations of G, B, and R signals in a blended image.

[FIG. 28] relates to Example 2 of Embodiment 1 of the invention, and is a block diagram of part of the imaging device, including an internal block diagram of the video signal processing section in FIG. 1.

[FIG. 29] relates to Example 2 of Embodiment 1 of the invention, and is a diagram showing an example of the relationship between the magnitude of a motion vector and the weight coefficient used in blending together a color-interpolated image and a previous-frame blended image.

[FIG. 30A] is a diagram showing how the entire image region of an image is divided into nine partial image regions.

[FIG. 30B] is a diagram showing a group of motion vectors between two images.

[FIG. 31] relates to Example 3 of Embodiment 1 of the invention, and is a block diagram of part of the imaging device, including an internal block diagram of the video signal processing section in FIG. 1.

[FIG. 32A] relates to Example 3 of Embodiment 1 of the invention, and is a diagram showing an example of a filter for calculating an image characteristics amount.

[FIG. 32B] relates to Example 3 of Embodiment 1 of the invention, and is a diagram showing an example of a filter for calculating an image characteristics amount.

[FIG. 32C] relates to Example 3 of Embodiment 1 of the invention, and is a diagram showing an example of the relationship between an image characteristics amount and the weight coefficient maximum value at the time of blending together a current-frame color-interpolated image and a previous-frame blended image.

[FIG. 33] relates to Example 4 of Embodiment 1 of the invention, and is a diagram showing the make-up of an MPEG movie.

[FIG. 34] relates to Example 4 of Embodiment 1 of the invention, and is a diagram showing the relationship between a series of color-interpolated images, blended images, a series of output blended images, and a series of overall weight coefficients.

[FIG. 35] relates to Example 5 of Embodiment 1 of the invention, and is a diagram showing how signals are added up when binning pattern groups (P_{B1} to P_{B4}) are used.

[FIG. 36] relates to Example 5 of Embodiment 1 of the invention, and is a diagram showing how pixel signals appear in a source image obtained when binned reading is performed by use of the binning pattern groups in FIG. 35.

[FIG. 37] relates to Example 5 of Embodiment 1 of the invention, and is a diagram showing how signals are added up when binning pattern groups (P_{C1} to P_{C4}) are used.

[FIG. 38] relates to Example 5 of Embodiment 1 of the invention, and is a diagram showing how pixel signals appear in a source image obtained when binned reading is performed by use of the binning pattern groups in FIG. 37.

[FIG. 39] relates to Example 5 of Embodiment 1 of the invention, and is a diagram showing how signals are added up when binning pattern groups (P_{D1} to P_{D4}) are used.

[FIG. 40] relates to Example 5 of Embodiment 1 of the invention, and is a diagram showing how pixel signals appear in a source image obtained when binned reading is performed by use of the binning pattern groups in FIG. 39.

[FIG. 41] relates to Example 6 of Embodiment 1 of the invention, and is a diagram showing skipping pattern groups (Q_{A1} to Q_{A4}).

[FIG. 42] relates to Example 6 of Embodiment 1 of the invention, and is a diagram showing how pixel signals appear in a source image obtained when skipped reading is performed by use of the skipping pattern groups in FIG. 41.

[FIG. 43] relates to Example 6 of Embodiment 1 of the invention, and is a diagram showing skipping pattern groups (Q_{B1} to Q_{B4}).

[FIG. 44] relates to Example 6 of Embodiment 1 of the invention, and is a diagram showing how pixel signals appear in a source image obtained when skipped reading is performed by use of the skipping pattern groups in FIG. 43.

[FIG. 45] relates to Example 6 of Embodiment 1 of the invention, and is a diagram showing skipping pattern groups (Q_{C1} to Q_{C4}).

[FIG. 46] relates to Example 6 of Embodiment 1 of the invention, and is a diagram showing how pixel signals appear in a source image obtained when skipped reading is performed by use of the skipping pattern groups in FIG. 45.

[FIG. 47] relates to Example 6 of Embodiment 1 of the invention, and is a diagram showing skipping pattern groups (Q_{D1} to Q_{D4}).

[FIG. 48] relates to Example 6 of Embodiment 1 of the invention, and is a diagram showing how pixel signals appear in a source image obtained when skipped reading is performed by use of the skipping pattern groups in FIG. 47.

[FIG. 49] relates to Example 6 of Embodiment 1 of the invention, and is a diagram showing how signals are added up and skipped over when binning-skipping patterns are used.

[FIG. 50] relates to Example 6 of Embodiment 1 of the invention, and is a diagram showing how pixel signals appear in a source image when photosensitive pixel signals are read according to the binning-skipping patterns in FIG. 49.

[FIG. 51] relates to Example 7 of Embodiment 1 of the invention, and is a block diagram of part of the imaging device, including an internal block diagram of the video signal processing section in FIG. 1.

[FIG. 52] relates to Example 7 of Embodiment 1 of the invention, and is a flow chart showing the operation of the video signal processing section in FIG. 51.

[FIG. 53] relates to Example 7 of Embodiment 1 of the invention, and is a diagram showing G, B, and R signals in a color-reconstructed image generated from the color-interpolated image in FIG. 21.

[FIG. 54] relates to Example 7 of Embodiment 1 of the invention, and is a diagram showing G, B, and R signals in a color-reconstructed image generated from the color-interpolated image in FIG. 22.

[FIG. 55] relates to Example 7 of Embodiment 1 of the invention, and is a diagram showing G, B, and R signals in a color-reconstructed image generated from the color-interpolated image in FIG. 23.

[FIG. 56] relates to Example 7 of Embodiment 1 of the invention, and is a diagram showing G, B, and R signals in a color-reconstructed image generated from the color-interpolated image in FIG. 24.

[FIG. 57] relates to Example 7 of Embodiment 1 of the invention, and is a diagram showing how G, B, and R signals are mixed in a source image obtained by use of the fourth binning pattern.

[FIG. 58] relates to Example 1 of Embodiment 2 of the invention, and is a block diagram of part of the imaging device, including an internal block diagram of the video signal processing section in FIG. 1.

[FIG. 59] relates to Example 1 of Embodiment 2 of the invention, and is a diagram showing how G, B, and R signals are mixed in a source image acquired by use of the first binning pattern.

[FIG. 60] relates to Example 1 of Embodiment 2 of the invention, and is a diagram showing G, B, and R signals in a color-interpolated image generated from the source image in FIG. 59.

[FIG. 61] relates to Example 1 of Embodiment 2 of the invention, and is a diagram showing how G, B, and R signals are mixed in a source image acquired by use of the second binning pattern.

[FIG. 62] relates to Example 1 of Embodiment 2 of the invention, and is a diagram showing G, B, and R signals in a color-interpolated image generated from the source image in FIG. 61.

[FIG. 63] relates to Example 1 of Embodiment 2 of the invention, and is a diagram showing how G, B, and R signals are mixed in a source image acquired by use of the third binning pattern.

[FIG. 64] relates to Example 1 of Embodiment 2 of the invention, and is a diagram showing G, B, and R signals in a color-interpolated image generated from the source image in FIG. 63.

[FIG. 65] relates to Example 1 of Embodiment 2 of the invention, and is a diagram showing how G, B, and R signals are mixed in a source image acquired by use of the fourth binning pattern.

[FIG. 66] relates to Example 1 of Embodiment 2 of the invention, and is a diagram showing G, B, and R signals in a color-interpolated image generated from the source image in FIG. 65.

[FIG. 67] relates to Example 1 of Embodiment 2 of the invention, and is a diagram showing G, B, and R signals in a color-interpolated image generated from the source image in FIG. 59.

[FIG. 68] relates to Example 1 of Embodiment 2 of the invention, and is a diagram showing G, B, and R signals in a color-interpolated image generated from the source image in FIG. 61.

[FIG. 69] relates to Example 1 of Embodiment 2 of the invention, and is a diagram showing color-interpolated images and corresponding luminance images.

[FIG. 70] relates to Example 1 of Embodiment 2 of the invention, and is a diagram showing G, B, and R signals in a color-interpolated image for generating G, B, and R signals in an output blended image.

[FIG. 71] relates to Example 1 of Embodiment 2 of the invention, and is a diagram showing B and R signals in a color-interpolated image for generating G, B, and R signals in an output blended image.

[FIG. 72] relates to Example 1 of Embodiment 2 of the invention, and is a diagram showing the locations of G, B, and R signals in an output blended image.

[FIG. 73] relates to Example 2 of Embodiment 2 of the invention, and is a block diagram of part of the imaging device, including an internal block diagram of the video signal processing section in FIG. 1.

[FIG. 74] relates to Example 2 of Embodiment 2 of the invention, and is a diagram showing an example of the relationship between the magnitude of a motion vector and the weight coefficient used in mixing color signals of a plurality of color-interpolated images.

[FIG. 75A] is a diagram showing how the entire image region of an image is divided into nine partial image regions.

[FIG. 75B] is a diagram showing a group of motion vectors between two images.

[FIG. 76A] is a diagram showing the relationship between two color-interpolated images and one output blended image.

[FIG. 76B] is a diagram showing the relationship between two color-interpolated images and one output blended image.

[FIG. 77] relates to Example 3 of Embodiment 2 of the invention, and is a block diagram of part of the imaging device, including an internal block diagram of the video signal processing section in FIG. 1.

[FIG. 78A] relates to Example 3 of Embodiment 2 of the invention, and is a diagram showing an example of the relationship between the contrast amount of an image and the reference motion value used in mixing color signals of a plurality of color-interpolated images.

[FIG. 78B] relates to Example 3 of Embodiment 2 of the invention, and is a diagram showing an example of the relationship between the magnitude of a motion vector and the weight coefficient used in mixing color signals of a plurality of color-interpolated images.

[FIG. 79] relates to Example 4 of Embodiment 2 of the invention, and is a diagram showing the relationship between a series of color-interpolated images, output blended images, and a series of overall weight coefficients.

[FIG. 80] is a diagram showing a rightward-up straight line and a rightward-down straight line defined in Example 6 of Embodiment 2.

[FIG. 81] relates to Example 6 of Embodiment 2 of the invention, and is a diagram showing the relationship between a series of source images, a series of color-interpolated images, a series of motion vectors, and the binning pattern groups applied to the source images respectively.

[FIG. 82] relates to Example 8 of Embodiment 2 of the invention, and is a block diagram of part of the imaging device, including an internal block diagram of the video signal processing section in FIG. 1.

[FIG. 83] relates to Example 8 of Embodiment 2 of the invention, and is a diagram showing the relationship between a series of source images, a series of color-interpolated images, and a series of converted images.

[FIG. 84] relates to related art, and is a diagram illustrating processing for generating an output image from a source image obtained through binned reading of photosensitive pixel signals of an image sensor.

### BEST MODE FOR CARRYING OUT THE INVENTION

The significance and benefits of the present invention will become clearer through the description of different embodiments of it given below. It should be understood, however, that the embodiments presented below are merely examples of how the invention is carried out, and that the meanings of the terms used to describe the invention and its features are not limited to those in which they are used in the description of the specific embodiments below.

Different embodiments of the invention will be described specifically below with reference to the accompanying drawings. Among the different drawings referred to in the course, the same parts are identified by the same reference signs, and in principle no overlapping description of the same parts will be repeated. Before the description of specific embodiments and practical examples, namely Embodiment 1 embracing Examples 1 to 7 and Embodiment 2 embracing Examples 1 to 8, first, a description will be given of features common to, and applicable to, all embodiments and practical examples.

FIG. 1 is an overall block diagram of an imaging device 1 embodying the invention. The imaging device 1 is, for example, a digital video camera. The imaging device 1 is capable of shooting moving images and still images, and is capable of shooting a still image during shooting of a moving image.

### [Basic Configuration]

The imaging device 1 includes: an image shooting section 11, an AFE (analog front-end) 12, a video signal processing section 13, a microphone 14, an audio signal processing section 15, a compression section 16, an internal memory 17 such as a DRAM (dynamic random access memory), an external memory 18 such as an SD (Secure Digital) card or a magnetic disc, a decompression section 19, a VRAM (video random access memory) 20, an audio output circuit 21, a TG (timing generator) 22, a CPU (central processing unit) 23, a bus 24, a bus 25, an operation section 26, a display section 27, and a loudspeaker 28. The operation section 26 has a record button 26a, a shutter release button 26b, operation keys 26c, etc. The individual blocks within the imaging device 1 exchange signals (data) with one another via the bus 24 or 25.

The TG 22 generates timing control signals for controlling the timing of different operations in the entire imaging device 1, and feeds the generated timing control signals to the relevant blocks within the imaging device 1. The timing control signals include a vertical synchronizing signal Vsync and a horizontal synchronizing signal Hsync. The CPU 23 controls the operation of the individual blocks within the imaging device 1 in a concentrated fashion. The operation section 26 is operated by a user. How the operation section 26 is operated is conveyed to the CPU 23. Whenever necessary, different blocks within the imaging device 1 temporarily record various kinds of data (digital signals) to the internal memory 17 during signal processing.

The image shooting section 11 includes an image sensor (IS, image sensing device) 33, and also includes an optical system, an aperture stop, and a driver (none is shown). The light incoming from a subject passes through the optical system and the aperture stop and enters the image sensor 33. The optical system is composed of lenses, which focus an optical image of the subject on the image sensor 33. The TG 22 generates driving pulses, which are synchronous with the timing control signals mentioned above, for driving the image sensor 33, and feeds the driving pulses to the image sensor 33.

The image sensor 33 is a solid-state image sensor such as a CCD (charge-coupled device) or CMOS (complementary metal oxide semiconductor) image sensor. The image sensor 33 photoelectrically converts the optical image incident on it through the optical system and the aperture stop, and outputs the electrical signal resulting from the photoelectric conversion to the AFE 12. More specifically, the image sensor 33 has a plurality of photosensitive pixels (not shown in FIG. 1) arrayed in a two-dimensional matrix; during each period of shooting, each photosensitive pixel accumulates an amount of signal charge commensurate with the length of time of its exposure to light (exposure time). Each photosensitive pixel then outputs an electrical signal with a magnitude proportional to the amount of signal charge accumulated there, and such electrical signals from individual photosensitive pixels are outputted sequentially, synchronously with the driving pulses from the TG 22, to the AFE 12 in the succeeding stage.

The AFE 12 amplifies the signals, which are analog signals, outputted from the image sensor 33 (individual photosensitive pixels), then converts the amplified analog signals into digital signals, and then outputs the resulting digital signals to the video signal processing section 13. The amplification factor at the AFE 12 is controlled by the CPU 23. The video signal processing section 13 applies various kinds of image processing to the image represented by the output signals from the AFE 12, and generates a video signal representing the image that has undergone the image processing. Typically, the video signal is composed of a luminance signal Y, which represents the luminance of the image, and color difference signals U and V, which represent the color (hue) of the image.

The microphone 14 converts sounds around the imaging device 1 into an analog audio signal, and the audio signal processing section 15 then converts the analog audio signal into a digital audio signal.

The compression section 16 compresses the video signal from the video signal processing section 13 by a predetermined compression method. During shooting and recording of a moving or still image, the compressed video signal is recorded to the external memory 18. The compression section 16 also compresses the audio signal from the audio signal processing section 15 by a predetermined compression method. During shooting and recording of a moving image, the video signal from the video signal processing section 13 and the audio signal from the audio signal processing section 15 are compressed, in a form temporally associated with each other, at the compression section 16, and are then recoded, in the thus compressed form, to the external memory 18.

The record button 26a is a push button switch for entering an instruction to start/stop shooting and recording of a moving image. The shutter release button 26b is a push button switch for entering an instruction to shoot and record a still image.

The imaging device 1 operates in different modes, and these modes include a shooting mode, in which it can shoot moving and still images, and a playback mode, in which it can play back (replay) and display moving and still images stored in the external memory 18 on the display section 27. Operating the operation keys 26c allows switching among different modes.

In shooting mode, shooting is performed successively at a predetermined frame period, so that the image sensor 33 yields a series of shot images. A series of images, like the series of shot images here, denotes a group of chronologically ordered images. Data representing an image will be called image data. Image data may be thought of as a kind of video signal. A one-frame-period equivalent of image data represents one frame of image. The video signal processing section 13 applies various kinds of image processing to the image represented by the output signals from the AFE 12, and the image before undergoing those image processing, that is, the image represented by the unprocessed output signals from the AFE 12, will be called the source image. Accordingly, a one-frame-period equivalent of the output signals from the AFE 12 represents one source image.

In shooting mode, when the user presses the record button 26a, under the control of the CPU 23, the video signal obtained after the pressing is, along with the corresponding audio signal, sequentially recorded via the compression section 16 to the external memory 18. After the start of moving image shooting, when the user presses the record button 26a again, the recording of the video and audio signals to the external memory 18 is ended, and thus the shooting of one moving image is completed. On the other hand, in shooting mode, when the user presses the shutter release button 26b, a still image is shot and recoded.

In playback mode, when the user operates the operation keys 26c in a predetermined way, a compressed video signal representing a moving or still image recorded in the external memory 18 is decompressed at the decompression section 19 and is written to the VRAM 20. Incidentally, in shooting mode, normally, regardless of how the record button 26a and the shutter release button 26b are operated, the video signal processing section 13 keeps generating the video signal, which thus keeps being written to the VRAM 20.

The display section 27 is a display device such as a liquid crystal display, and displays an image based on the video signal written in the VRAM 20. When a moving image is played back in playback mode, a compressed audio signal recorded in the external memory 18 and corresponding to the moving image is delivered to the decompression section 19 as well. The decompression section 19 decompresses the received audio signal and then delivers the result to the audio output circuit 21. The audio output circuit 21 converts the received digital audio signal into an audio signal (for example, an analog audio signal) reproducible on the loudspeaker 28, and outputs the result to the loudspeaker 28. The loudspeaker 28 outputs audio (sounds) reproduced from the audio signal from the audio output circuit 21.

### [Photosensitive Pixel Array on Image Sensor]

FIG. 2 shows a photosensitive pixel array within an effective region of the image sensor 33. The effective region of the image sensor 33 is rectangular in shape, and one vertex of the rectangular is taken as the origin on the image sensor 33. It is here assumed that the origin is at the upper left corner of the effective region of the image sensor 33. The effective region of the image sensor 33 is formed by a two-dimensional array of photosensitive pixels of which the number equals the product (for example, several hundred squared to several thousand squared) of multiplying the number of effective pixels in the vertical direction in the image sensor 33 by the number of effective pixels in the horizontal direction in it. A given photosensitive pixel within the effective region of the image sensor 33 is represented by P_{S}[x, y]. Here, x and y are integers. It is assumed that, relative to the origin of the image sensor 33, the farther rightward a photosensitive pixel is located, the greater the value of variable x, and the farther downward a photosensitive pixel is located, the greater the value of variable y. On the image sensor 33, the up/down direction (upward/downward) corresponds to the vertical direction, and the left/right direction (leftward/rightward) to the horizontal direction.

For the sake of convenience, FIG. 2 only shows a region of 10×10 photosensitive pixels, and this photosensitive pixel region will be identified by the reference sign 200. In the following description, particular attention is paid to the photosensitive pixels within the photosensitive pixel region 200. Within the photosensitive pixel region 200, there are present a total of 100 photosensitive pixels P_{S}[x, y] fulfilling the inequalities “1≦x≦10” and “1≦y≦10.” In photosensitive pixels belonging to the photosensitive pixel region 200, photosensitive pixel P_{S}[1, 1] is located closest to the origin of the image sensor 33, and photosensitive pixel P_{S}[10, 10] is located farthest from the origin of the image sensor 33.

The imaging device 1 uses only one image sensor; that is, it adopts a single-panel configuration. FIG. 3 shows the array of color filters placed respectively in front of photosensitive pixels of the image sensor 33. The array shown in FIG. 3 is one generally called a Bayer array. The color filters include red filters, which only transmit a red component of light; green filters, which only transmit a green component of light; and blue filters, which only transmit a blue component of light. Red filters are placed in front of photosensitive pixels Ps[2n_{A}−1, 2n_{B}], blue filters are placed in front of photosensitive pixels P_{S}[2n_{A}, 2n_{B}−1], and green filters are placed in front of photosensitive pixels P_{S}[2n_{A}−1, 2n_{B}−1] and P_{S}[2n_{A}, 2n_{B}]. Here n_{A} and n_{B} are integers. In FIG. 3, and also in FIG. 5 etc. referred to later, parts corresponding to red filters are identified by R, parts corresponding to green filters are identified by G, and parts corresponding to blue filters are identified by B.

Photosensitive pixels having red, green, and blue filters placed in front of them are also called red, green, and blue photosensitive pixels respectively. Each photosensitive pixel photoelectrically converts the light incident on it through the corresponding color filter into an electrical signal. Such electrical signals represent the image signals of photosensitive pixels, and in the following description these will also be called “photosensitive pixel signals.” Red, green, and blue photosensitive pixels are sensitive to red, green, and blue components, respectively, of the light incoming through the optical system.

Methods of reading photosensitive pixel signals from the image sensor 33 include an all-pixel reading method, a binned (additive) reading method, and a skipped (thinned-out) reading method. In a case where photosensitive pixel signals are read from the image sensor 33 by an all-pixel reading method, the photosensitive pixel signals from all the photosensitive pixels present within the effective region of the image sensor 33 are individually fed via the AFE 12 to the video signal processing section 13,. A binned reading method and a skipped reading method will be discussed later. In the following description, for the sake of simplicity, the signal amplification and digitization at AFE 12 will be ignored.

### [Pixel Array on Source Image]

FIG. 4A shows a pixel array on the source image. FIG. 4A only shows a partial image region within the source image which corresponds to the photosensitive pixel region 200 in FIG. 2. The source image, and for that matter any image in general, may be thought of as being formed by a group of pixels arrayed two-dimensionally on an image coordinate plane XY, which is a two-dimensional orthogonal coordinate system (see FIG. 4B).

The symbol P[x, y] represents a pixel on the source image which corresponds to photosensitive pixel P_{S}[x, y]. It is assumed that, relative to the origin of the source image which corresponds to the origin of the image sensor 33, the farther rightward a pixel is located, the greater the value of variable x in the corresponding symbol P[x, y], and the farther downward a pixel is located, the greater the value of variable y in the corresponding symbol P[x, y]. On the source image, the up/down direction (upward/downward) corresponds to the vertical direction, and the left/right direction (leftward/rightward) to the horizontal direction.

In the following description, a given position on the image sensor 33 is represented by the symbol [x, y], and likewise a given position on the source image or any other image (that is, a position on the image coordinate plane XY) is also represented by the symbol [x, y]. Position [x, y] on the image sensor 33 matches the position of photosensitive pixel P_{S}[x, y] on the image sensor 33, and position [x, y] on an image (on the image coordinate plane XY) matches the position of pixel P[x, y] on the source image. It should be noted here that each photosensitive pixel on the image sensor 33 and each pixel on the source image has predetermined non-zero dimensions in the horizontal and vertical directions; thus, strictly, position [x, y] on the image sensor 33 matches the center position of photosensitive pixel P_{S}[x, y], and position [x, y] on an image (on the image coordinate plane XY) matches the center position of pixel [x, y] on the source image. In the following description, wherever necessary to indicate the position of a pixel (or photosensitive pixel), the symbol [x, y] is used also to indicate a pixel position.

The horizontal-direction width of one pixel on the source image is represented by Wp (see FIG. 4A). The vertical-direction width of one pixel on the source image equals Wp. Accordingly, on an image (on the image coordinate plane XY), the distance between position [x, y] and position [x+1, y], and the distance between position [x, y] and position [x, y+1], both equal Wp.

In a case where an all-pixel reading method is used, the photosensitive pixel signals of photosensitive pixels P_{S}[x, y] as outputted from the AFE 12 are, as they are, the pixel signals of pixels P[x, y] on the source image. FIG. 5 is an exemplary diagram of pixel signals on a source image 220 obtained by an all-pixel reading method. For the sake of simplified illustration, FIG. 5, and also FIGS. 6A and 6B referred to later, only shows part of the source image which corresponds to pixel positions [1, 1] to [4, 4]. Moreover, in FIG. 5, and also in FIGS. 6A and 6B referred to later, the color components (R, G, and B) that the individual pixel signals represent are indicated at their respective pixel positions.

In the source image 220, the pixel signal at pixel position [2n_{A}−1, 2n_{B}] is the photosensitive pixel signal of red photosensitive pixel P_{S}[2n_{A}−1, 2n_{B}] as outputted from the AFE 12; the pixel signal at pixel position [2n_{A}, 2n_{B}−1] is the photosensitive pixel signal of blue photosensitive pixel P_{S}[2n_{A}, 2n_{B}−1] as outputted from the AFE 12; and the pixel signal at pixel position [2n_{A}−1, 2n_{B}−1] or P[2n_{A}, 2n_{B}] is the photosensitive pixel signal of green photosensitive pixel P_{S}[2n_{A}−1, 2n_{B}−1] or P_{S}[2n_{A}, 2n_{B}] as outputted from the AFE 12 (where n_{A} and n_{B} are integers). In this way, in a case where an all-pixel reading method is used, the pixel intervals on an image are even as are the photosensitive pixel intervals on the image sensor 33.

In the source image 220, at one pixel position, there is present a pixel signal of only one of red, green, and blue components. The video signal processing section 13 performs interpolation such that each pixel forming an image is assigned pixel signals of three color components. Such processing whereby a color signal at a given pixel position is generated by interpolation is called color interpolation. In particular, color interpolation performed such that pixel signals of three color components are present at a given pixel position is generally called demosaicing, which is also known as color reconstruction.

In the following description, in the source image or any other image, pixel signals representing the data of red, green, and blue components will be called R, G, and B signals respectively. Any of R, G, and B signals may also be simply called a color signal, and they may be collectively called color signals.

FIG. 6A is a conceptual diagram of the color interpolation applied to the source image 220, and FIG. 6B is an exemplary diagram of a color-interpolated image 230 obtained by applying the color interpolation to the source image 220. FIG. 6A conceptually shows how color interpolation proceeds for each of G, B, and R signals, and FIG. 6B show the presence of G, B, and R signals at each pixel position in the color-interpolated image 230. In FIG. 6A, circled Gs, Bs, and Rs indicate G, B, and R signals, respectively, obtained by interpolation using neighboring pixels (pixels located at the tails of arrows). To avoid cluttering the diagrams, the G, B, and R signals in the color-interpolated image 230 are shown separately; in practice, from the source image 220, one color-interpolated image 230 is generated.

As is well known, in the color interpolation applied to the source image 220, the pixel signals of a color of interest at pixels neighboring a pixel of attention are mixed, and thereby the pixel signal of the color of interest at the pixel of attention is generated. (Throughout the present specification, “something of interest” means something on which interest is currently being focused; likewise “something of attention” means something to which attention is currently being paid.) For example, as shown in the left portions of FIGS. 6A and 6B, an average signal of the pixel signals at pixel positions [3, 1], [2, 2], [4, 2], and [3, 3] on the source image 220 is generated as the G signal at pixel position [3, 2] on the color-interpolated image 230, and an average signal of the pixel signals at pixel positions [2, 2], [1, 3], [3, 3] and, [2, 4]on the source image 220 is generated as the G signal at pixel position [2, 3] on the color-interpolated image 230. The pixel signals at pixel positions [2, 2] and [3, 3] on the source image 220 are, as they are, taken as the G signals at pixel positions [2, 2] and [3, 3] on the color-interpolated image 230. Likewise, by a well-known signal interpolation method, the B and R signals at each pixel on the color-interpolated image 230 are generated.

The imaging device 1 operates in a unique fashion when it uses a binned or skipped reading method. As embodiments and practical examples of the invention illustrative of how that unique operation is achieved, presented below one by one will be Embodiment 1, which embraces Examples 1 to 7, and Embodiment 2, which embraces Examples 1 to 8. Unless inconsistent, any description given in connection with a given practical example of a given embodiment applies to any other practical example of the same embodiment, and to any practical example of any other embodiment as well.

### Embodiment 1

First, a first embodiment (Embodiment 1) of the invention will be described. Unless otherwise indicated, numbered practical examples mentioned in the course of the following description of Embodiment 1 are those of Embodiment 1.

### Example 1

First, a first practical example (Example 1) will be described. In Example 1, adopted as the method for reading pixel signals from the image sensor 33 is a binned reading method, whereby reading proceeds concurrently with binning (adding-up) of a plurality of photosensitive pixel signals. Here, as binned reading proceeds, the binning pattern used is changed from one to the next among a plurality of binning patterns. A binning (addition) pattern denotes a specific pattern of combination of photosensitive pixels that are going to be binned together (added up). The plurality binning patterns used include two or more of a first, a second, a third, and a fourth binning pattern that are different from one another.

FIGS. 7A, 7B, 8A, and 8B show how signals are added up when the first, second, third, and fourth binning patterns, respectively, are used. The binning patterns corresponding to FIGS. 7A, 7B, 8A, and 8B will also be identified as binning patterns P_{A1}, P_{A2}, P_{A3}, and P_{A4} respectively. FIGS. 9A to 9D show how pixel signals appear in the source image when binned reading is performed by use of the first, second, third, and fourth binning patterns respectively. As described previously, attention is paid to the photosensitive pixel region 200 composed of photosensitive pixels P_{S}[1, 1] to P_{S}[10, 10] (see FIG. 2).

In FIGS. 7A, 7B, 8A, and 8B, solid black circles indicate the locations of virtual photosensitive pixels that are assumed to be present when the first, second, third, and fourth binning patterns, respectively, are used. In FIGS. 7A, 7B, 8A, and 8B, arrows pointing to solid black circles indicate how, to generate the pixel signals of the virtual photosensitive pixels corresponding to those circles, the pixel signals of photosensitive pixels neighboring the virtual photosensitive pixels are added up.

When the first binning pattern, that is, binning pattern P_{A1}, is used, the following assumptions are made:

at pixel positions [2+4n_{A}, 2+4n_{B}] and [3+4n_{A}, 3+4n_{B}] on the image sensor 33, virtual green photosensitive pixels are located; at pixel positions [3+4n_{A}, 2+4n_{B}] on the image sensor 33, virtual blue photosensitive pixels are located; and at pixel positions [2+4n_{A}, 3+4n_{B}] on the image sensor 33, virtual red photosensitive pixels are located.

When the second binning pattern, that is, binning pattern P_{A2}, is used, the following assumptions are made:

at pixel positions [4+4n_{A}, 4+4n_{B}] and [5+4n_{A}, 5+4n_{B}] on the image sensor 33, virtual green photosensitive pixels are located; at pixel positions [5+4n_{A}, 4+4n_{B}] on the image sensor 33, virtual blue photosensitive pixels are located; and at pixel positions [4+4n_{A}, 5+4n_{B}] on the image sensor 33, virtual red photosensitive pixels are located.

When the third binning pattern, that is, binning pattern P_{A3}, is used, the following assumptions are made:

at pixel positions [4+4n_{A}, 2+4n_{B}] and [5+4n_{A}, 3+4n_{B}] on the image sensor 33, virtual green photosensitive pixels are located; at pixel positions [5+4n_{A}, 2+4n_{B}] on the image sensor 33, virtual blue photosensitive pixels are located; and at pixel positions [4+4n_{A}, 3+4n_{B}] on the image sensor 33, virtual red photosensitive pixels are located.

When the fourth binning pattern, that is, binning pattern P_{A4}, is used, the following assumptions are made:

at pixel positions [2+4n_{A}, 4+4n_{B}] and [3+4n_{A}, 5+4n_{B}] on the image sensor 33, virtual green photosensitive pixels are located; at pixel positions [3+4n_{A}, 4+4n_{B}] on the image sensor 33, virtual blue photosensitive pixels are located; and at pixel positions [2+4n_{A}, 5+4n_{B}] on the image sensor 33, virtual red photosensitive pixels are located.

As described previously, n_{A} and n_{B} are integers.

Taken as the pixel signal of a given virtual photosensitive pixel is the sum signal of the pixel signals of real photosensitive pixels adjacent to that virtual photosensitive pixel on its upper left, upper right, lower left, and lower right. For example, in a case where binning pattern Pₘ is used, taken as the pixel signal of the virtual green photosensitive pixel located at pixel position [2, 2] is the sum signal of the pixel signals of actual green pixel signals P_{S}[1, 1], [3, 1], [1, 3], and [3, 3]. In this way, by adding up the pixel signals of four photosensitive pixels placed behind color filters of the same color, the pixel signal of one virtual photosensitive pixel located at the center of those four photosensitive pixels is formed. This applies regardless of what binning pattern is used (including binning patterns P_{B1} to P_{B4}, P_{C1} to P_{C4}, and P_{D1} to P_{D4}, which will be described later).

Then, by handling the pixel signals of such virtual photosensitive pixels located at positions [x, y] as the pixel signals at positions [x, y] on an image, a source image is acquired.

Accordingly, the source image obtained by binned reading using the first binning pattern (P_{A1}) is, as shown in FIG. 9A, one including: pixels located at pixel positions [2+4n_{A}, 2+4n_{B}] and [3+4n_{A}, 3+4n_{B}], each having a G signal alone; pixels located at pixel positions [3+4n_{A}, 2+4n_{B}], each having a B signal alone; and pixels located at pixel positions [2+4n_{A}, 3+4n_{B}], each having an R signal alone.

Likewise, the source image obtained by binned reading using the second binning pattern (P_{A},) is, as shown in FIG. 9B, one including: pixels located at pixel positions [4+4n_{A}, 4+4n_{B}] and [5+4n_{A}, 5+4n_{B}], each having a G signal alone; pixels located at pixel positions [5+4n_{A}, 4+4n_{B}], each having a B signal alone; and pixels located at pixel positions [4+4n_{A}, 5+4n_{B}], each having an R signal alone.

Likewise, the source image obtained by binned reading using the third binning pattern (P_{A3}) is, as shown in FIG. 9C, one including: pixels located at pixel positions [4+4n_{A}, 2+4n_{B}] and [5+4n_{A}, 3+4n_{B}], each having a G signal alone; pixels located at pixel positions [5+4n_{A}, 2+4n_{B}], each having a B signal alone; and pixels located at pixel positions [4+4n_{A}, 3+4nₑ], each having an R signal alone.

Likewise, the source image obtained by binned reading using the fourth binning pattern (P_{A4}) is, as shown in FIG. 9C, one including: pixels located at pixel positions [2+4n_{A}, 4+4n_{B}] and [3+4n_{A}, 5+4n_{B}], each having a G signal alone; pixels located at pixel positions [3+4n_{A}, 4+4n_{B}], each having a B signal alone; and pixels located at pixel positions [2+4n_{A}, 5+4n_{B}], each having an R signal alone.

In the following description, the source images obtained by binned reading using the first, second, third, and fourth binning patterns will be called the source images of the first, second, third, and fourth binning patterns respectively. In a given source image, a pixel that has a R, G, or B signal will also be called a real pixel, and a pixel having no R, G, or B signal will also be called a blank pixel. Accordingly, for example, in the source image of the first binning pattern, only the pixels located at [2+4n_{A}, 2+4n_{B}], [3+4n_{A}, 3+4n_{B}], [3+4n_{A}, 2+4n_{B}], and [2+4n_{A}, 3+4n_{B}] are real pixels and all other pixels (for example, the pixel located at position [1, 1]) are blank pixels.

### [Video Signal Processing Section]

FIG. 10 is a block diagram of part of the imaging device 1 in FIG. 1, including an internal block diagram of a video signal processing section 13a, which here serves as the video signal processing section 13 in FIG. 1. The video signal processing section 13a includes blocks identified by the reference signs 51 to 56. FIG. 11 is a flow chart showing the operation of the video signal processing section 13a in FIG. 10. Now, with reference to FIGS. 10 and 11, an outline of the configuration and operation of the video signal processing section 13a will be described. It should be noted that the flow chart of FIG. 11 deals with processing of one image.

First, from the AFE 12, RAW data (image data representing a source image) is inputted to the video signal processing section 13a (STEP 1). Inside the video signal processing section 13a, the RAW data is inputted to a color interpolation section 51.

The color interpolation section 51 applies color interpolation to the RAW data obtained at STEP 1 (STEP 2). Applying the color interpolation to the RAW data converts it into R, G, and B signals (a color-interpolated image). The R, G, and B signals constituting the color-interpolated image are sequentially inputted to an image blending section 54.

At the color interpolation section 51, every time the frame period elapses, one source image after another, namely the source images of a first, a second, . . . a (n−1)th, and an nth frame, is acquired from the image sensor 33 via the AFE 12. From these source images of the first, second, . . . (n−1)th, and nth frame, the color interpolation section 51 generates color-interpolated images of the first, second, . . . (n−1)th and nth frame respectively.

The color-interpolated image generated at STEP 2 (in the following description also called the current-frame color-interpolated image) is inputted to the image blending section 54 so as to be blended with the blended image outputted from the image blending section 54 one frame before (in the following description also called the previous-frame blended image). Through this blending, a blended image is generated (STEP 3). Here, it is assumed that, from the color-interpolated images of the first, second, . . . (n−1)th, and nth frame that are inputted from the color interpolation section 51 to the image blending section 54, blended images of the first, second, . . . (n−1)th, and nth frame are generated (where n is an integer of 2 or more). That is, as a result of the color-interpolated image of the nth frame being blended with the blended image of the (n−1)th frame, the blended image of the nth frame is generated.

To enable the blending at STEP 3, a frame memory 52 temporarily stores the blended image outputted from the image blending section 54. For example, when the color-interpolated image of the nth frame is inputted to the image blending section 54, the blended image of the (n−1)th frame is stored in the frame memory 52. The image blending section 54 thus receives, on one hand, one signal after another representing the previous-frame blended image as stored in the frame memory 52 and, on the other hand, one signal after another representing the current-frame color-interpolated image as inputted from the color interpolation section 51, and blends each pair of images together to output one signal after another representing the blended image.

Based on the current-frame color-interpolated image as currently being outputted from the color interpolation section 51 and the previous-frame blended image as stored in the frame memory 52, a motion detection section 53 detects a motion of an object between those images. It detects a motion, for example, by finding an optical flow between consecutive frames. In that case, based on the image data of the color-interpolated image of the nth frame and the image data of the blended image of the (n−1)th frame, an optical flow between the two images is found. Based on the optical flow, the motion detection section 53 recognizes the magnitude and direction of a motion between the two images. The result of the detection by the motion detection section 53 is inputted to the image blending section 54, where it is used in the blending performed by the image blending section 54 (STEP 3).

The blended image generated at STEP 3 is inputted to a color reconstruction section 55. The color reconstruction section 55 applies color reconstruction (demosaicing) to the blended image inputted to it, and thereby generates an output blended image (STEP 4). The output blended image generated at STEP 4 is inputted to a signal processing section 56.

The signal processing section 56 converts the R, G, and B signals constituting the output blended image inputted to it into a video signal composed of a luminance signal Y and color difference signals U and V (STEP 5). The operations at STEPs 1 to 5 described above are performed on the image of each frame. Thus, the video signal (Y, U, and V signals) of one frame after another is generated, and is sequentially outputted from the signal processing section 56. The video signal thus outputted is inputted to the compression section 16, where it is compressed-encoded by a predetermined image compression method.

In the configuration shown in FIG. 10, the route from the AFE 12 to the compression section 16 passes via the color interpolation section 51, the motion detection section 53, the image blending section 54, the color reconstruction section 55, and the signal processing section 56 arranged in this order. These may be arranged in any other order. Now, a description will be given of a basic method for color interpolation, followed by a detailed description of the functions of the color interpolation section 51, the motion detection section 53, the image blending section 54, and the color reconstruction section 55.

### [Basic Method for Color Interpolation]

Now, with interest focused on G signals, a basic method for color interpolation will be described with reference to FIGS. 12A and 12B. When a G signal in the color-interpolated image is generated from G signals in the source image, an interpolated pixel position is determined on the color-interpolated image, and attention is paid to a plurality of real pixels on the source image which are located at positions close to that interpolated pixel position and which have a G signal. Then, the G signals of those real pixels of attention are mixed, and thereby the G signal at the interpolated pixel position is generated. For the sake of convenience, the plurality of real pixels to which attention is paid to be involved in the generation of the G signal at an interpolated pixel position will be called a group of considered real pixels.

In a case where the number of real pixels constituting a group of considered real pixels is two and the group consists of a first and a second pixel, the G signal value at an interpolated pixel position is calculated according to Equation (Al) below. Here, as shown in FIG. 12A, d₁ and d₂ respectively represent the distance between the pixel position of the first pixel and the interpolated pixel position and the distance between the pixel position of the second pixel and the interpolated pixel position. A “distance” here is a distance as observed on an image (a distance as observed on the image coordinate plane XY). The V_{GT} calculated by substituting the G signal values of the first and second pixels in the source image for V_{G1} and V_{G2} in Equation (A1) represents the G signal value at the interpolated pixel position. That is, the G signal value at the interpolated pixel position is calculated by linearly interpolating the G signal values of the group of considered real pixels in accordance with the distances d₁ and d₂. A G signal value denotes the value of a G signal (a similar note applies to R and B signal values).

$$\begin{matrix}[ Equation 1 ] & \\ \begin{matrix}{v}_{GT} = \frac{( {d}_{1} + {d}_{2} ) - {d}_{1}}{{d}_{1} + {d}_{2}} {v}_{G 1} + \frac{( {d}_{1} + {d}_{2} ) - {d}_{2}}{{d}_{1} + {d}_{2}} {v}_{G 2} \\ = \frac{{d}_{2}}{{d}_{1} + {d}_{2}} {v}_{G 1} + \frac{{d}_{1}}{{d}_{1} + {d}_{2}} {v}_{G 2}\end{matrix} & ( A1 )\end{matrix}$$

Likewise, in a case where the number of real pixels constituting the group of considered real pixels is four and the group consists of a first to a fourth pixel, through linear interpolation similar to that in the case where the number of real pixels constituting the group of considered real pixels is two, the G signal value at the interpolated pixel position is calculated. Specifically, by mixing the G signal values V_{G1} to V_{G4} of the first to fourth pixels in a ratio commensurate with their respective distances d₁ to d₄ from the interpolated pixel position, the G signal value V_{GT} at the interpolated pixel position is calculated (see FIG. 12B).

Instead, the G signal values V_{G1} to V_{Gm} of a first to an mth pixel may be mixed to calculate the G signal value at the interpolated pixel position (where m is an integer of 2 or more). That is, when the number of real pixels constituting the group of considered real pixels is m, through linear interpolation performed by a method similar to that described above (a method involving mixing in a ratio commensurate with the distances d₁ to dₘ of the real pixel positions from the interpolated pixel position), it is possible to calculate the G signal value V_{GT}. While the foregoing discusses a basic method for color interpolation with interest focused on G signals, color interpolation for B and R signals is performed by similar methods. That is, irrespective of whether the color of interest is green, blue, or red, color interpolation for color signals of the color of interest is performed by the basic method described above. For a discussion of color interpolation for B or R signals, all that needs to be done is to read “G” in the above description as “B” or “R”.

### [Color Interpolation Section]

The color interpolation section 51 applies color interpolation on the source image obtained from the AFE 12, and thereby generates a color-interpolated image. In Example 1, and also in Examples 2 to 5 and 7 described later, the source image fed from the AFE 12 to the color interpolation section 51 is, for example, a source image of the first, second, third, or fourth binning pattern. Accordingly, in the source image that is going to be subjected to color interpolation, the pixel intervals (intervals between adjacent real pixels) are uneven as shown in FIGS. 9A to 9D. On a source image like those, the color interpolation section 51 performs color interpolation by the basic method described above.

Now, with reference to FIGS. 13 and 14, a description will be given of color interpolation for generating a color-interpolated image 261 from a source image 251 of the first binning pattern. FIG. 13 is a diagram showing how G, B, and R signals of real pixels in the source image 251 are mixed to generate the G, B, and R signals at an interpolated pixel position. FIG. 14 is a diagram showing G, B, and R signals on the color-interpolated image 261. In FIG. 13, solid black circles indicate interpolated pixel positions at which G, B, and R signals are to be generated in the color-interpolated image 261, and black and gray arrows pointing to solid black circles indicate how a plurality of color signals are mixed to generate color signals at interpolated pixel positions. To avoid cluttering the diagrams, G, B, and R signals in the color-interpolated image 261 are shown separately; in practice, one color-interpolated image 261 is generated from the source image 251.

First, with reference to the left portions of FIGS. 13 and 14, a description will be given of the color interpolation for generating a G signal in the color-interpolated image 261 from a G signal in the source image 251. Pay attention to block 241 encompassing positions [x, y] fulfilling the inequalities “2≦x≦7” and “2≦y≦7.” Then consider a G signal at an interpolated pixel position on the color-interpolated image 261 which is generated from G signals of real pixels belonging to block 241. A G signal (or B signal, or R signal) generated with respect to an interpolated pixel position will also be specially called an interpolated G signal (or interpolated B signal, or interpolated R signal).

From G signals of real pixels on the source image 251 belonging to block 241, interpolated G signals are generated with respect to two interpolated pixel positions 301 and 302 set on the color-interpolated image 261. The interpolated pixel position 301 is [3.5, 3.5], and the interpolated G signal at this interpolated pixel position 301 is calculated by use of the G signals at real pixels P[2, 2], P[6, 2], P[2, 6], and P[6, 6]. On the other hand, the interpolated pixel position 302 is [5.5, 5.5], and the interpolated G signal at this interpolated pixel position 302 is calculated by use of the G signals at real pixels P[3, 3], P[7, 3], P[3, 7], and P[7, 7].

In the left portion of FIG. 14, the interpolated G signals generated at the interpolated pixel positions 301 and 302 are indicated by the reference signs 311 and 312 respectively. The value of the interpolated G signal 311 generated at the interpolated pixel position 301 is generated by mixing the pixel values (that is, G signal values) of real pixels P[2, 2], P[6, 2], P[2, 6], and P[6, 6] in the source image 251 in a ratio commensurate with their respective distances from the interpolated pixel position 301. Likewise, the value of the interpolated G signal 312 generated at the interpolated pixel position 302 is generated by mixing the pixel values (that is, G signal values) of real pixels P[3, 3], P[7, 3], P[3, 7], and P[7, 7] in a ratio commensurate with their respective distances from the interpolated pixel position 302. A pixel value denotes the value of a pixel signal.

When attention is paid to block 241, two interpolated pixel positions 301 and 302 are set, and with respect to them, interpolated G signals 311 and 312 are generated. The block of attention is then, starting at block 241, shifted four pixels in the horizontal or vertical direction at a time, and every time such a shift is done, similar generation of interpolated G signals is performed. In this way, G signals on the color-interpolated image 261 as shown in the left portion of FIG. 21 are generated. In the left portion of FIGS 21, G1_{2,2} and G1_{3,3} correspond to the interpolated G signals 311 and 312 in the left portion of FIG. 14. Prior to a detailed discussion of FIG. 21, first, a description will be given of color interpolation with respect to B and R signals and color interpolation using the second to fourth binning patterns.

With reference to the middle portions of FIGS. 13 and 14, a description will be given of color interpolation for generating a B signal in the color-interpolated image 261 from B signals in the source image 251. Pay attention to block 241, and consider a B signal at an interpolated pixel position on the color-interpolated image 261 which is generated from B signals of real pixels belonging to block 241.

From B signals of real pixels belonging to block 241, an interpolated B signal is generated with respect to an interpolated pixel position 321 set on the color-interpolated image 261. The interpolated pixel position 321 is [3.5, 5.5], and the interpolated B signal at this interpolated pixel position 321 is calculated by use of the B signals at real pixels P[3, 2], P[7, 2], P[3, 6], and P[7, 6].

In the middle portion of FIG. 14, the interpolated B signal generated at the interpolated pixel positions 321 is indicated by the reference sign 331. The value of the interpolated B signal 331 generated at the interpolated pixel position 331 is generated by mixing the pixel values (that is, B signal values) of real pixels P[3, 2], P[7, 2], P[3, 6], and P[7, 6] in the source image 251 in a ratio commensurate with their respective distances from the interpolated pixel position 321.

When attention is paid to block 241, an interpolated pixel position 321 is set, and with respect to it, an interpolated B signal 331 is generated. The block of attention is then, starting at block 241, shifted four pixels in the horizontal or vertical directions at a time, and every time such a shift is done, similar generation of an interpolated B signal is performed. In this way, B signals on the color-interpolated image 261 as shown in the middle portion of FIG. 21 are generated. In the middle portion of FIG. 21, B1_{2,3} corresponds to the interpolated B signal 331 in the middle portion of FIG. 14.

With reference to the right portions of FIGS. 13 and 14, a description will be given of color interpolation for generating an R signal in the color-interpolated image 261 from R signals in the source image 251. Pay attention to block 241, and consider an R signal at an interpolated pixel position on the color-interpolated image 261 which is generated from R signals of real pixels belonging to block 241.

From R signals of real pixels belonging to block 241, an interpolated R signal is generated with respect to an interpolated pixel position 341 set on the color-interpolated image 261. The interpolated pixel position 341 is [5.5, 3.5], and the interpolated R signal at this interpolated pixel position 341 is calculated by use of the R signals at real pixels P[2, 3], P[6, 3], P[2, 7], and P[6, 7].

In the right portion of FIG. 14, the interpolated R signal generated at the interpolated pixel positions 341 is indicated by the reference sign 351. The value of the interpolated R signal 351 generated at the interpolated pixel position 341 is generated by mixing the pixel values (that is, R signal values) of real pixels P[2, 3], P[6, 3], P[2, 7], and P[6, 7] in the source image 251 in a ratio commensurate with their respective distances from the interpolated pixel position 341.

When attention is paid to block 241, an interpolated pixel position 341 is set, and with respect to it, an interpolated R signal 351 is generated. The block of attention is then, starting at block 241, shifted four pixels in the horizontal or vertical directions at a time, and every time such a shift is done, similar generation of an interpolated R signal is performed. In this way, R signals on the color-interpolated image 261 as shown in the right portion of FIG. 21 are generated. In the right portion of FIG. 21, R1_{3,2} corresponds to the interpolated R signal 351 in the middle portion of FIG. 14.

A description will now be given of color interpolation with respect to the source images of the second, third, and fourth binning patterns. The source images of the second, third, and fourth binning patterns will be identified by the reference signs 252, 253, and 254 respectively, and the color-interpolated images generated from the source images 252, 253, and 254 will be identified by the reference signs 262, 263, and 264 respectively.

FIG. 15 is a diagram showing how G, B, and R signals of real pixels in the source image 252 are mixed to generate the G, B, and R signals at interpolated pixel positions in the color-interpolated image 262. FIG. 16 is a diagram showing G, B, and R signals on the color-interpolated image 262. FIG. 17 is a diagram showing how G, B, and R signals of real pixels in the source image 253 are mixed to generate the G, B, and R signals at interpolated pixel positions in the color-interpolated image 263. FIG. 18 is a diagram showing G, B, and R signals on the color-interpolated image 263. FIG. 19 is a diagram showing how G, B, and R signals of real pixels in the source image 254 are mixed to generate the G, B, and R signals at interpolated pixel positions in the color-interpolated image 264. FIG. 20 is a diagram showing G, B, and R signals on the color-interpolated image 264.

In FIG. 15, solid black circles indicate interpolated pixel positions at which G, B, and R signals are to be generated in the color-interpolated image 262; in FIG. 17, solid black circles indicate interpolated pixel positions at which G, B, and R signals are to be generated in the color-interpolated image 263; in FIG. 19, solid black circles indicate interpolated pixel positions at which G, B, and R signals are to be generated in the color-interpolated image 264. Black and gray arrows pointing to solid black circles indicate how a plurality of color signals are mixed to generate color signals at interpolated pixel positions. To avoid cluttering the diagrams, G, B, and R signals in the color-interpolated image 262 are shown separately; in practice, one color-interpolated image 262 is generated from the source image 252. A similar note applies to the color-interpolated images 263 and 264.

Relative to the locations of real pixels in the source image of the first binning pattern, the locations of real pixels in the source image of the second binning pattern are shifted 2·Wp rightward and 2·Wp downward, the locations of real pixels in the source image of the third binning pattern are shifted 2·Wp rightward, and the locations of real pixels in the source image of the fourth binning pattern are shifted 2·Wp downward (see also FIG. 4A).

As described above, as the binning pattern differs, the locations of real pixels in the source image differ. On the other hand, the interpolated pixel positions at which individual color signals are generated are similar among the different binning patterns, and in addition are even (distances between adjacent color signals are equal). Specifically, interpolated G signals are located at interpolated pixel positions [1.5+4n_{A}, 1.5+4n_{B}] and [3.5+4n_{A}, 3.5+4n_{B}], interpolated B signals are located at interpolated pixel positions [3.5+4n_{A}, 1.5+4n_{B}], and interpolated R signals are located at interpolated pixel positions [1.5+4n_{A}, 3.5+4n_{B}] (where n_{A} and n_{B} are integers). In this way, the interpolated pixel positions of interpolated G signals, interpolated B signals, and interpolated R signals are all predetermined positions.

Thus, the positional relationship between the positions of real pixels that have the G, B, and R signals to be used to calculate interpolated G, B, and R signals and the interpolated pixel positions at which the interpolated G, B, and R signals are generated differs among different binning patterns as described below. Accordingly, the methods by which color interpolation is applied to the source images obtained by use of the second to fourth binning patterns differ among the different source images (among the different binning patterns used). Below will be described specific methods by which color interpolation is applied to the source images obtained by use of the second to fourth binning patterns and the resulting color-interpolated images.

As for the source image 252 corresponding to FIG. 15 dealing with the second binning pattern, attention is paid to block 242 encompassing positions [x, y] fulfilling the inequalities “4≦x≦9” and “4≦y≦9,” and from the G, B, and R signals of real pixels belonging to block 242, interpolated G, B, and R signals are generated with respect to interpolated pixel positions set on the color-interpolated image 262 shown in FIG. 16. Generated are: two interpolated G signals, specifically one (at interpolated pixel position [5.5, 5.5]) calculated by use of the G signals at real pixels P[4, 4], P[8, 4], P[4, 8], and P[8, 8] and one (at interpolated pixel position [7.5, 7.5]) calculated by use of the G signals at real pixels P[5, 5], P[9, 5], P[5, 9], and P[9, 9]; an interpolated B signal at interpolated pixel position [7.5, 5.5] calculated by use of the B signals at real pixels P[5, 4], P[9, 4], P[5, 8], and P[9, 8]; and an interpolated R signal at interpolated pixel position [5.5, 7.5] calculated by use of the R signals at real pixels P[4, 5], P[8, 5], P[4, 9], and P[8, 9].

As for the source image 253 corresponding to FIG. 17 dealing with the third binning pattern, attention is paid to block 243 encompassing positions [x, y] fulfilling the inequalities “4≦x≦9” and “2≦y≦7,” and from the G, B, and R signals of real pixels belonging to block 243, interpolated G, B, and R signals are generated with respect to interpolated pixel positions set on the color-interpolated image 263 shown in FIG. 18. Generated are: two interpolated G signals, specifically one (at interpolated pixel position [7.5, 3.5]) calculated by use of the G signals at real pixels P[4, 2], P[8, 2], P[4, 6], and P[8, 6] and one (at interpolated pixel position [5.5, 5.5]) calculated by use of the G signals at real pixels P[5, 3], P[9, 3], P[5, 7], and P[9, 7]; an interpolated B signal at interpolated pixel position [7.5, 5.5] calculated by use of the B signals at real pixels P[5, 2], P[9, 2], P[5, 6], and P[9, 6]; and an interpolated R signal at interpolated pixel position [5.5, 3.5] calculated by use of the R signals at real pixels P[4, 3], P[8, 3], P[4, 7], and P[8, 7].

As for the source image 254 corresponding to FIG. 19 dealing with the fourth binning pattern, attention is paid to block 244 encompassing positions [x, y] fulfilling the inequalities “2≦x≦7” and “4≦y≦9,” and from the G, B, and R signals of real pixels belonging to block 244, interpolated G, B, and R signals are generated with respect to interpolated pixel positions set on the color-interpolated image 264 shown in FIG. 20. Generated are: two interpolated G signals, specifically one (at interpolated pixel position [5.5, 5.5]) calculated by use of the G signals at real pixels P[2, 4], P[6, 4], P[2, 8], and P[6, 8] and one (at interpolated pixel position [3.5, 7.5]) calculated by use of the G signals at real pixels P[3, 5], P[7, 5], P[3, 9], and P[7, 9]; an interpolated B signal at interpolated pixel position [3.5, 5.5] calculated by use of the B signals at real pixels P[3, 4], P[7, 4], P[3, 8], and P[7, 8]; and an interpolated R signal at interpolated pixel position [5.5, 7.5] calculated by use of the R signals at real pixels P[2, 5], P[6, 5], P[2, 9], and P[6, 9].

Each of the blocks of attention 242 to 244 is then, starting at blocks 242 to 244 respectively, shifted four pixels in the horizontal or vertical direction at a time, and every time such a shift is done, similar generation of interpolated G, B, and R signals is perfornied. In this way, G, B, and R signals on the color-interpolated images 262 to 264 as shown in the left portion of FIGS. 22, 23, and 24 are generated.

FIG. 21 is a diagram showing the locations of G, B, and R signals in the color-interpolated image 261, and FIG. 22 is a diagram showing the locations of G, B, and R signals in the color-interpolated image 262. FIG. 23 is a diagram showing the locations of G, B, and R signals in the color-interpolated image 263, and FIG. 24 is a diagram showing the locations of G, B, and R signals in the color-interpolated image 264.

In FIG. 21, G, B, and R signals on the color-interpolated image 261 are indicated by circles, and the reference signs in the circles represent the G, B, and R signals corresponding to those circles. In FIG. 22, G, B, and R signals on the color-interpolated image 262 are indicated by circles, and the reference signs in the circles represent the G, B, and R signals corresponding to those circles. In FIG. 23, G, B, and R signals on the color-interpolated image 263 are indicated by circles, and the reference signs in the circles represent the G, B, and R signals corresponding to those circles. In FIG. 24, G, B, and R signals on the color-interpolated image 264 are indicated by circles, and the reference signs in the circles represents the G, B, and R signals corresponding to those circles.

G, B, and R signals in the color-interpolated image 261 will be represented by the symbols G1_{i, j}, B1_{i, j}, and R1_{i, j} respectively, and G, B, and R signals in the color-interpolated image 262 will be represented by the symbols G2_{i, j}, B2_{i, j}, and R2_{i, j} respectively. G, B, and R signals in the color-interpolated image 263 will be represented by the symbols G3_{i, j}, B3_{i, j}, and R3_{i, j} respectively, and G, B, and R signals in the color-interpolated image 264 will be represented by the symbols G4_{i, j}, B4_{i, j}, and R4_{i, j} respectively. Here, i and j are integers. G1_{i, j} to G4_{i, j} will also be used as symbols representing the values of G signals (a similar note applies to B1_{i, j} to B4_{i, j}, and R1_{i, j} to R4_{i, j}).

The i and j in the notation for the color signals G1_{i, j}, B1_{i, j}, and R1_{i, j} of a pixel of attention in the color-interpolated image 261 represent the horizontal and vertical pixel numbers, respectively, of the pixel of attention in the color-interpolated image 261 (a similar note applies to the notation for color signals G2_{i, j} to G4_{i, j}, B2_{i, j} to B4_{i, j}, and R2_{i, j} to R4_{i, j}).

A description will now be given of the array of color signals G1_{i, j}, B1_{i, j}, and R1_{i, j} in the color-interpolated image 261 generated by use of the first binning pattern. As shown in FIG. 21, position [1.5, 1.5] in the color-interpolated image 261 is taken as the signal reference position, and the horizontal and vertical pixel numbers i and j of the signal at this signal reference position are assumed to be 1 and 1 respectively. That is, in the color-interpolated image 261, the G signal at position [1.5, 1.5] is identified by G1_{1, 1}.

Starting at the signal reference position (position [1.5, 1.5]), scanning signals on the color-interpolated image 261 rightward encounters color signals G1_{1, 1}, B1_{2, 1}, G1_{3, 1}, B1_{4, 1}, . . . in this order.

Starting at the signal reference position (position [1.5, 1.5]), scanning signals on the color-interpolated image 261 downward encounters color signals G1_{1, 1}, R1_{1, 2}, G1_{1, 3}, R1_{1, 4}, . . . in this order.

Moreover, as described above, individual color signals are located at predetermined interpolated pixel positions. Thus, a color signal whose horizontal pixel number i is an even number and whose vertical pixel number j is an odd number is a B signal; a color signal whose horizontal pixel number i is an odd number and whose vertical pixel number j is an even number is an R signal; and a color signal whose horizontal and vertical pixel numbers i and j are both even, or both odd, numbers is a G signal.

A description will now be given of the array of color signals G2_{i, j}, B2_{i, j}, and R2_{i, j} in the color-interpolated image 262 generated by use of the second binning pattern. As shown in FIG. 22, position [3.5, 3.5] in the color-interpolated image 262 is taken as the signal reference position, and the horizontal and vertical pixel numbers i and j of the signal at this signal reference position are assumed to be 1 and 1 respectively. That is, in the color-interpolated image 262, the G signal at position [3.5, 3.5] is identified by G2_{1, 1}.

Starting at the signal reference position (position [3.5, 3.5]), scanning signals on the color-interpolated image 262 rightward encounters color signals G2_{1, 1}, R2_{2, 1}, G2_{3, 1}, R2_{4, 1}, . . . in this order.

Starting at the signal reference position (position [3.5, 3.5]), scanning signals on the color-interpolated image 262 downward encounters color signals G2_{1, 1}, B2_{1, 2}, G2_{1, 3}, B2_{1, 4}, . . . in this order.

Moreover, as described above, individual color signals are located at predetermined interpolated pixel positions. Thus, a color signal whose horizontal pixel number i is an odd number and whose vertical pixel number j is an even number is a B signal; a color signal whose horizontal pixel number i is an even number and whose vertical pixel number j is an odd number is an R signal; and a color signal whose horizontal and vertical pixel numbers i and j are both even, or both odd, numbers is a G signal.

A description will now be given of the array of color signals G3_{i, j}, B3_{i, j}, and R3_{i, j} in the color-interpolated image 263 generated by use of the third binning pattern. As shown in FIG. 23, position [3.5, 1.5] in the color-interpolated image 263 is taken as the signal reference position, and the horizontal and vertical pixel numbers i and j of the signal at this signal reference position are assumed to be 1 and 1 respectively. That is, in the color-interpolated image 263, the B signal at position [3.5, 1.5] is identified by B3_{1, 1}.

Starting at the signal reference position (position [3.5, 1.5]), scanning signals on the color-interpolated image 263 rightward encounters color signals B3_{1, 1}, G3_{2, 1}, B3_{3, 1}, G3_{4, 1}, . . . in this order.

Starting at the signal reference position (position [3.5, 1.5]), scanning signals on the color-interpolated image 263 downward encounters color signals B3_{1, 1}, G3_{1, 2}, B3_{1, 3}, G3_{1, 4}, . . . in this order.

Moreover, as described above, individual color signals are located at predetermined interpolated pixel positions. Thus, a color signal whose horizontal and vertical pixel numbers i and j are both odd numbers is a B signal; a color signal whose horizontal and vertical pixel numbers i and j are both even numbers is an R signal; and a color signal whose horizontal pixel number i is an even number and whose vertical pixel number j is an odd number, or whose horizontal pixel number i is an odd number and whose vertical pixel number j is an even number, is a G signal.

A description will now be given of the array of color signals G4_{i, j}, B4_{i, j}, and R4_{i, j} in the color-interpolated image 264 generated by use of the fourth binning pattern. As shown in FIG. 24, position [1.5, 3.5] in the color-interpolated image 264 is taken as the signal reference position, and the horizontal and vertical pixel numbers i and j of the signal at this signal reference position are assumed to be 1 and 1 respectively. That is, in the color-interpolated image 264, the R signal at position [1.5, 3.5] is identified by R4_{1, 1}.

Starting at the signal reference position (position [1.5, 3.5]), scanning signals on the color-interpolated image 264 rightward encounters color signals R4_{1, 1}, G4_{2, 1}, R4_{3, 1}, G4_{4, 1}, . . . in this order.

Starting at the signal reference position (position [1.5, 3.5]), scanning signals on the color-interpolated image 264 downward encounters color signals R4_{1, 1}, G4_{1, 2}, R4_{1, 3}, G4_{1, 4}, . . . in this order.

Moreover, as described above, individual color signals are located at predetermined interpolated pixel positions. Thus, a color signal whose horizontal and vertical pixel numbers i and j are both even numbers is a B signal; a color signal whose horizontal and vertical pixel numbers i and j are both odd numbers is an R signal; and a color signal whose horizontal pixel number i is an even number and whose vertical pixel number j is an odd number, or whose horizontal pixel number i is an odd number and whose vertical pixel number j is an even number, is a G signal.

Irrespective of which binning pattern is used, color signals in the color-interpolated images 261 to 264 are located at positions [2×(i−1)+Signal Reference Position (Horizontal), 2×(j−1)+Signal Reference Position (Vertical)]. For example when the first binning pattern is used, G1_{2, 4} is located at position [2×(2−1)+1.5, 2×(4−1)+1.5], that is, at position [3.5, 7.5].

The specific interpolation methods shown in FIGS. 13, 15, 17, and 19 are merely examples, and any other interpolation methods may instead be adopted. For example, the number of considered real pixels may be different than in the methods described above (four); the real pixels used to calculate the signal values of interpolated pixels may be different than in the methods described above. It is, however, preferable to perform interpolation by use of real pixels close to interpolated pixel positions as in the method described above, because it is then possible to calculate the signal values of interpolated pixels more accurately.

Interpolated pixel positions (the positions of color signals) may be different from those described above. For example, the positions of interpolated B signals and the positions of interpolated R signals may be interchanged, or the positions of interpolated B or R signals and the positions of interpolated G signals may be interchanged. It is, however, preferable that, among color-interpolated images obtained from source images obtained by use of different binning patterns, interpolated pixel positions are similar (color signals generated at the same positions [x, y] are of the same types).

### [Motion Detection Section]

A description will now be given of the function of the motion detection section 53 in FIG. 10. It is assumed that, as in the example described above, the motion detection section 53 detects a motion by finding an optical flow between, based on the image data of, the image data of the blended image of the (n−1)th frame as stored in the frame memory 52 and the image data of the color-interpolated image of the nth frame. The blended image is an even-pixel-interval image like the color-interpolated images 261 to 264; that is, it has G, B, and R signals one at each of the interpolated pixel positions as described above.

Now, with reference to FIG. 26, a description will be given of individual color signals in the blended image. FIG. 26 is a diagram showing individual color signals in the blended image. In FIG. 26, a G signal is represented by Gc_{i, j}, a B signal is represented by Bc_{i, j}, and an R signal is represented by Rc_{i, j}. As shown in FIG. 26, color signals Gc_{i, j}, Bc_{i, j}, and Rc_{i, j} in the blended image are located at positions [x, y] equal to those at which color signals G1_{i, j}, B1_{i, j}, and R1_{i, j} in the color-interpolated image 261 generated by use of the first binning pattern are located. In other words, the horizontal and vertical pixel numbers i and j of the color signal located at a given position [x, y] are the same between the color-interpolated image 261 and the blended image 270. That is, the horizontal and vertical pixel numbers i and j match between the color-interpolated image 261 and the blended image 270.

Here, as an example, a description will be given of a method for deriving an optical flow between the color-interpolated image 262 shown in FIG. 22 and the blended image 270 (see FIG. 26) stored in the frame memory 52. As shown in FIG. 25, the motion detection section 53 first generates a luminance image 262Y from the R, G, and B signals of the color-interpolated image 262 and generates a luminance image 270Y from the R, G, and B signals of the blended image 270. A luminance image is a grayscale image containing luminance signals alone. The luminance images 262Y and 270Y are each formed by arraying pixels having a luminance signal at even intervals in both the horizontal and vertical directions. In FIG. 25, each “Y” indicates a luminance signal.

The luminance signal of a pixel of attention on the luminance image 262Y is derived from G, B, and R signals on the color-interpolated image 262 which are located at or close to the pixel of attention. For example, to generate the luminance signal at position [5.5, 5.5] on the luminance image 262Y, G signal G2_{2, 2} in the color-interpolated image 262 is, as it is, used as the G signal at position [5.5, 5.5], the B signal at position [5.5, 5.5] is calculated by linear interpolation from B signals B2_{1, 2} and B2_{3, 2} on the color-interpolated image 262, and the R signal at position [5.5, 5.5] is calculated by linear interpolation from R signals R2_{2, 1} and R2_{2, 3} (see FIG. 22). Then, from the G, B, and R signals at position [5.5, 5.5] calculated based on the color-interpolated image 262, the luminance signal at position [5.5, 5.5] on the luminance image 262Y is calculated. The calculated luminance signal is taken as the luminance signal of the pixel located at position [5.5, 5.5] on the luminance image 262Y.

To generate the luminance signal at position [5.5, 5.5] on the luminance image 270Y, G signal Gc_{3, 3} in the color-interpolated image 270 is, as it is, used as the G signal at position [5.5, 5.5], the B signal at position [5.5, 5.5] is calculated by linear interpolation from B signals Bc_{2, 3} and B2_{4, 3} on the color-interpolated image 270, and the R signal at position [5.5, 5.5] is calculated by linear interpolation from R signals Rc_{3, 2} and Rc_{3, 4} (see FIG. 26). Then, from the G, B, and R signals at position [5.5, 5.5] calculated based on the color-interpolated image 270, the luminance signal at position [5.5, 5.5] on the luminance image 262Y is calculated. The calculated luminance signal is taken as the luminance signal of the pixel located at position [5.5, 5.5] on the luminance image 262Y.

The pixel located at position [5.5, 5.5] on the luminance image 262Y and the pixel located at position [5.5, 5.5] on the luminance image 270Y correspond to each other. While a method for calculating the luminance signal at position [5.5, 5.5] has been described, the luminance signals at other positions are calculated by a similar method. In this way, the luminance signal at a given pixel position [x, y] on the luminance image 262Y and the luminance signal at a given pixel position [x, y] on the luminance image 270Y are calculated.

After generating the luminance images 262Y and 270Y, the motion detection section 53 then, by comparing luminance signals in the luminance image 262Y with luminance signals in luminance image 270Y, finds an optical flow between the luminance images 262Y and 270Y. Examples of methods for deriving an optical flow include a block matching method, a representative point matching method, and a gradient method. The found optical flow is expressed by a motion vector representing a movement of a subject between the luminance images 262Y and 270Y. The motion vector is a two-dimensional quantity representing the direction and magnitude of the movement. The motion detection section 53 handles the optical flow found between the luminance images 262Y and 270Y as an optical flow between the images 262 and 270, and outputs it as the result of motion detection.

An “optical flow (or motion vector) between the luminance images 262Y and 270Y” denotes an “optical flow (or motion vector) between the luminance image 262Y and the luminance image 270Y.” Similar designations will be used when an optical flow, a motion vector, a movement, or anything related to any of those is discussed with respect to a plurality of images other than the luminance images 262Y and 270Y. Accordingly, for example, an “optical flow between the color-interpolated and blended images 262 and 270” denotes an “optical flow between the color-interpolated image 262 and the blended image 270.”

The above-described method for generating a luminance image is merely one example, and any other generation method may instead be used. For example, the color signals used to calculate the individual color signals at a predetermined position (in the above example, [5.5, 5.5]) by interpolation may be different than in the above example.

As in the above example, the G, B, and R signals at each of those interpolated pixel position where a color signal can exist (position [1.5+2n_{A}, 1.5+2n_{B}], where n_{A} and n_{B} are integers) may be individually calculated by interpolation to generate a luminance image; instead, the G, B, and R signals at each of the same positions as real pixels (that is, positions [1, 1], [1, 2], . . . , [2, 1], [2, 2], . . . ) may be individually calculated by interpolation to generate a luminance image.

### [Image Blending Section]

A description will now be given of the function of the image blending section 54 in FIG. 10. The image blending section 54 generates a blended image based on the color signals of the color-interpolated image outputted from the color interpolation section 51, the color signals of the blended image stored in the frame memory 52, and the result of motion detection inputted from the motion detection section 53.

When performing the blending, the image blending section 54 refers to the current-frame color-interpolated image and the previous-frame blended image. At this time, if the binning pattern of the source image used to generate the color-interpolated image to be blended changes with time, this may lead to the problem of a mismatch in the positions [x, y] of the color signals to be blended, or the problem of the positions [x, y] of the color signals (Gc_{i, j}, Bc_{i, j}, and Rc_{i, j}) outputted from the image blending section 54 being inconstant, causing the image as a whole to move. To avoid that, when a series of blended images are generated, a blending reference image is set. Then, for example by controlling the image data read from the frame memory 52 and from the color interpolation section 51, the above-mentioned problems resulting from the binning pattern changing with time are coped with. An example will be discussed below, taking up a case where the color-interpolated image 261 generated by use of the source image of the first binning pattern is set as the blending reference image.

The following discussion deals with a case where, with no consideration given to the result of motion detection outputted from the motion detection section 53, a color-interpolated image and a blended image are blended at predetermined proportions (with a weight factor of k). The weight factor k here represents the proportion (contribution factor) of the signal values of the previous-frame blended image in the signal values of the current-frame blended image generated. On the other hand, the proportion of the signal values of the current-frame color-interpolated image in the signal values of the current-frame blended image generated is given by (1−k).

Now, under the above assumptions, with reference to FIGS. 21 and 26, a description will be given of a method of generating one blended image 270 (current frame) from the color-interpolated image 261 generated by use of the source image of the first binning pattern and the blended image 270 (previous frame).

As described above, color signals G1_{i, j}, B1_{i, j}, and R1_{i, j} in the color-interpolated image 261 and color signals Gc_{i, j}, Bc_{i, j}, and Rc_{i, j} in the blended image 270 are located at the same positions. Accordingly, in this example, through weighted addition of the G, B, and R signal values of the color-interpolated image 261 and the G, B, and R signal values of the blended image 270 according to Equations (B1) to (B3) below, the G, B, and R signal values Gpc_{i, j}, Bpc_{i, j}, and Rpc_{i, j} in the current-frame blended image 270 are calculated. In Equations (B1) to (B3) below, the G, B, and R signal values of the previous-frame blended image 270 are represented by Gpc_{i, j}, Bpc_{i, j}, and Rpc_{i, j} for distinction from the G, B, and R signal values of the current-frame blended image 270.

[Equation 2]

Gc_{i, j}=(1−k)×G1_{i, j}+k×Gpc_{i, j} (B1)

Bc_{i, j}=(1−k)×B1_{i, j}+k×Bpc_{i, j} (B2)

Rc_{i, j}=(1−k)×R1_{i, j}+k×Rpc_{i, j} (B3)

As Equations (B1) to (B3) indicate, the G, B, and R signal values Gpc_{i, j}, and Rpc_{i, j} of the previous-frame blended image 270 and the G, B, and R signal values G1_{i, j}, B1_{i, j}, and R1_{i, j} of the color-interpolated image 261 are blended with no shift in the horizontal and vertical pixel numbers i and j. In this way, the G, B, and R signal values Gc_{i, j}, Bc_{i, j}, and Rc_{i, j} of the current-frame blended image 270 are obtained.

Next, with reference to FIGS. 22 and 26, a description will be given of a method of generating one blended image 270 (current frame) from the color-interpolated image 262 generated by use of the source image of the second binning pattern and the blended image 270 (previous frame).

Between the color-interpolated image 262 (the second binning pattern) and the blended image 270 (similar to the first binning pattern), the same position [x, y] is assigned different horizontal and vertical pixel numbers i and j. Specifically, color signals G2_{i-1, j-1}, B2_{i-1, j-1}, and R2_{i-1, j-1} of the color-interpolated image 262 and color signals Gc_{i, j}, Bc_{i, j}, and Rc_{i, j} of the blended image 270 indicate the same position. Accordingly, in this example, through weighted addition of the G, B, and R signal values of the color-interpolated image 262 and the G, B, and R signal values of the blended image 270 according to Equations (B4) to (B6) below, the G, B, and R signal values Gc_{i, j}, Bc_{i, j}, and Rc_{i, j} of the current-frame blended image 270 are calculated. Also in Equations (B4) to (B6) below, the G, B, and R signal values of the previous-frame blended image 270 are represented by Gpc_{i, j}, Bpc_{i, j}, and Rpc_{i, j}for distinction from the G, B, and R signal values of the current-frame blended image 270.

[Equation 3]

Gc_{i, j}=(1−k)×G1_{i-1, j-1}+k×Gpc_{i, j} (B4)

Bc_{i, j}=(1−k)×B2_{i-1, j-1}+k×Bpc_{i, j} (B5)

Rc_{i, j}=(1−k)×R2_{i-1, j-1}+k×Rpc_{i, j} (B6)

As Equations (B4) to (B6) indicate, in this example, blending is performed with a shift in the horizontal and vertical pixel numbers i and j. Specifically, the G, B, and R signal values Gpc_{i, j}, Bpc_{i, j}, and Rpc_{i, j} of the previous-frame blended image 270 and the G, B, and R signal values G2_{i-1, j-1}, B2_{i-1, j-1} and R2_{i-1, j-1} of the color-interpolated image 262 are blended. In this way, the G, B, and R signal values Gc_{i, j}, Bc_{i, j}, and Rc_{i, j} of the current-frame blended image 270 are obtained.

Next, with reference to FIGS. 23 and 26, a description will be given of a method of generating one blended image 270 (current frame) from the color-interpolated image 263 generated by use of the source image of the third binning pattern and the blended image 270 (previous frame).

Between the color-interpolated image 263 (the third binning pattern) and the blended image 270 (similar to the first binning pattern), the same position [x, y] is assigned different horizontal and vertical pixel numbers i and j. Specifically, color signals G3_{i-1, j}, B3_{i-1, j}, and R3_{i-1, j} of the color-interpolated image 263 and color signals Gc_{i, j}, Bc_{i, j}, and Rc_{i, j} of the blended image 270 indicate the same position. Accordingly, in this example, through weighted addition of the G, B, and R signal values of the color-interpolated image 263 and the G, B, and R signal values of the blended image 270 according to Equations (B7) to (B9) below, the G, B, and R signal values Gc_{i, j}, Bc_{i, j}, and Rc_{i, j} of the current-frame blended image 270 are calculated. Also in Equations (B7) to (B9) below, the G, B, and R signal values of the previous-frame blended image 270 are represented by Gpc_{i, j}, Bpc_{i, j}, and Rpc_{i, j} for distinction from the G, B, and R signal values of the current-frame blended image 270.

[Equation 4]

Gc_{i, j}=(1−k)×G3_{i-1, j}+k×Gpc_{i, j} (B7)

Bc_{i, j}=(1−k)×B3_{i-1, j}+k×Bpc_{i, j} (B8)

Rc_{i, j}=(1−k)×R3_{i-1, j}+k×Rpc_{i, j} (B9)

As Equations (B7) to (B9) indicate, in this example, blending is performed with a shift in the horizontal and vertical pixel numbers i and j. Specifically, the G, B, and R signal values Gpc_{i, j}, Bpc_{i, j}, and Rpc_{i, j} of the previous-frame blended image 270 and the G, B, and R signal values G3_{i-1, j}, B3_{i-1, j}, and R3_{i-1, j} of the color-interpolated image 263 are blended. In this way, the G, B, and R signal values Gc_{i, j}, Bc_{i, j}, and Rc_{i, j} of the current-frame blended image 270 are obtained.

Next, with reference to FIGS. 24 and 26, a description will be given of a method of generating one blended image 270 (current frame) from the color-interpolated image 264 generated by use of the source image of the fourth binning pattern and the blended image 270 (previous frame).

Between the color-interpolated image 264 (the fourth binning pattern) and the blended image 270 (similar to the first binning pattern), the same position [x, y] is assigned different horizontal and vertical pixel numbers i and j. Specifically, color signals G4_{i, j-1}, B4_{i, j-1}, and R4_{i, j-1} of the color-interpolated image 264 and color signals Gc_{i, j}, Bc_{i, j}, and Rc_{i, j} of the blended image 270 indicate the same position. Accordingly, in this example, through weighted addition of the G, B, and R signal values of the color-interpolated image 263 and the G, B, and R signal values of the blended image 270 according to Equations (B10) to (B12) below, the G, B, and R signal values Gc_{i, j}, Bc_{i, j}, and Rc_{i, j} of the current-frame blended image 270 are calculated. Also in Equations (B10) to (B12) below, the G, B, and R signal values of the previous-frame blended image 270 are represented by Gpc_{i, j}, Bpc_{i, j}, and Rpc_{i, j} for distinction from the G, B, and R signal values of the current-frame blended image 270.

[Equation 5]

Gc_{i, j}=(1−k)×G1_{i, j-1}+k×Gpc_{i, j} (B10)

Bc_{i, j}=(1−k)×B4_{i, j-1}+k×Bpc_{i, j} (B11)

Rc_{i, j}=(1−k)×R4_{i, j-1}+k×Rpc_{i, j} (B12)

As Equations (B10) to (B12) indicate, in this example, blending is performed with a shift in the horizontal and vertical pixel numbers i and j. Specifically, the G, B, and R signal values Gpc_{i, j}, Bpc_{i, j}, and Rpc_{i, j} of the previous-frame blended image 270 and the G, B, and R signal values G4_{i, j-1}, B4_{i, j-1} and R4_{i, j-1} of the color-interpolated image 264 are blended, and thereby the G, B, and R signal values Gc_{i, j}, Bc_{i, j}, and Rc_{i, j} of the current-frame blended image 270 are obtained.

Although the foregoing deals with a case where the color-interpolated image 261 generated by use of the source image of the first binning pattern is used as the blending reference image, any of the color-interpolated images 262 to 264 generated by use of the source images of the other binning patterns may instead be used as the blending reference image. Specifically, instead of assuming as in the foregoing that color signals Gc_{i, j}, Bc_{i, j}, and Rc_{i, j} of the blended image 270 are located at the same position [x, y] as color signals G1_{i, j}, B1_{i, j}, and R1_{i, j} of the color-interpolated image 261, it is also possible to assume that they are located at the same position [x, y] as the color signals (G2_{i, j} to G4_{i, j}, B2_{i, j} to B4_{i, j}, or R2_{i, j} to R4_{i, j}) of any of the color-interpolated images 262 to 264 generated by use of the other binning patterns.

It is also possible to use the correspondence relationships given by Equations (B1) to (B12) above at the time of comparison between luminance images by the motion detection section 53. In particular, in a case where the motion detection section 53 generates luminance images by finding the luminance signals at individual interpolated pixel positions, it is preferable to perform the comparison with a shift, like one at the time of blending, in the horizontal and vertical pixel numbers i and j of the obtained luminance signals. Performing the comparison in that way helps suppress a shift in the positions [x, y] of individual luminance signals Y.

### [Color Reconstruction Section]

A description will now be given of the function of the color reconstruction section 55 in FIG. 10. As described above, the motion detection section 53 applies color reconstruction (demosaicing) on the blended image outputted from the image blending section 54, and thereby generates and outputs an output blended image. Color reconstruction is generation of an image having three color signals at each interpolated pixel position, and the G, B, and R signals needed for that purpose are calculated by interpolation as will be described later.

With reference to FIG. 27, the output blended image will be described. FIG. 27 is a diagram showing individual color signals in the output blended image. In FIG. 27, G, B, and R signals in the output blended image 280 are represented by Go_{i, j}, Bo_{i, j}, and Ro_{i, j} respectively. As shown in FIG. 27, G, B, and R signals Go_{i, j}, Bo_{i, j}, and Ro_{i, j} in the output blended image 280 are located at the same positions [x, y] as color signals Gc_{i, j}, Bc_{i, j}, and Rc_{i, j} in the blended image 270 (see FIG. 26). In other words, the color signal located at a given position [x, y] has the same horizontal and vertical pixel numbers i and j between the blended image 270 and the output blended image 280. That is, the horizontal and vertical pixel numbers i and j match between the blended image 270 and the output blended image 280.

In the output blended image 280, however, three color signals Go_{i, j}, Bo_{i, j}, and Ro_{i, j} are all located at position [1.5+2×(i−1), 1.5+2×(j−1)], in the form of color components. In this respect, the output blended image 280 differs from the blended image 270, where only one color signal can be located at a given interpolated pixel position.

In color reconstruction, for example, as signal value Go_{1, 1}, signal value Gc_{1, 1} in the blended image 270 may be taken as it is. Signal value Go_{2, 1} may be calculated through linear interpolation of signal values Gc_{1, 1} and Gc_{3, 1} in the blended image 270 (see FIG. 26, left portion). Similar notes apply to B and R signals. For example, signal value Bc_{2, 1} in the blended image 270 may be, as it is, taken as signal value Bo^{2, 1}. Signal value Bo_{3, 1} may be calculated through linear interpolation of signal values Bc_{2, 1} and Bc_{4, 1} in the blended image 270 (see FIG. 26, middle portion). As signal value Ro_{1, 2}, a signal value Rc_{1, 2} in the blended image 270 may be taken as it is. A signal value Ro_{2, 2} may be calculated through linear interpolation of the signal values Rc_{1, 2} and Rc_{3, 2} in the blended image 270 (see FIG. 26, right portion).

By a method as described above, for every interpolated pixel position, three color signals Go_{i, j}, Bo_{i, j}, and Ro_{i, j} are generated, and thereby the output blended image is generated.

It should be understood that the interpolation method described above is merely one example; any other method of interpolation may be adopted to achieve color reconstruction. For example, the color signals used to calculate individual color signals by interpolation may be different than in the example described above. For another example, interpolation may be performed by use of four color signals neighboring a color signal to be calculated.

To follow is a discussion of the benefits of a technique, like the one described above, of generating an output blended image. With the conventional technique shown in FIG. 84, interpolating source pixels obtained by binned reading makes it possible to suppress jaggies and false colors, but degrades the perceived resolution of the image obtained through the interpolation (see FIG. 84, blocks 902 and 903). In contrast, in Example 1, source images are read by use of binning patterns that change with time, and from these source images, color-interpolated images are generated that change with time (see FIGS. 22 to 24). Then, by blending the color-interpolated images that change with time with the blended image of the previous frame (see FIG. 26), the blended image of the current frame is obtained. Obtained from this blended image, the output blended image (see FIG. 27) is generated by use of a larger number of pixels than the output image in FIG. 84 (see FIG. 84, block 905), and thus offers enhanced perceived resolution. Moreover, as with the conventional technique corresponding to FIG. 84, it is possible to suppress jaggies and false colors.

In addition, since noise occurs randomly in shot images, the previous-frame blended image generated by sequentially blending together color-interpolated images preceding the current frame has reduced noise. Thus, by using the previous-frame blended image in blending, it is possible to reduce noise in the resulting current-frame blended image and output blended image. It is thus possible to reduce jaggies and false colors simultaneously.

Moreover, blending for reducing jaggies, false colors, and noise is performed only once, and all that are blended together are the current-frame color-interpolated image, of which one after another is inputted, and the previous-frame blended image. This means that all that needs to be stored for blending is the previous-frame blended image. Thus, blending requires only one (one-frame equivalent) frame memory 52, and this helps make the circuit configuration simple and compact.

While the above description discusses different binning patterns being applied to the source image inputted from the AFE 12 to the color interpolation section 51, the different binning patterns may be changed from one frame to another. For example, the first and second binning patterns may be used alternately, or the first to fourth binning patterns may be used in turn (cyclically).

### Example 2

Next, a second practical example (Example 2) will be described. While the description of Example 1 has concentrated on the blending by the image blending section 54, with no consideration given to the output of the motion detection section 53, the description of Example 2 will deal with the configuration and operation of the image blending section 54 with consideration given to the motion detected by the motion detection section 53. FIG. 28 is a block diagram of part of the imaging device 1 in FIG. 1 according to Example 2. FIG. 28 includes an internal block diagram of the video signal processing section 13a, which here serves as the video signal processing section 13 in FIG. 1, and in addition an internal block diagram of the image blending section 54.

The image blending section 54 in FIG. 28 includes a weight coefficient calculation section 61 and a blending section 62. Except for the weight coefficient calculation section 61 and the blending section 62, the configuration and operation within the video signal processing section 13a are the same as described in connection with Example 1, and accordingly the following description mainly deals with the operation of the weight coefficient calculation section 61 and the blending section 62. Unless inconsistent, any description given in connection with Example 1 applies equally to Example 2.

As described in connection with Example 1, the motion detection section 53 outputs a result of motion detection based on the current-frame color-interpolated image and the previous-frame blended image. Then, based on the motion detection result, the image blending section 54 sets a weight coefficient to be used in blending. The description of Example 2 will concentrate on the motion detection result outputted from the motion detection section 53 and the weight coefficient w set according to the motion detection result. Moreover, to make the description concrete, the following description deals with a case where the current-frame color-interpolated image is the color-interpolated image 261 (see FIG. 21) generated by use of the source image of the first binning pattern.

The motion detection section 53 finds a motion vector (optical flow) between the color-interpolated image 261 and the blended image 270 by, for example, the method described above, and outputs the result to the weight coefficient calculation section 61 in the image blending section 54. Based on the magnitude |M| of the motion vector thus inputted, the weight coefficient calculation section 61 calculates a weight coefficient w. At this time, the weight coefficient w is so calculated that, the greater the magnitude |M|, the smaller the weight coefficient w. The upper limit (weight coefficient maximum value) and the lower limit of the weight coefficient w (and also w_{i, j} discussed later) are set at Z and 0 respectively.

FIG. 29 is a diagram showing an example of the relationship between the weight coefficient w and the magnitude |M|. When this exemplary relationship is adopted, the weight coefficient w is calculated according to the equation “w=−K·|M|+Z.” Here, within the range |M|>Z/K, w=0. K is the gradient in the relational equation of |M| with respect to w, and has a predetermined positive value.

The optical flow found by the motion detection section 53 between the color-interpolated image 261 and the blended image 270 is composed of a bundle of motion vectors at different positions on the image coordinate plane XY. For example, the entire image region of each of the color-interpolated image 261 and the blended image 270 is divided into a plurality of partial image regions, and for each of these partial image regions, one motion vector is found. Consider now a case where, as shown in FIG. 30A, the entire image region of an image 290, which may be the color-interpolated image 261 or the blended image 270, is divided into nine partial image regions AR₁ to AR₉, and for each of partial image regions AR₁ to AR₉, one motion vector is found. Needless to say, the number of partial image regions may be other than 9. As shown in FIG. 30B, the motion vectors found for partial image regions AR₁ to AR₉ between the color-interpolated image 261 and the blended image 270 will be represented by M₁ to M₉ respectively. The magnitudes of motion vectors M₁ to M₉ are represented by |M₁| to |M₉| respectively. In FIG. 30B, the images indicated by the reference signs 291 and 292 are a color-interpolated image and a blended image respectively.

Based on the magnitudes |M₁| to |M₉| of motion vectors M₁ to M₉, the weight coefficient calculation section 61 calculates weight coefficients w at different positions on the image coordinate plane XY. The weight coefficient w for the horizontal and vertical pixel numbers i and j will be represented by w_{i, j}. The weight coefficient w_{i, j} is the weight coefficient for the pixel (pixel position) having color signals Gc_{i, j}, Bc_{i, j}, and Rc_{i, j} in the blended image, and is calculated from the motion vector with respect to the partial image region to which that pixel belongs. Accordingly, for example, if the pixel position [1.5, 1.5] at which G signal Gc_{1, 1} is located belongs to partial image region AR₁, then the weight coefficient w_{1, 1} is calculated based on the magnitude |M₁| according to the equation “w_{1, 1}=−K·|M₁|+Z” (though, in the range |M₁|>Z/K, w_{1, 1}=0). Likewise, if the pixel position [1.5, 1.5] at which G signal Gc_{1, 1} is located belongs to partial image region AR₂, then the weight coefficient w_{1, 1} is calculated based on the magnitude |M₂| according to the equation “w_{1,1} =−K·|M₂|+Z” (though, in the range |M₂|>Z/K, w_{1, 1}=0).

The blending section 62 blends the G, B, and R signals of the color-interpolated image 261 with respect to the current frame as currently being outputted from the color interpolation section 51 and the G, B, and R signals of the previous-frame blended image 270 as stored in the frame memory 52 in a ratio commensurate with the weight coefficient w_{i, j} calculated by the weight coefficient calculation section 61. That is, the blending section 62 performs blending by taking the weight coefficient w_{i, j} as the weight coefficient k in Equations (B1) to (B3) above. In this way, the blended image 270 with respect to the current frame is generated.

When a blended image is generated by the blending together of the current-frame color-interpolated image and the previous-frame blended image, if a motion of a subject between the two images is comparatively large, the output blended image generated from the blended image will have blurred edges, or double images. To avoid this, if a motion vector between the two images is comparatively large, the contribution factor (weight factor w_{i, j}) of the previous-frame blended image in the current-frame blended image generated by blending is reduced. This suppresses occurrence of blurred edges and double images.

Moreover, the motion detection result used to calculate the weight coefficient w_{i, j} is detected from the current-frame color-interpolated image and the previous-frame blended image. That is, use is made of the previous-frame blended image stored for blending. This eliminates the need to separately store an image for motion detection (for example, two consecutive color-interpolated images). Thus, only one (one-frame equivalent) frame memory 52 needs to be provided, and this helps make the circuit configuration simple and compact.

In the example described above, weight coefficients w_{i, j} at different positions on the image coordinate plane XY are set; instead, only one weight coefficient may be set for the blending together of the current-frame color-interpolated image and the previous-frame blended image, with the one weight coefficient used with respect to the entire image region. For example, the motion vectors M₁ to M₉ are averaged to calculate an average motion vector M_{AVE} representing an average motion of a subject between the color-interpolated image 261 and the blended image 270, and by use of the magnitude |M_{AVE}| of the average motion vector M_{AVE}, one weight coefficient w is calculated according to the equation “w=−K+Z” (though, within the range |M_{AVE}|>Z/K, w=0). Then, the signal values Gc_{i, j}, Bc_{i, j}, and Rc_{i, j} can be calculated according to equations obtained by substituting the weight coefficient w thus calculated by use of |M_{AVE}| in equations (B1) to (B12).

### Example 3

Next, a third practical example (Example 3) will be described. In Example 3, when a weight coefficient is set, consideration is given not only to a motion of a subject between a color-interpolated image and a blended image but also to an image characteristics amount. An image characteristics amount indicates the characteristics of pixels neighboring a given pixel of attention. FIG. 31 is a block diagram of part of the imaging device 1 in FIG. 1 according to Example 3. FIG. 31 includes an internal block diagram of a video signal processing section 13b, which here serves as the video signal processing section 13 in FIG. 1.

The video signal processing section 13b includes blocks identified by the reference signs 51 to 53, 54b, 55, and 56, among which those identified by the reference signs 51 to 53, 55, and 56 are the same as those shown in FIG. 10. In FIG. 31, an image blending section 54b includes an image characteristics amount calculation section 70, a weight coefficient calculation section 71, and a blending section 72. Except for the image blending section 54b, the configuration and operation within the video signal processing section 13b are the same as those within the video signal processing section 13a described in connection with Examples 1 and 2, and accordingly the following description mainly deals with the configuration and operation of the image blending section 54b. Unless inconsistent, any description given in connection with Examples 1 and 2 applies equally to Example 3.

To make the description concrete, in Example 3, as in Example 2, the following description deals with a case where the current-frame color-interpolated image used in blending is the color-interpolated image 261 (see FIG. 21) generated by use of the source image of the first binning pattern. Moreover, the description of Example 3 will concentrate on the image characteristics amount Cₒ calculated by the image characteristics amount calculation section 70 and the weight coefficient w set according to the image characteristics amount Cₒ.

The image characteristics amount calculation section 70 receives, as input signals, the G, B, and R signals of the current-frame color-interpolated image 261 currently being outputted from the color interpolation section 51, and based on those input signals calculates an image characteristics amount of the current-frame color-interpolated image 261 (see FIG. 21). Here, the image characteristics amount calculation section 70 calculates the image characteristics amount Cₒ by use of the luminance image 261Y of the current-frame color-interpolated image 261.

As the image characteristics amount Cₒ, it is possible to use, for example, a standard deviation σ of the luminance image 261Y calculated according to Equation (C1) below. In Equation (C1) below, n represents the number of pixels used in the calculation, xₖ represents the luminance value of the pixel, and xₐᵥₑ represents the average of the luminance values of the pixels used in the calculation.

$$\begin{matrix}[ Equation 6 ] & \\ σ = \sqrt{\frac{1}{n} {\sum }_{k = 1}^{n} {( {x}_{k} - {x}_{ave} )}^{2}} & ( C 1 )\end{matrix}$$

The standard deviation σ may be calculated for each of partial image regions AR₁ to AR₉, or may be calculated for the entire luminance image 261Y. The standard deviation σ may be calculated by averaging standard deviations calculated one for each of partial image regions AR₁ to AR₉.

For another example, as the image characteristics amount Cₒ, it is possible to use a value obtained by extracting a predetermined high-frequency component H from the luminance image 261Y by use of a high-pass filter. More specifically, for example, the high-pass filter is formed by a Laplacian filter with a predetermined filter size (for example, a 3×3 Laplacian filter as shown in FIG. 32A), and by applying the Laplacian filter to individual pixels of the luminance image 261Y, spatial filtering is performed. The high-pass filter then yields, sequentially, output values according to the filtering characteristics of the Laplacian filter. By use of these values, the high-frequency component H is calculated. The absolute values of the output values from the high-pass filter (the magnitudes of high-frequency components extracted with the high-pass filter) may be added up so that the sum total is taken as the high-frequency component H.

The high-frequency component H may be calculated for each pixel, or may be calculated for each of partial image regions AR₁ to AR₉ of the luminance image 261Y, or may be calculated for the entire luminance image 261Y. The high-frequency component H may be calculated by averaging, for each of partial image regions AR₁ to AR₉, high-frequency components calculated one for each pixel. The high-frequency component H may be calculated by averaging high-frequency components calculated one for each of partial image regions AR₁ to AR₉.

For yet another example, a value obtained by extracting an edge component P (variation across pixels) with a differential filter may be used as the image characteristics amount Cₒ. More specifically, for example, the differential filter is formed by a Prewitt filter (for example, a 3×3 Prewitt filter as shown in FIG. 32B), and by applying the Prewitt filter to individual pixels of the luminance image 261Y, spatial filtering is performed. The differential filter then yields, sequentially, output values according to the filtering characteristics of the differential filter. By use of these values, the edge component P is calculated. An edge component Pₓ in the horizontal direction and an edge component P_{y} in the vertical direction may be calculated separately, in which case the edge component P is the calculated according to Equations (C2) and (C3) below.

$$\begin{matrix}[ Equation 7 ] & \\ P = \frac{{P}_{x}}{( {P}_{x} + {P}_{y} )} , ( {P}_{x} > {P}_{y} ) & ( C 2 ) \\ P = \frac{{P}_{y}}{( {P}_{x} + {P}_{y} )} , ( {P}_{x} \leq {P}_{y} ) & ( C3 )\end{matrix}$$

In the example expressed by Equations (C2) and (C3) above, whichever of the edge component Pₓ in the horizontal direction and the edge component P_{y} in the vertical direction is greater is taken as the edge component P. The edge component P may be calculated for each pixel, or may be calculated for each of partial image regions AR₁ to AR₉ of the luminance image 261Y, or may be calculated for the entire luminance image 261Y. The edge component P may be calculated by averaging, for each of partial image regions AR₁ to AR₉, edge components calculated one for each pixel. The edge component P may be calculated by averaging edge components calculated one for each of partial image regions AR₁ to AR₉.

Any of the thus calculated different values (the standard deviation σ, the high-frequency component H, and the edge component P) indicates the following: the greater it is, the greater the variation in luminance across pixels neighboring the pixel of attention; the smaller it is, the smaller the variation in luminance across pixels neighboring the pixel of attention. Accordingly, as given by Equation (C4), a value obtained by combining those different values together through weighted addition may be taken as the image characteristics amount Cₒ. In the equation below, A, B, and C represent coefficients for adjusting the magnitudes of the different values and setting the proportions at which to add them.

[Equation 8]

C_{O}=A×σ+B×H+C×P (C4)

As described above, the different values (the standard deviation σ, the high-frequency component H, and the edge component P) contributing to the image characteristics amount Cₒ may each be calculated for each of partial image regions AR₁ to AR₉. Accordingly, the image characteristics amount Cₒ may be calculated for each of partial image regions AR₁ to AR₉. In the following description, it is assumed that the image characteristics amount Cₒ is calculated for each of partial image regions AR₁ to AR₉, and the image characteristics amount for partial image region ARₙ will be identified as the image characteristics amount Cₒₘ. In this example, m is an integer fulfilling 1≦m≦9.

Based on image characteristics indices Cₒ₁ to Cₒ₉, the image characteristics amount calculation section 70 calculates weight coefficient maximum values Z₁ to Z₉ (see FIG. 29) for partial image regions AR₁ to AR₉ respectively. As shown in FIG. 32C, the weight coefficient maximum value Zₘ is set at 1 when the image characteristics amount Cₒₘ is equal to or greater than zero but smaller than a predetermined image characteristics amount threshold C_{TH1} (0≦C_{OM}≦C_{TH1}), and is set at 0.5 when the image characteristics amount Cₒₘ is equal to or greater than a predetermined image characteristics amount threshold C_{TH2} (C_{TH2}≦Cₒₘ). Here, C_{TH1}>0, C_{TH2}>0, and C_{TH1}<C_{TH2}.

Moreover, when the image characteristics amount Cₒₘ is equal to or greater than the predetermined image characteristics amount threshold C_{TH1} but smaller than the predetermined image characteristics amount threshold C_{TH2} (C_{TH1}≦Cₒₘ≦C_{TH2}), the weight coefficient maximum value Zₘ is set at a value in the range of from 1 to 0.5 according to the value of the image characteristics amount Cₒₘ. Here, the greater the value of the image characteristics amount Cₒₘ the smaller the value of the weight coefficient maximum value Zₘ. More specifically, the weight coefficient maximum value Zₘ is calculated according to the equation “Zₘ=−Θ·Cₒₘ+1.” Here, Θ=0.5/(C_{TH2}−C_{TH1}), Θ thus being the gradient in the relational equation of the image characteristics amount Cₒₘ with respect to the weight coefficient maximum value Zₘ and having a predetermined positive value.

As described in connection with Example 2, the weight coefficient calculation section 71 sets the weight coefficient w_{i, j} according to the motion detection result outputted from the motion detection section 53. At this time, in this practical example, the weight coefficient calculation section 71 determines the weight coefficient maximum value Zₘ, which is the maximum value of the weight coefficient w_{i, j}, according to the image characteristics amount Cₒₘ outputted from the image characteristics amount calculation section 70.

Since noise occurs randomly in shot images, the previous-frame blended image 270 (see FIG. 26) generated by sequentially blending together color-interpolated images preceding the current frame has reduced noise. Likewise, within the current-frame color-interpolated image 261 (see FIG. 21), in a flat image region (an image region where the image characteristics amount Cₒₘ is comparatively small), jaggies are less notable, and therefore there is less sense in reducing jaggies by image blending; this allows a high contribution factor of the previous frame. Accordingly, with respect to such an image region, the weight coefficient maximum value Zₘ is increased to penult the previous-frame blended image 270 to be assigned a high contribution factor. Setting the weight coefficient maximum value Zₘ in this way makes it possible to obtain an output blended image with less noise than the output blended image generated from the blended image described in connection with Examples 1 and 2.

On the other hand, an image region where the image characteristics amount Cₒₘ is comparatively great is one containing a large edge component; thus, there, jaggies are more notable, and therefore image blending exerts a marked effect of reducing jaggies. Accordingly, to achieve effective blending, the weight coefficient maximum value Zₘ is set at a value close to 0.5. With this configuration, in an image region where no motion is present, the contribution factors of the color-interpolated image 261 and the previous-frame blended image 270 to the current-frame blended image are both close to 0.5. This makes it possible to reduce jaggies effectively.

Thus, it is possible to reduce jaggies effectively in an image region where jaggies reduction is necessary, and to reduce noise further in an image region where jaggies reduction is less necessary.

As mentioned above, the image characteristics amount Cₒ may be set for each region, or may be set for each pixel, or may be set for each image. The gradient K (see FIG. 29) may be made variable with the weight coefficient maximum value Z. Formula (C4) for calculating the image characteristics amount Cₒ is merely an example; the image characteristics amount Cₒ may be calculated by any other method. For example, the image characteristics amount Cₒ may be calculated with at least one of the standard deviation 6, the high-frequency component H, and the edge component P unused, or with consideration given to any other component (for example, the difference between the maximum and minimum signal values among pixels within partial image regions AR₁ to AR₉ or within an image).

### Example 4

Next, a fourth practical example (Example 4) will be described. The description of Example 4 will deal with a unique image compression method that can be adopted in the compression section 16 (see FIG. 1, etc.). In Example 4, it is assumed that the compression section 16 compresses a video signal by use of a compression method conforming to MPEG (Moving Picture Experts Group), which is one of the commonest compression methods for video signals. According to MPEG, frame-to-frame differences are used to generate an MPEG movie, which is a compressed moving image. FIG. 33 schematically shows the make-up of an MPEG movie. An MPEG movie is composed of three types of picture, namely I pictures, P pictures, and B pictures.

An I picture is an intra-frame encoded picture (intra-coded picture), that is, an image for which a one-frame equivalent video signal is encoded within that frame. From a single I picture, a one-frame equivalent video signal can be decoded.

A P picture is an inter-frame predictively encoded picture (predictive-coded picture), that is, an image predicted from the I or P picture preceding it in time. A P picture is formed from data obtained by compressing-encoding the difference between an original image as the target of the P picture and an I or P picture preceding it in time. A B picture is a frame-interpolating bidirectionally predictively encoded picture (bidirectionally predictive-coded picture), that is, an image bidirectionally predicted from the I or P pictures preceding and succeeding it in time. A B picture is foamed from data obtained by compressing-encoding the differences between an original image as the target of the B picture and each of the I or P pictures succeeding and preceding it in time.

An MPEG movie is made up of units called GOPs (groups of pictures). The GOP is the unit by which compression and decompression are performed. One GOP is composed of pictures from one I picture to the next I picture. One GOP, or two or more GOPs, constitute an MPEG movie. The number of pictures from one I picture to the next I picture may be constant, or may be varied within a certain range.

In a case where an image compression method, as exemplified by one conforming to MPEG, exploiting frame-to-frame differences is used, an I picture provides differential data for both a B and a P picture, and therefore the image quality of an I picture greatly influences the overall image quality of an MPEG movie. With this taken into consideration, the number of an image that is judged to have effectively reduced noise and jaggies is recorded in the video signal processing section 13 or the compression section 16, and at the time of image compression, an output blended image corresponding to a recorded image number is preferentially used as the target of an I picture. This makes it possible to enhance the overall image quality of an MPEG movie obtained by compression.

Now, with reference to FIG. 34, a more specific example will be described. In Example 4, used as the video signal processing section 13 is the video signal processing section 13a or 13b shown in FIG. 28 or 31. Consider the following case: from source images of nth, (n+1)th, (n+2)th, (n+3)th, (n+4)th, . . . frames, the color interpolation section 51 generates color-interpolated images 451, 452, 453 and 454 of nth, (n+1)th, (n+2)th, (n+3)th, (n+4)th, . . . frames; then at the image blending section 54 or 54b, a blended image 461 is generated from the color-interpolated image 451 and a blended image 460, a blended image 462 is generated from the color-interpolated image 452 and the blended image 461, a blended image 463 is generated from the color-interpolated image 453 and the blended image 462, a blended image 464 is generated from the color-interpolated image 454 and the blended image 463, and so forth. Moreover, in this case, from the generated blended images 461 to 464, the color reconstruction section 55 generates output blended images 471 to 474 respectively.

Here, the technique of generating one blended image from a color-interpolated image and a blended image of attention is the same as that described in connection with Example 2 or 3, and through blending according to the weight coefficient calculated for the color-interpolated image and blended image of attention, the one blended image is generated. The weight coefficient w_{i, j} used to generate the one blended image can take different values according to the horizontal and vertical pixel numbers i and j (see FIG. 29). Also the weight coefficient maximum value Z used in the process of calculating the weight coefficient can take different values, for example, one for each of partial image regions AR₁ to AR₉ (see FIG. 32C). In this practical example, by use of the weight coefficient and the weight coefficient maximum value Zₘ, an overall weight coefficient is calculated. The overall weight coefficient is calculated by, for example, the weight coefficient calculation section 61 or the weight coefficient calculation section 71 (see FIG. 28 or 31).

To calculate an overall weight coefficient, first, for each pixel (or each partial image region), the weight coefficient w_{i, j} is divided by the weight coefficient maximum value Zₘ to find their quotient (that is, w_{i, j}/Zₘ). Then, a value obtained by averaging those quotients over the entire image is taken as the overall weight coefficient. Instead, a value obtained by averaging the quotients in a predetermined, for example central, region of the image instead of the entire image may be taken as the overall weight coefficient. As described in connection with Example 2, the number of weight coefficients set with respect to a color-interpolated image and a blended image of attention may be one, in which case a value obtained by dividing that one weight coefficient by the weight coefficient maximum value Z may be taken as the overall weight coefficient.

The overall weight coefficients calculated with respect to the blended images 461 to 464 will be represented by w_{T1} to w_{T4} respectively. The reference signs 461 to 464 identifying the blended images 461 to 464 represent the image numbers of the corresponding blended images. The reference signs 471 to 474 identifying the output blended images 471 to 474 represent the image numbers of the corresponding output blended images. The output blended images 471 to 474 are, in a form associated with the overall weight coefficients w_{T1} to w_{T4}, recorded within the video signal processing section 13a or 13b (see FIG. 28 or 31) so that the compression section 16 can refer to them.

An output blended image corresponding to a comparatively great overall weight coefficient is expected to be an image with comparatively greatly reduced jaggies and noise. Hence, the compression section 16 preferentially uses an output blended image corresponding to a comparatively great overall weight coefficient as the target of an I picture. Accordingly, out of the output blended images 471 to 474, the compression section 16 selects the one with the greatest overall weight coefficient among w_{T1} to w_{T4} as the target of an I picture. For example, if, among the overall weight coefficients w_{T1} to w_{T4}, the overall weight coefficient w_{T2} is the greatest, the output blended image 472 is selected as the target of an I picture, and based on the output blended image 472 and the output blended images 471, 473, and 474, P and B pictures are generated. A similar note applies in a case where the target of an I picture is selected from a plurality of output blended images obtained after the output blended image 474.

The compression section 16 generates an I picture by encoding, by an MPEG-conforming method, an output blended image selected as the target of the I picture, and generates P and B pictures based on the output blended image selected as the target of the I picture and output blended images unselected as the target of the I picture.

### Example 5

### Other Examples of Binning Patterns

Next, a fifth practical example (Example 5) will be described. In Examples 1 to 4, it is assumed that binning patterns P_{A1} to P_{A4} corresponding to FIGS. 7A, 7B, 8A, and 8B are used as the first to fourth binning patterns for acquiring source images. It is however also possible to use, as binning patterns for acquiring source images, binning patterns different from binning patterns P_{A1} to P_{A4}. Usable binning patterns include binning patterns P_{B1} to P_{B4}, binning patterns P_{C1} to P_{C4}, and binning patterns P_{D1} to P_{D4}.

When binning patterns P_{B1} to P_{B4} are used, they function as the first, second, third, and fourth binning patterns, respectively, in Examples 1 to 4.

When binning patterns P_{C1} to P_{C4} are used, they function as the first, second, third, and fourth binning patterns, respectively, in Examples 1 to 4.

When binning patterns P_{D1} to P_{D4} are used, they function as the first, second, third, and fourth binning patterns, respectively, in Examples 1 to 4.

FIG. 35 shows how signals are added up when binning patterns P_{B1} to P_{B4} are used, and

FIG. 36 shows how pixel signals appear in a source image when binned reading is performed by use of binning patterns P_{B1} to P_{B4}.

FIG. 37 shows how signals are added up when binning patterns P_{C1} to P_{C4} are used, and

FIG. 38 shows how pixel signals appear in a source image when binned reading is performed by use of binning patterns P_{C1} to P_{C4}.

FIG. 39 shows how signals are added up when binning patterns P_{D1} to P_{D4} are used, and

FIG. 40 shows how pixel signals appear in a source image when binned reading is performed by use of binning patterns P_{D1} to P_{D4}.

In FIG. 35, solid black circles indicate the locations of virtual photosensitive pixels that are assumed to be present when binning patterns P_{B1} to P_{B4} are used as the first to fourth binning patterns. It should be understood, however, that FIG. 35 only shows the locations of, of all the virtual photosensitive pixels that are assumed to be present, only those corresponding to R signals.

In FIG. 37, solid black circles indicate the locations of virtual photosensitive pixels that are assumed to be present when binning patterns P_{C1} to P_{C4} are used as the first to fourth binning patterns. It should be understood, however, that FIG. 37 only shows the locations of, of all the virtual photosensitive pixels that are assumed to be present, only those corresponding to B signals.

In FIG. 39, solid black circles indicate the locations of virtual photosensitive pixels that are assumed to be present when binning patterns P_{D1} to P_{D4} are used as the first to fourth binning patterns. It should be understood, however, that FIG. 39 only shows the locations of of all the virtual photosensitive pixels that are assumed to be present, only those corresponding to G signals.

In FIGS. 35, 37, and 39, arrows pointing to solid black circles indicate how, to generate the pixel signals of the virtual photosensitive pixels corresponding to those circles, the pixel signals of photosensitive pixels neighboring the virtual photosensitive pixels are added up.

When binned reading is performed by use of arbitrary binning patterns, the following assumptions are made:

virtual green photosensitive pixels are located at pixel positions [p_{G1}+4n_{A}, p_{G2}+4nB] and [p_{G3}+4n_{A}, p_{G4}+4n_{B}] on the image sensor 33; virtual blue photosensitive pixels are located at pixel positions [p_{B1}+4n_{A}, p_{B2}+4n_{B}]; and virtual red photosensitive pixels are located at pixel positions [p_{R1}+4n_{A}, p_{R2}+4n_{B}]. Here,

when binning patterns P_{B1}, P_{B2}, P_{B3}, and P_{B4} are used, (p_{G1}, p_{G2}, p_{G3}, p_{G4}, p_{B1}, p_{B2}, p_{R1}, p_{R2}) are (4, 2, 3, 3, 3, 2, 4, 3), (6, 4, 5, 5, 5, 4, 6, 5), (6, 2, 5, 3, 5, 2, 6, 3), and (4, 4, 3, 5, 3, 4, 4, 5) respectively;

when binning patterns P_{C1}, P_{C2}, P_{C3}, and P_{C4} are used, (p_{G1}, p_{G2}, p_{G3}, p_{G4}, p_{B1}, p_{b2}, p_{R1}, p_{R2}) are (3, 3, 2, 4, 3, 4, 2, 3), (5, 5, 4, 6, 5, 6, 4, 5), (5, 3, 4, 4, 5, 4, 4, 3), and (3, 5, 2, 6, 3, 6, 2, 5) respectively;

when binning patterns P_{D1}, P_{D2}, P_{D3}, and P_{D4} are used (p_{G1}, p_{G2}, p_{G3}, p_{G4}, p_{B1}, p_{B2}, p_{R1}, p_{R2}) are (3, 3, 4, 4, 3, 4, 4, 3), (5, 5, 6, 6, 5, 6, 6, 5), (5, 3, 6, 4, 5, 4, 6, 3), and (3, 5, 4, 6, 3, 6, 4, 5) respectively.

It should be noted here that saying (p_{G1}, p_{G2}, p_{G3}, p_{G4}, p_{B1}, p_{B2}, p_{R1}, p_{R2}) are (p_{G1}′, p_{G2}′, p_{G3}′, p_{G4}′, p_{B1}′, p_{B2}′, p_{R1}′, p_{R2}′) means that p_{G1}=p_{G1}′, p_{G2}=p_{G2}′, p_{G3}=p_{G3}′, p_{G4}=p_{G4}′, p_{B1}=p_{B1}′, p_{B2}=p_{B2}′, p_{R1}=p_{R1}′ and p_{R2}=p_{R2}′.

By way of a similar expression, when binning patterns P_{A1}, P_{A2}, P_{A3}, and P_{A4} described previously are used, (p_{G1}, p_{G2}, p_{G3}, p_{G4}, p_{B1}, p_{B2}, p_{R1}, P_{R2}) are (2, 2, 3, 3, 3, 2, 2, 3), (4, 4, 5, 5, 5, 4, 4, 5), (4, 2, 5, 3, 5, 2, 4, 3), and (2, 4, 3, 5, 3, 4, 2, 5) respectively.

As described in connection with Example 1, the pixel signal of a given virtual photosensitive pixel is a sum signal of the pixel signals of real photosensitive pixels adjacent to the virtual photosensitive pixel on its upper left, upper right, lower left, and lower right. And a source image is acquired such that the pixel signal of the virtual photosensitive pixel located at position [x, y] is handled as the pixel signal at position [x, y] on an image.

Accordingly, a source image obtained by binned reading using an arbitrary binning pattern is, as shown in FIGS. 36, 38, and 40, one including: pixels located at pixel positions [p_{G1}+4n_{A}, p_{G2}+4n_{B}] and [p_{G3}+4n_{A}, p_{G4}+4n_{B}], each having a G signal alone; pixels located at pixel positions [p_{B1}+4n_{A}, p_{B2}+4n_{B}], each having a B signal alone; and pixels located at pixel positions [p_{R1}+4n_{A}, p_{R2}+4n_{B}], each having an R signal alone.

A group of binning patterns consisting of binning patterns P_{A1} to P_{A4}, a group of binning patterns consisting of binning patterns P_{B1} to P_{B4}, a group of binning patterns consisting of binning patterns P_{C1} to P_{C4}, and a group of binning patterns consisting of binning patterns P_{D1} to P_{D4} will be represented by P_{A}, P_{B}, P_{C}, and P_{D} respectively.

As described in connection with Example 1, the color interpolation section 51 in FIG. 10 applies color interpolation to source images obtained by use of a predetermined binning pattern group (P_{A}), and thereby generates color signals at predetermined interpolated pixel positions (positions [x, y] at which color signals can be generated) (see FIGS. 13, 15, 17, and 19). Similar notes apply in cases where binning pattern groups P_{B}, P_{C}, and P_{D} are used. That is, also with respect to source images (see FIGS. 36, 38, and 40) obtained by use of binning pattern groups P_{B}, P_{C}, and P_{D}, similar color interpolation as in Example 1 is performed, and thereby color signals are generated at predetermined interpolated pixel positions. At this time, as in Example 1, interpolation is achieved by use of neighboring color signals.

In color interpolation, color signals may be generated at the same interpolated pixel positions as when binning pattern group P_{A} is used. Or the interpolated pixel positions may be varied from one binning pattern group to another. Or the types of color signals generated at the same interpolated pixel positions may be varied from one binning pattern group to another. For example, while with binning pattern group P_{A}, a G signal is located at position [1.5, 1.5], with binning pattern group P_{B}, a B signal may be generated at the same position.

Binning patterns do not necessarily need to be selected from one binning pattern group. For example, binning pattern P_{A1} and binning pattern P_{B2} may be selected and used. With a view to simplifying the blending performed at the image blending section 54, however, it is preferable that, between the different binning patterns used, the interpolated pixel positions be the same and that the same type of color signals be generated at the same positions [x, y].

### Example 6

### [Skipping Pattern]

In Examples 1 to 5, the pixel signals of a source image are acquired by binned reading. Instead, skipped reading may be used to acquire the pixel signals of a source image. A practical example (sixth) in which the pixel signals of a source image are acquired by skipped reading will now be described as Example 6. Also in cases where the pixel signals of source images are acquired by skipped reading, any description given in connection with Examples 1 to 5 equally applies unless inconsistent.

As is well known, in skipped reading, the photosensitive pixel signals from the image sensor 33 are read in a skipping fashion. In Example 6, skipped reading proceeds while the skipping pattern used to acquire source images is changed from one to the next among a plurality of skipping patterns. A skipping (thinning-out) pattern denotes a specific pattern of combination of photosensitive pixels that are going to be skipped over (thinned out).

Usable as a group of skipping patterns consisting of a first to a fourth skipping pattern are: skipping pattern group Q_{A} consisting of skipping patterns Q_{A1} to Q_{A4}; skipping pattern group Q_{B} consisting of skipping patterns Q_{B1} to Q_{B4}; skipping pattern group Q_{C} consisting of skipping patterns Q_{C1} to Q_{C4}; and skipping pattern group Q_{D} consisting of skipping patterns Q_{D1} to Q_{D4}.

FIG. 41 shows skipping patterns Q_{A1} to Q_{A4}, and FIG. 42 shows how pixel signals in a source image appear when skipped reading is performed by use of skipping patterns Q_{A1} to Q_{A4}.

FIG. 43 shows skipping patterns Q_{B1} to Q_{B4}, and FIG. 44 shows how pixel signals in a source image appear when skipped reading is performed by use of skipping patterns Q_{B1} to Q_{B4}.

FIG. 45 shows skipping patterns Q_{C1} to Q_{C4}, and FIG. 46 shows how pixel signals in a source image appear when skipped reading is performed by use of skipping patterns Q_{C1} to Q₄.

FIG. 47 shows skipping patterns Q_{D1} to Q_{D4}, and FIG. 48 shows how pixel signals in a source image appear when skipped reading is performed by use of skipping patterns Q_{D1} to Q_{D4}.

In FIGS. 41, 43, 45, and 47, the pixel signals of photosensitive pixels inside circles are read as the pixel signals of real pixels in source images, and the pixel signals of photosensitive pixels located between circles adjacent in the horizontal or vertical direction are skipped over.

When skipped reading is performed by use of arbitrary skipping patterns,

the pixel signals of green photosensitive pixels located at pixel positions [p_{G1}+4n_{A}, p_{G2}+4n_{B}] and [p_{G3}+4n_{A}, p_{G4}+4n_{B} on the image sensor 33 are read as the G signals at pixel positions [p_{G1}+4n_{A}, p_{G2}+4n_{B}] and [p_{G3}+4n_{A}, p_{G4}+4n_{B}] on the source image;

the pixel signals of blue photosensitive pixels located at pixel positions [p_{B1}+4n_{A}, p_{B2}+4n_{B}] on the image sensor 33 are read as the B signals at pixel positions [p_{B1}+4n_{A}, p_{B2}+4n_{B}] on the source image; and

the pixel signals of blue photosensitive pixels located at pixel positions [p_{R1}+4n_{A}, p_{R2}+4n_{B}] on the image sensor 33 are read as the R signals at pixel positions [p_{R1}+4n_{A}, p_{R2}+4n_{B}] on the source image. Here,

when skipping patterns Q_{A1}, Q_{A}, Q_{A3}, and Q_{A4} are used, (p_{G1}, p_{G2}, p_{G3}, p_{G4}, p_{B1}, p_{B2}, p_{R1}, p_{R2}) are (1, 1, 2, 2, 2, 1, 1, 2), (3, 3, 4, 4, 4, 3, 3, 4), (3, 1, 4, 2, 4, 1, 3, 2), and (1, 3, 2, 4, 2, 3, 1, 4) respectively;

when skipping patterns Q_{B1}, Q_{B2}, Q_{B3}, and Q_{B4} are used, (p_{G1}, p_{G2}, p_{G3}, p_{G4}, p_{B1}, p_{B2}, p_{R1}, p_{R2}) are (3, 1, 2, 2, 2, 1, 3, 2), (5, 3, 4, 4, 4, 3, 5, 4), (5, 1, 4, 2, 4, 1, 5, 2), and (3, 3, 2, 4, 2, 3, 3, 4) respectively;

when skipping patterns Q_{C1}, Q_{C2}, Q_{C3}, and Q_{C4} are used, (p_{G1}, p_{G2}, p_{G3}, p_{G4}, p_{B1}, p_{B2}, p_{R1}, p_{R2}) are (2, 2, 1, 3, 2, 3, 1, 2), (4, 4, 3, 5, 4, 5, 3, 4), (4, 2, 3, 3, 4, 3, 3, 2), and (2, 4, 1, 5, 2, 5, 1, 4) respectively; and

when skipping patterns Q_{D1}, Q_{D2}, Q_{D3}, and Q_{D4} are used, (p_{G1}, p_{G2}, p_{G3}, p_{G4}, p_{B1}, p_{B2}, p_{R1}, p_{R2}), (2, 2, 3, 3, 2, 3, 3, 2), (4, 4, 5, 5, 4, 5, 5, 4), (4, 2, 5, 3, 4, 3, 5, 2), and (2, 4, 3, 5, 2, 5, 3, 4) respectively.

A pixel on the source image which corresponds to a pixel position at which a G, B, or R signal is read is a real pixel at which a G, B, or R signal is present. A pixel on the source image corresponding to a pixel position at which no G, B, or R signal is read is a blank pixel at which no G, B, or R signal is present.

As shown in FIGS. 41, 43, 45, and 47, source images obtained by skipped reading using different skipping patterns are similar to source images obtained by binned reading except for slight differences in the positions of real pixels (see FIGS. 13, 15, 17, and 19). Thus, also with respect to the source images (see FIGS. 41, 43, 45, and 47) obtained by use of the groups of skipping patterns Q_{A} to Q_{D}, it is possible to perform color interpolation similar to that in Example 1 and thereby generate color signals at predetermined interpolated pixel positions. At this time, as in Example 1, interpolation is performed by use of neighboring color signals.

In color interpolation, color signals may be generated at the same interpolated pixel positions as, or at different interpolated pixel positions than, when binning pattern group P_{A} is used. Or the interpolated pixel positions may be varied from one groups of skipping patterns to another. Or the types of color signals generated at the same interpolated pixel positions may be varied from one groups of skipping patterns to another. For example, while with skipping pattern group Q_{A}, a G signal is located at position [1.5, 1.5], with skipping pattern group Q_{B}, a B signal may be generated at the same position.

Skipping patterns do not necessarily need to be selected from one skipping pattern group. For example, a skipping pattern Q_{A1} and a skipping pattern Q_{B2} may be used. With a view to simplifying the blending performed at the image blending section 54, however, it is preferable that, between the different skipping patterns used, the interpolated pixel positions be the same and that the same type of color signals be generated at the same positions [x, y].

As described above, from a source image obtained by skipped reading, a similar color-interpolated image can be obtained as from a source image obtained by binned reading. Thus, the color-interpolated images obtained from the two types of source images can be handled as equivalent images. Accordingly, any description given in connection with Examples 1 to 4 equally applies unmodified to Example 6; basically, all that needs to be done is to read “binning pattern” and “binned reading” in the description of Examples 1 to 4 as “skipping pattern” and “skipped reading” respectively.

Specifically, for example, by use of skipping patterns that change with time, source images are acquired. Then, by performing the color interpolation described in connection with Example 1, color-interpolated images are generated at the color interpolation section 51; meanwhile, by performing the motion detection described in connection with Example 1, a motion vector between the current-frame color-interpolated image and the previous-frame blended image is detected at the motion detection section 53. Then, based on the detected motion vector, by any of the techniques described in connection with Examples 1 to 3, one blended image is generated from the current-frame color-interpolated image and the previous-frame blended image at the image blending section 54 or 54b. Then, on this blended image, color reconstruction is performed at the color reconstruction section 55, and thereby an output blended image is generated. It is also possible to apply the image compression technology described in connection with Example 4 to a series of output blended images based on a series of source images obtained by skipped reading.

Instead of a method using binning patterns that change with time, or a method using skipping patterns that change with time, it is also possible, for example, to use binning and skipping patterns alternately to generate source images by methods that change with time. For example, a binning pattern P_{A1} and a skipping pattern Q_{D2} may be used alternately.

### [Binning-Skipping Pattern]

The photosensitive pixel signals of the image sensor 33 may be read even by a reading method that is a combination of binning and skipping reading methods as described above (in the following description, called a binning-skipping method). A reading pattern for a case where a binning-skipping method is used is called a binning-skipping pattern. For example, it is possible to adopt a binning-skipping pattern corresponding to FIGS. 49 and 50. This binning-skipping pattern functions as a first binning-skipping pattern. FIG. 49 shows how signals are added up and skipped over when the first binning-skipping pattern is used, and FIG. 50 shows how pixel signals in a source image appear when photosensitive pixel signals are read according to the first binning-skipping pattern.

When this first binning-skipping pattern is used, the following assumptions are made:

virtual green photosensitive pixels are located at pixel positions [2+6n_{A}, 2+6n_{B}] and [3+6n_{A}, 3+6n_{B}] on the image sensor 33; virtual blue photosensitive pixels are located at pixel positions [3+6n_{A}, 2+6n_{B}] on the image sensor 33; and virtual red photosensitive pixels are located at pixel positions [2+6n_{A}, 3+6n_{B}] on the image sensor 33 (n_{A} and n_{B} are integers).

As described in connection with Example 1, the pixel signal of a given virtual photosensitive pixel is a sum signal of the pixel signals of real photosensitive pixels adjacent to the virtual photosensitive pixel on its upper left, upper right, lower left, and lower right. And a source image is acquired such that the pixel signal of the virtual photosensitive pixel located at position [x, y] is handled as the pixel signal at position [x, y] on an image.

Accordingly, a source image obtained by reading using the first binning-skipping pattern is, as shown in FIG. 50, one including: pixels located at pixel positions [2+6n_{A}, 2+6n_{B}] and [3+6n_{A}, 3+6n_{B}], each having a G signal alone; pixels located at pixel positions [3+6n_{A}, 2+6n_{B}], each having a B signal alone; and pixels located at pixel positions [2+6n_{A}, 3+6n_{B}], each having an R signal alone.

In this way, a plurality of photosensitive pixel signals are added up to form the pixel signals of a source image; thus, a binning-skipping method is a kind of binned reading method. Meanwhile, the photosensitive pixel signals at positions [5, n_{B}], [6, n_{B}], [n_{A}, 5], and [n_{A}, 6] do not contribute to generation of the pixel signals of the source image; that is, in generation of the source image, the photosensitive pixel signals at positions [5, n_{B}], [6, n_{B}], [n_{A}, 5], and [n_{A}, 6] are skipped over. Thus a binning-skipping method can also be said to be a kind of skipped reading method.

As described previously, a binning pattern denotes a specific pattern of combination of photosensitive pixels that are going to be binned together, and a skipping pattern denotes a specific pattern of combination of photosensitive pixels that are going to be skipped over. In contrast, a binning-skipping pattern denotes a pattern of combination of photosensitive pixels that are going to be added up or skipped over. Also in a case where a binning-skipping method is used, it is possible to set a plurality of different binning-skipping patterns, read photosensitive pixel signals while the binning-skipping pattern used to acquire source images is changed from one to the next among the plurality of binning-skipping patterns, and blend together the current-frame color-interpolated image and the previous-frame blended image obtained, to generate one blended image.

### Example 7

The practical examples described above adopt a configuration in which a color-interpolated image is blended with a blended image in which color signals are arrayed in a similar manner as in the color-interpolated image to generate a blended image, and then the obtained blended image is subjected to color reconstruction to obtain an output blended image. The configuration may instead be such that the color-interpolated image is first subjected to color reconstruction and then blended to obtain the output blended image. This configuration will now be described as a seventh embodiment (Example 7). Unless inconsistent, any description given in connection with the practical examples above applies equally to Example 7.

FIG. 51 is a block diagram of part of the imaging device 1 in FIG. 1 according to Example 7. FIG. 51 includes an internal block diagram of a video signal processing section 13c, which here serves as the video signal processing section 13 in FIG. 1. FIG. 51 corresponds to, and is to be compared with, FIG. 10, which shows the video signal processing section 13a in Example 1.

FIG. 52 is a flow chart showing the operation of the video signal processing section 13c in FIG. 51. FIG. 52 corresponds to, and is to be compared with, FIG. 11, which shows the operation of the video signal processing section 13a in Example 1. Like FIG. 11, the flow chart of FIG. 52 deals with processing of one image.

The video signal processing section 13 shown in FIG. 51 includes a color interpolation section 51 similar to that described previously, and generates from a source image inputted to it a color-interpolated image (STEPs 1 and 2). The configuration and operation of the color interpolation section 51 are similar to those described in connection with Example 1, and accordingly no overlapping description will be repeated. The following description deals with, as an example, a case where binning patterns P_{A1} to P_{A4} are adopted as the first to fourth binning patterns and source images obtained by use of binning patterns P_{A1} to P_{A4} are inputted. The source images inputted, however, may instead be those obtained by use of binning, skipping, or binning-skipping patterns as described in connection with Examples 1, 5, and 6.

The method of generating a color-interpolated image and the color-interpolated image so generated may be similar to those described in connection with Example 1 (see FIGS. 13 to 24). Accordingly, the following description deals with a case where a color-interpolated image similar to those described in connection with Example 1 generated by a method similar to that described in connection with Example 1 is used. It should be understood however that, in this practical example, a generation method and a color-interpolated image different from those described in connection with Example 1 may be used. Differences from Example 1 will be described in detail later.

The color-interpolated image generated at STEP 2 is subjected to color reconstruction at a color reconstruction section 55c, and thereby a color-reconstructed image is generated (STEP 3a). At this time, the color reconstruction section 55c sequentially receives color-interpolated images of first, second, . . . , (n−1)th, and nth frames, and generates color-reconstructed images of first, second, . . . , (n−1)th, and nth frames.

The color-reconstructed images so generated will be described with reference to FIGS. 53 to 56. FIG. 53 shows a color-reconstructed image 401 obtained by applying color reconstruction to the color-interpolated image 261 shown in FIG. 21 (a color-interpolated image obtained from a source image generated by use of the first binning pattern). FIG. 54 shows a color-reconstructed image 402 obtained by applying color reconstruction to the color-interpolated image 262 shown in FIG. 22 (a color-interpolated image obtained from a source image generated by use of the second binning pattern). FIG. 55 shows a color-reconstructed image 403 obtained by applying color reconstruction to the color-interpolated image 263 shown in FIG. 23 (a color-interpolated image obtained from a source image generated by use of the third binning pattern). FIG. 56 shows a color-reconstructed image 404 obtained by applying color reconstruction to the color-interpolated image 264 shown in FIG. 24 (a color-interpolated image obtained from a source image generated by use of the fourth binning pattern).

The G, B, and R signals in the color-reconstructed image 401 will be represented by G1s_{i,j}, B1s_{i,j}, and R1s_{i,j} respectively, and the G, B, and R signals in the color-reconstructed image 402 will be represented by G2s_{i,j}, B2s_{i,j}, and R2s_{i,j}. The G, B, and R signals in the color-reconstructed image 403 will be represented by G3s_{i,j}, B3s_{i,j}, and R3s_{i,j} respectively, and the G, B, and R signals in the color-reconstructed image 404 will be represented by G4s_{i,j}, B4s_{i,j}, and R4s_{i,j}. Here, i and j are integers. G1s_{i,j} to G4sᵢ, will also be used as symbols representing the values of G signals (a similar note applies to B1s_{i,j} to B4s_{i,j}, and R1s_{i,j} to R4s_{i,j}).

The i and j in the notation for the color signals G1s_{i,j}, B1s_{i,j}, and R1s_{i,j} of a pixel of attention in the color-interpolated image 401 represent the horizontal and vertical pixel numbers, respectively, of the pixel of attention in the color-interpolated image 401 (a similar note applies to the notation for color signals G2s_{i,j} to G4s_{i,j}, B2s_{i,j} to B4s_{i,j}, and R2s_{i,j} to R4s_{i,j}).

A description will now be given of the array of color signals G1s_{i,j}, B1s_{i,j}, and R1s_{i,j} in the color-interpolated image 401 generated from the color-interpolated image 261. As shown in FIG. 53, position [1.5, 1.5] in the color-interpolated image 401 is taken as the signal reference position, and the horizontal and vertical pixel numbers i and j of the signal at this signal reference position are assumed to be 1 and 1 respectively. That is, in the color-interpolated image 401, the G, B, and R signals at position [1.5, 1.5] are identified by G1s_{1, 1}, B1s_{1, 1} and R1s_{1, 1} respectively. And, at positions [2×(i−1)+1.5, 2×(j−1)+1.5], color signals G1s_{i,j}, B1s_{i,j} and R1s_{i,j} are arrayed respectively.

A description will now be given of the array of color signals G2s_{i,j}, B2s_{i,j}, and R2s_{i,j} in the color-interpolated image 402 generated from the color-interpolated image 262. As shown in FIG. 54, position [3.5, 3.5] in the color-interpolated image 402 is taken as the signal reference position, and the horizontal and vertical pixel numbers i and j of the signal at this signal reference position are assumed to be 1 and 1 respectively. That is, in the color-interpolated image 402, the G, B, and R signals at position [3.5, 3.5] are identified by G2s_{1, 1}, B2s_{1, 1} and R2s_{1, 1} respectively. And at positions [2×(i−1)+3.5, 2×(j−1)+3.5], color signals G2s_{i,j}, B2s_{i,j}, and R2s_{i,j} are arrayed respectively.

A description will now be given of the array of color signals G3s_{i,j}, B3s_{i,j}, and R3s_{i,j} in the color-interpolated image 403 generated from the color-interpolated image 263. As shown in FIG. 55, position [3.5, 1.5] in the color-interpolated image 403 is taken as the signal reference position, and the horizontal and vertical pixel numbers i and j of the signal at this signal reference position are assumed to be 1 and 1 respectively. That is, in the color-interpolated image 403, the G, B, and R signals at position [3.5, 1.5] are identified by G3s_{1, 1}, B3s_{1, 1} and R3s_{1, 1} respectively. And, at positions [2×(i−1)+3.5, 2×(j−1)+1.5], color signals G3s_{i,j}, B3s_{i,j}, and R3s_{i,j} are arrayed respectively.

A description will now be given of the array of color signals G4s_{i,j}, B4s_{i,j}, and R4s_{i,j} in the color-interpolated image 404 generated from the color-interpolated image 264. As shown in FIG. 56, position [1.5, 3.5] in the color-interpolated image 404 is taken as the signal reference position, and the horizontal and vertical pixel numbers i and j of the signal at this signal reference position are assumed to be 1 and 1 respectively. That is, in the color-interpolated image 404, the G, B, and R signals at position [1.5, 3.5] are identified by G4s_{1, 1}, B4s_{1, 1} and R4s_{1, 1} respectively. And, at positions [2×(i−1)+1.5, 2×(j−1)+3.5], color signals G4s_{i,j}, B4s_{i,j}, and R4s_{i,j} are arrayed respectively.

As described above, performing color reconstruction results in three, namely G,

B, and R, signals being located at each interpolated pixel position. Depending on the positions of color signals contained in the color-interpolated images subjected to color reconstruction, however, the color signals of the color-reconstructed images have different horizontal and vertical pixel numbers i and j. Specifically, among the color-reconstructed images 401 to 404, color signals having the same horizontal and vertical pixel numbers i and j are signals at different positions [x, y] (see FIGS. 53 to 56).

Here, it is assumed that the output blended image generated at an image blending section 54c is similar to the output blended image described in connection with Example 1, specifically the output blended image 280 shown in FIG. 27. Accordingly, G, B, and R signals Go_{i,j}, Bo_{i,j}, and Ro_{i,j} are all generated at interpolated pixel position [1.5+2×(i−1), 1.5+2×(j−1)]. Thus, color signals G1s_{i,j}, B1s_{i,j}, and R1s_{i,j} of the color-reconstructed image 401 (see FIG. 53) and color signals Go_{i,j}, Bo_{i,j}, and Ro_{i,j} of the output blended image 280 are located at the same positions [x, y]. In other words, the horizontal and vertical pixel numbers i and j of the color signals located at a given position [x, y] are the same between the color-reconstructed image 401 and the output blended image 280. That is, the horizontal and vertical pixel numbers i and j match between the color-reconstructed image 401 and the output blended image 280. On the other hand, the horizontal and vertical pixel numbers i and j of color signals of the other color-reconstructed images 402 to 404 do not match the horizontal and vertical pixel numbers i and j of color signals of the output blended image.

The color-reconstructed image generated at STEP 3a (in the following description, also called the current-frame color-reconstructed image) is inputted to the image blending section 54c so as to be blended with the output blended image outputted from the image blending section 54c one frame before (in the following description also called the previous-frame output blended image). Through this blending, an output blended image is generated (STEP 4a). Here, it is assumed that, from the color-interpolated images of the first, second, . . . (n−1)th, and nth frame that are inputted from the color reconstruction section 55c to the image blending section 54c, output blended images of the first, second, . . . (n−1)th, and nth frame are generated (where n is an integer of 2 or more). That is, as a result of the color-reconstructed image of the nth frame being blended with the output blended image of the (n−1)th frame, the output blended image of the nth frame is generated.

To enable the blending at STEP 4a, a frame memory 52c temporarily stores the output blended image outputted from the image blending section 54c. For example, when the color-reconstructed image of the nth frame is inputted to the image blending section 54c, the output blended image of the (n−1)th frame is stored in the frame memory 52c. The image blending section 54c thus receives, on one hand, one signal after another representing the previous-frame output blended image as stored in the frame memory 52c and, on the other hand, one signal after another representing the current-frame color-reconstructed image as inputted from the color reconstruction section 55c , and blends each pair of images together to output one signal after another representing the current-frame output blended image.

When a color-reconstructed image and an output blended image are blended together at STEP 4a, similar problems can occur as in the blending together at STEP 3 (see FIG. 11) in Example 1, specifically the problem of the positions [x, y] of color signals differing between the images blended together, or the problem of the positions [x, y] of the signals (Go_{i,j}, Bo_{i,j}, and Ro_{i,j}) outputted from the image blending section 54c being inconstant, causing the image as a whole to move. To avoid that, as in Example 1, when a series of output blended images are generated, a blending reference image is set. Then, for example by controlling the image data read from the frame memory 52c and from the color reconstruction section 55c , the above-mentioned problems are coped with. A description will be given below of a case where the color-interpolated image 401 is set as the blending reference image.

When blending is performed with a blending reference image set, the blending proceeds by a similar method as in Example 1. Moreover, a condition similar to that described in connection with Example 1 (an image based on a source image obtained by use of the first binning pattern (namely, the color-reconstructed image 401) is taken as the blending reference image) is adopted, and thus the blending can be performed by methods similar to those expressed by Equations (B1) to (B12) above (similar methods of handling the horizontal and vertical pixel numbers i and j). The weight coefficient k in Equations (D1) to (D12) below is similar to that in Example 1. That is, it depends on the motion detection result outputted from the motion detection section 53.

To blend together the color-reconstructed image 401 and the output blended image 280, through weighted addition of the G, B, and R signal values of the color-reconstructed image 401 and the G, B, and R signal values of the output blended image 280 according to Equations (D1) to (D3) below, the G, B, and R signal values of the current-frame output blended image 280 are calculated. In Equations (D1) to (D3) below, the G, B, and R signal values of the previous-frame output blended image 280 are represented by Gpo_{i,j}, Bpo_{i,j}, and Rpo_{i,j} for distinction from the G, B, and R signal values of the current-frame output blended image 280.

[Equation 9]

Go_{i,j}=(1−k)×G1s_{i,j}+k×Gpo_{i,j} (D1)

Bo_{i,j}=(1−k)×B1s_{i,j}+k×Bpo_{i,j} (D2)

Ro_{i,j}=(1−k)×R1s_{i,j}+k×Rpo_{i,j} (D3)

As Equations (D1) to (D3) indicate, the G, B, and R signal values Gpoc_{i,j}, Bpo_{i,j}, and Rpo_{i,j} of the previous-frame output blended image 280 and the G, B, and R signal values G1s_{i,j}, B1s_{i,j}, and R1s_{i,j} of the color-reconstructed image 401 are blended with no shift in the horizontal and vertical pixel numbers i and j. In this way, the G, B, and R signal values Go_{i,j}, Bo_{i,j}, and Ro_{i,j} of the current-frame output blended image 280 are obtained.

To blend together the color-reconstructed image 402 and the output blended image 280, through weighted addition of the G, B, and R signal values of the color-reconstructed image 402 and the G, B, and R signal values of the output blended image 280 according to Equations (D4) to (D6) below, the G, B, and R signal values of the current-frame output blended image 280 are calculated. Also in Equations (D4) to (D6) below, the G, B, and R signal values of the previous-frame output blended image 280 are represented by Gpo_{i,j}, Bpo_{i,j}, and Bpo_{i,j} for distinction from the G, B, and R signal values of the current-frame output blended image 280.

[Equation 10]

Go_{i,j}=(1−k)×G2s_{i-1,j-1}+k×Gpo_{i,j} (D4)

Bo_{i,j}=(1−k)×B2s_{i-1,j-1}+k×Bpo_{i,j} (D5)

Ro_{i,j}=(1−k)×R2s_{i-1,j-1}+k×Rpo_{i,j} (D6)

As Equations (D4) to (D6) indicate, in this example, blending is performed with a shift in the horizontal and vertical pixel numbers i and j. Specifically, the G, B, and R signal values Gpo_{i,j}, Bpo_{i,j}, and Bpo_{i,j} of the previous-frame output blended image 280 and the G, B, and R signal values G2s_{i-1,j-1}, B2s_{i-1,j-1}, and R2s_{i-1,j-1} if the color-reconstructed image 402 are blended. In this way, the G, B, and R signal values Go_{i,j}, Bo_{i,j}, and Ro_{i,j} of the current-frame output blended image 280 are obtained.

To blend together the color-reconstructed image 403 and the output blended image 280, through weighted addition of the G, B, and R signal values of the color-reconstructed image 403 and the G, B, and R signal values of the output blended image 280 according to Equations (D7) to (D9) below, the G, B, and R signal values of the current-frame output blended image 280 are calculated. Also in Equations (D7) to (D9) below, the G, B, and R signal values of the previous-frame output blended image 280 are represented by Gpo_{i,j}, Bpo_{i,j}, and Bpo_{i,j} for distinction from the G, B, and R signal values of the current-frame output blended image 280.

[Equation 11]

Go_{i,j}=(1−k)×G3s_{i-1,j}+k×Gpo_{i,j} (D7)

Bo_{i,j}=(1−k)×B3s_{i-1,j}+k×Bpo_{i,j} (D8)

Ro_{i,j}=(1−k)×R3s_{i-1,k}+k×Rpo_{i,j} (D9)

As Equations (D7) to (D9) indicate, in this example, blending is performed with a shift in the horizontal and vertical pixel numbers i and j. Specifically, the G, B, and R signal values Gpo_{i,j}, Bpo_{i,j}, and Bpo_{i,j} of the previous-frame output blended image 280 and the G, B, and R signal values G3s_{i-1,j}, B3s_{i-1,j} and R3s_{i-1,j} of the color-reconstructed image 403 are blended. In this way, the G, B, and R signal values Go_{i,j}, Bo_{i,j}, and Ro_{i,j} of the current-frame output blended image 280 are obtained.

To blend together the color-reconstructed image 404 and the output blended image 280, through weighted addition of the G, B, and R signal values of the color-reconstructed image 404 and the G, B, and R signal values of the output blended image 280 according to Equations (D10) to (D12) below, the G, B, and R signal values of the current-frame output blended image 280 are calculated. Also in Equations (D10) to (D12) below, the G, B, and R signal values of the previous-frame output blended image 280 are represented by Gpo_{i,j}, Bpo_{i,j}, and Rpo_{i,j} for distinction from the G, B, and R signal values of the current-frame output blended image 280.

[Equation 12]

Go_{i,j}=(1−k)×G4s_{i,j-1}+k×Gpo_{i,j} (D10)

Bo_{i,j}=(1−k)×B4s_{i,j-1}+k×Bpo_{i,j} (D11)

Ro_{i,j}=(1−k)×R4s_{i,j-1}+k×Rpo_{i,j} (D12)

As Equations (D10) to (D12) indicate, in this example, blending is performed with a shift in the horizontal and vertical pixel numbers i and j. Specifically, the G, B, and R signal values Gpo_{i,j}, Bpo_{i,j}, and Rpo_{i,j} of the previous-frame output blended image 280 and the G, B, and R signal values G4s_{i,j-1}, B4s_{i,j-1} and R4s_{i,j-1} of the color-reconstructed image 403 are blended. In this way, the G, B, and R signal values Go_{i,j}, Bo_{i,j}, and Ro_{i,j} of the current-frame output blended image 280 are obtained.

To set the weight coefficient k in Equations (D1) to (D12) above, the motion detection section 53 generates luminance signals (a luminance image) from the color signals of each of the color-reconstructed image and the output blended image inputted to it, then finds an optical flow between the two luminance images to detect the magnitude and direction of a motion, and outputs the result to the image blending section 54c. As in Example 1, each luminance image is generated by calculating the values of G, B, and R signals at arbitrary positions [x, y]. In Example 7, the value of the G, B, and R signals at interpolated pixel positions on the color-reconstructed image and on the output blended image have already been obtained, and therefore the luminance signals at the interpolated pixel positions can be calculated without interpolating color signals. An optical flow may be found by use of the correspondence relationships given by Equations (D1) to (D12) above. In particular, the horizontal and vertical pixel numbers i and j of the luminance signals to be calculated are compared with a shift as at the time of blending. By such comparison, it is possible to prevent a shift in the positions [x, y] of luminance signals.

The output blended image obtained at STEP 4a is inputted to the signal processing section 56. The signal processing section 56 converts the R, G, and B signals constituting the output blended image to generate a video signal composed of a luminance signal Y and color difference signals U and V (STEP 5). The operations at STEPs 1 to 5 described above are performed on the image of each frame. In this way, the video signal (Y, U, and V signals) of one after another frame is generated, and is sequentially outputted from the signal processing section 56. The video signal thus outputted is inputted to the compression section 16, where it is compressed-encoded by a predetermined image compression method.

As Example 7 demonstrates, a configuration in which a color-reconstructed image and an output blended image are blended together (a configuration in which color reconstruction is performed first and then blending is performed) offers benefits similar to those Example 1 offers (a configuration in which blending is performed first and then color reconstruction is performed). Specifically, it is possible to suppress jaggies and false colors, and in addition to enhance perceived resolution. It is further possible to reduce noise in the output blended image generated.

Moreover, blending for reducing jaggies, false colors, and noise is performed only once, and all that are blended together are the current-frame color-reconstructed image, of which one after another is inputted, and the previous-frame output blended image. This means that all that needs to be stored for blending is the previous-frame output blended image. Thus, only one (one-frame equivalent) frame memory 52c needs to be provided, and this helps make the circuit configuration simple and compact.

Furthermore, in Example 7, it is possible to eliminate the need to limit the locations of the color signals of the color-interpolated images 261 to 264 (see FIGS. 21 to 24). In Example 1, in the color-interpolated image and the blended image that are going to be blended together, only one of G, B, and R signals is present at each interpolated pixel position. Accordingly, interpolated pixel positions at which to generate color signals by color interpolation are defined so that particular types of color signals are generated at particular interpolated pixel positions, and this makes blending easy. In contrast, in Example 7, color reconstruction is performed before blending, and thus, in the color-reconstructed image and the output blended image, G, B, and R signals are all present at each interpolated pixel position. This makes it possible to eliminate the need to generate particular types of color signals at particular interpolated pixel positions when generating a color-interpolated image. Even so, it is still necessary to define the interpolated pixel positions themselves at which to generate color signals.

A specific description will now be given of the benefits mentioned above with reference to FIG. 57. FIG. 57 is a diagram showing how G, B, and R signals in a source image acquired by use of the fourth binning pattern are mixed in Example 7, and corresponds to, and is to be compared with, FIG. 19, which deals with Example 1. In Example 1, it is suitable to define interpolated pixel positions at which to generate particular types of color signals, and this requires that color signals be generated by different methods according to source images as described above. For example, in FIGS. 13 and 19, black and gray arrows indicate different methods of color signals. In contrast, in Example 7, there is no need to define interpolated pixel positions at which to generate particular types of color signals, and accordingly, as shown in FIGS. 13 and 57, the same method of generating color signals can be used throughout. Thus, even when the source images inputted change with time, so long as the binning pattern groups, skipping pattern groups, or binning-skipping pattern groups are the same, it is possible to apply the same method of color interpolation to different types of source images that are inputted.

The positions [x, y] of color signals in color-interpolated images thus obtained are shifted as described above, but have the same pattern. For example, at a position where the horizontal and vertical pixel numbers i and j are both even or odd numbers, there is a G signal; at a position where the horizontal and vertical pixel numbers i and j are an odd and an even number respectively, there is a B signal; and at a position where the horizontal and vertical pixel numbers i and j are an even and an odd number respectively, there is an R signal. This applies equally to all source images. Thus, it is possible to apply the same method of color reconstruction to signals of different types of color-interpolated images that are inputted.

Since Example 7 corresponds to Example 1, any feature of Examples 2 to 6 that is applicable to Example 1 can be combined with Example 7. Specifically, applicable to Example 7 are: the method of determining a weight coefficient described in connection with Examples 2 and 3; the method of image compression described in connection with Example 4; the binning, skipping, and binning-skipping patterns described in connection with Example7.

### Embodiment 2

Next, a first practical example (Example 1) of a second embodiment (Embodiment 2) of the invention will be described. Unless otherwise indicated, numbered practical examples mentioned in the course of the following description of Embodiment 2 are those of Embodiment 2.

### Example 1

As in Example 1 of Embodiment 1, also in this practical example, a binned reading method is used to read pixel signals from the image sensor 33. The binning patterns used for that purpose are the same as those described under the heading [Binning Pattern] with respect to Example 1 of Embodiment 1, and therefore no overlapping description will be repeated. In this practical example, binned reading is performed while a plurality of binning patterns are changed from one to the next, and by blending together a plurality of color-interpolated images resulting from different binning patterns, one output blended image is generated.

FIG. 58 is a block diagram of part of the imaging device 1 in FIG. 1, including an internal block diagram of a video signal processing section 13A, which here serves as the video signal processing section 13 in FIG. 1. The video signal processing section 13A includes blocks identified by the reference signs 151 to 154, 156, and 157.

A color interpolation section 151 applies color interpolation to RAW data from the AFE 12, and thereby converts the RAW data into R, G, and B signals. This conversion is performed on a frame-by-frame basis, and the R, G, and B signals obtained by the conversion are temporarily stored in a frame memory 152.

Through the color interpolation at the color interpolation section 151, from one source image, one color-interpolated image is generated. Every time the frame period lapses, first, second, . . . , (n−1)th, and nth source images are sequentially acquired from the image sensor 33 via the AFE 12, and, from these first, second, . . . , (n−1)th, and nth source images, the color interpolation section 151 generates first, second, . . . , (n−1)th, and nth color-interpolated images respectively. Here, n is an integer of 2 or more.

Based on the R, G, and B signals of the current frame as currently being outputted from the color interpolation section 151 and the R, G, and B signals of the previous frame as stored in the frame memory 152, a motion detection section 153 finds an optical flow between adjacent frames. Specifically, based on the image data of the (n−1)th and nth color-interpolated images, the motion detection section 153 finds an optical flow between the two color-interpolated images. From this optical flow, the motion detection section 153 detects the magnitude and direction of a motion between the two color-interpolated images. The result of the detection by the motion detection section 153 is stored in a memory 157.

An image blending section 154 receives the output signal of the color interpolation section 151 and the signal stored in the frame memory 152, and based on a plurality of color-interpolated images represented by the received signals, generates one output blended image. In the generation here, the detection result from the motion detection section 153 stored in the memory 157 is also referred to. A signal processing section 156 converts the R, G, and B signals of the output blended image outputted from the image blending section 154 into a video signal composed of a luminance signal Y and color difference signals U and V. The video signal (Y, U, and V signals) obtained by the conversion is delivered to the compression section 16, where it is compressed-encoded by a predetermined image compression method.

In the configuration shown in FIG. 58, the route from the AFE 12 to the compression section 16 passes via the color interpolation section 151, the frame memory 152, the motion detection section 153, the image blending section 154, and the signal processing section 156 arranged in this order. These may be arranged in any other order. Now, a detailed description will be given of the functions of the color interpolation section 151, the motion detection section 153, and the image blending section 154.

### [Color Interpolation Section]

The color interpolation section 151 achieves color interpolation basically in a manner similar to that described under the heading [Basic Method for Color Interpolation] in connection with Example 1 of Embodiment 1. Here, however, in addition to the basic method described previously, the following processing is performed as well. The following description will refer to FIGS. 12A and 12B and Equation (A1) where necessary, and will mainly discuss a case where G signals are mixed.

At the color interpolation section 151, in addition to the basic method described previously, when G signals of a group of considered real pixels are mixed to generate the G signal at an interpolated pixel position, the G signals of the plurality of real pixels are mixed in an equal ratio (mixed at equal proportions). Put the other way around, by mixing the G signals of a group of considered real pixels in an equal ratio, an interpolated pixel position is set at a position where a signal is to be interpolated. To meet the requirements, an interpolated pixel position is set at the center-of-gravity position of the pixel positions of real pixels constituting a group of considered real pixels. More specifically, the center-of-gravity position of the figure formed by connecting together the pixel positions of the real pixels constituting the group of considered real pixels is taken as the interpolated pixel position.

Accordingly, in a case where a group of considered real pixels consists of a first and a second pixel, the center-of-gravity position of the figure (line segment) connecting the pixel positions of the first and second pixels, that is, the middle position between the two pixel positions, is taken as the interpolated pixel position. Then, d₁=d₂ necessarily holds, and accordingly Equation (Al) above is rearranged into Equation (A2) below. That is, the average of the G signal values of the first and second pixels is taken as the G signal value at the interpolated pixel position.

[Equation 13]

V_{GT}=½V_{G1}+½V_{G}2 (A2)

Likewise, in a case where a group of considered real pixels consists of a first to a fourth pixel, the center-of-gravity position of the quadrilateral formed by connecting together the pixel positions of the first to fourth pixels is taken as the interpolated pixel position. Then, the G signal value V_{GT} at that interpolated pixel position is the average of the G signal values V_{G1} to V_{G4} of the first to fourth pixels.

While the above description focuses interest on G signals as for the basic method described previously, color interpolation with respect to B and R signals is performed in similar manners. For a discussion of color interpolation with respect to B or R signals, all that needs to be done is to read “G” in the above description as “B” or “R.”

The color interpolation section 151 applies color interpolation to the source image obtained from the AFE 12, and thereby generates a color-interpolated image. In Example 1, and also in Examples 2 to 6 described later, the source image fed from the AFE 12 to the color interpolation section 151 is the source image of the first, second, third, or fourth binning pattern described under the heading [Binning Pattern] in connection with Example 1 of Embodiment 1 (see FIGS. 7 to 9). Accordingly, in the source image to be subjected to color interpolation, the pixel intervals (the intervals between adjacent real pixels) are uneven as shown in FIGS. 9A to 9D. On a source image like those, the color interpolation section 151 performs color interpolation by the method described previously.

With reference to FIGS. 59 and 60, a description will now be given of the color interpolation for generating from a source image 1251 of the first binning pattern a color-interpolated image 1261. FIG. 59 is a diagram showing how the G, B, and R signals of real pixels in the source image 1251 are mixed to generate the G, B, and R signals at an interpolated pixel position. FIG. 60 is a diagram showing G, B, and R signals on the color-interpolated image 1261. In FIG. 59, solid black circles indicate the interpolated pixel positions at which to generate G, B, and R signals in the color-interpolated image 1261, and arrows pointing to solid black circles indicate how a plurality of color signals are mixed to generate the color signals at interpolated pixel positions. To avoid cluttering the diagrams, the G, B, and R signals in the color-interpolated image 1261 are shown separately; in practice, one color-interpolated image 1261 is generated from the source image 1251.

First, with reference to the left portions of FIGS. 59 and 60, a description will be given of the color interpolation for generating G signals in the color-interpolated image 1261 from G signals in the source image 1251. Pay attention to block 1241 encompassing positions [x, y] fulfilling the inequalities “2≦x≦7” and “2≦y≦7.” Then consider a G signal at an interpolated pixel position on the color-interpolated image 1261 which is generated from G signals of real pixels belonging to block 1241. A G signal (or B signal, or R signal) generated with respect to an interpolated pixel position will also be specially called an interpolated G signal (or interpolated B signal, or interpolated R signal).

From G signals of real pixels on the source image 1251 belonging to block 1241, interpolated G signals are generated with respect to two interpolated pixel positions 1301 and 1302 set on the color-interpolated image 1261. The interpolated pixel position 1301 is the center-of-gravity position [3.5, 5.5] of the pixel positions of real pixels P[2, 6], P[3, 7], P[3, 3], and P[6, 6], which have a G signal. Position [3.5, 5.5] corresponds to the middle position between positions [3, 6] and [4, 5]. The interpolated pixel position 1302 is the center-of-gravity position [5.5, 3.5] of the pixel positions of real pixels P[6, 2], P[7, 3], P[3, 3], and P[6, 6], which have a G signal. Position [5.5, 3.5] corresponds to the middle position between positions [6, 3] and [5, 4].

In the left portions of FIG. 59, the interpolated G signals generated at interpolated pixel positions 1301 and 1302 are indicated by the reference signs 1311 and 1312 respectively. The value of the G signal 1311 generated at the interpolated pixel position 1301 is the average of the pixel values (that is, G signal values) of real pixels P[2, 6], P[3, 7], P[3, 3], and P[6, 6] in the source image 1251. That is, the G signal 1311 is generated by mixing the pixel signals of the group of considered real pixels for the G signal 1311 in an equal ratio. Likewise, the value of the G signal 1312 generated at the interpolated pixel position 1302 is the average of the pixel values (that is, G signal values) of real pixels P[6, 2], P[7, 3], P[3, 3], and P[6, 6] in the source image 1251. That is, the G signal 1312 is generated by mixing the pixel signals of the group of considered real pixels for the G signal 1312 in an equal ratio. A pixel value denotes the value of a pixel signal.

The G signals of real pixels P[x, y] in the source image 1251 are, as they are, taken as the G signals at positions [x, y] in the color-interpolated image 1261. That is, for example, the G signals at real pixels P[3, 3] and P[6, 6] in the source image 1251 (that is, the G signals at positions [3, 3] and [6, 6] in the source image 1251) are taken as the G signals 1313 and 1314 at positions [3, 3] and [6, 6], respectively, in the color-interpolated image 1261. A similar note applies to other positions (for example, position [2, 2]).

While attention is being paid to block 1241, two interpolated pixel positions 1301 and 1302 are set, and with respect to them, interpolated G signals 1311 and 1312 are generated. The block of attention is then, starting at block 1241, shifted four pixels in the horizontal or vertical direction at a time, and every time such a shift is done, similar generation of interpolated G signals is performed. In this way, G signals on the color-interpolated image 1261 as shown in the left portion of FIG. 67 are generated. In the left portion of FIG. 67, G1_{2, 3}, G1_{3, 2}, G1_{2, 2} and G1_{3, 3} correspond to the G signals 1311, 1312, 1313, and 1314 in the left portion of FIG. 60. Prior to a detailed discussion of the left portion of FIG. 67, first, a description will be given of color interpolation with respect to B and R signals and color interpolation using the second to fourth binning patterns.

With reference to the middle portions of FIGS. 59 and 60, a description will be given of color interpolation for generating a B signal in the color-interpolated image 1261 from B signals in the source image 1251. Pay attention to block 1241, and consider a B signal at an interpolated pixel position on the color-interpolated image 1261 which is generated from B signals of real pixels belonging to block 1241.

From B signals of real pixels belonging to block 1241, interpolated B signals are generated with respect to interpolated pixel positions 1321 to 1323 set on the color-interpolated image 1261. The interpolated pixel position 1321 matches the center-of-gravity position [3, 4] of the pixel positions of real pixels P[3, 2] and P[3, 6] having B signals. The interpolated pixel position 1322 matches the center-of-gravity position [5, 6] of the pixel positions of real pixels P[3, 6] and P[7, 6] having B signals. The interpolated pixel position 1323 matches the center-of-gravity position [5, 4] of the pixel positions of real pixels P[3, 2], P[7, 2], P[3, 6], and P[7, 6] having B signals.

In the middle portion of FIG. 60, the interpolated B signals generated at the interpolated pixel positions 1321 to 1323 are indicated by the reference signs 1331 to 1333 respectively. The value of the B signal 1331 generated at interpolated pixel position 1321 is made equal to the average of the pixel values (that is, B signal value) of real pixels P[3, 2] and P[3, 6] in the source image 1251. That is, by mixing the pixel signals of the group of considered real pixels for the B signal 1331 in an equal ratio, the B signal 1331 is generated. A similar note applies to the B signals 1332 and 1333. That is, the value of the B signal 1332 generated at interpolated pixel position 1322 is made equal to the average of the pixel values (that is, B signal value) of real pixels P[3, 6] and P[7, 6] in the source image 1251, and the value of the B signal 1333 generated at interpolated pixel position 1323 is made equal to the average of the pixel values (that is, B signal value) of real pixels P[3, 2], P[7, 2], P[3, 6], and P[7, 6] in the source image 1251.

The B signals of real pixels P[x, y] in the source image 1251 are, as they are, taken as the B signals at positions [x, y] in the color-interpolated image 1261. That is, for example, the B signal at real pixel P[3, 6] in the source image 1251 (that is, the B signals at position [3, 6] in the source image 1251) are taken as the B signal 1334 at position [3, 6] in the color-interpolated image 1261. A similar note applies to other positions (for example, position [3, 2]).

While attention is being paid to block 1241, three interpolated pixel positions 1321 to 1323 are set, and with respect to them, interpolated G signals 1331 to 1333 are generated. The block of attention is then, starting at block 1241, shifted four pixels in the horizontal or vertical direction at a time, and every time such a shift is done, similar generation of interpolated B signals is performed. In this way, B signals on the color-interpolated image 1261 as shown in the middle portion of FIG. 67 are generated.

With reference to the right portions of FIGS. 59 and 60, a description will be given of color interpolation for generating an R signal in the color-interpolated image 1261 from R signals in the source image 1251. Pay attention to block 1241, and consider an R signal at an interpolated pixel position on the color-interpolated image 1261 which is generated from R signals of real pixels belonging to block 1241.

From R signals of real pixels belonging to block 1241, interpolated B signals are generated with respect to three interpolated pixel positions 1341 to 1343 set on the color-interpolated image 1261. The interpolated pixel position 1341 matches the center-of-gravity position [4, 3] of the pixel positions of real pixels P[2, 3] and P[6, 3] having R signals. The interpolated pixel position 1342 matches the center-of-gravity position [6, 5] of the pixel positions of real pixels P[6, 3] and P[6, 7] having R signals. The interpolated pixel position 1343 matches the center-of-gravity position [4, 5] of the pixel positions of real pixels P[2, 3], P[2, 7], P[6, 3], and P[6, 7] having R signals.

In the right portion of FIG. 60, the interpolated R signals generated at the interpolated pixel positions 1341 to 1343 are indicated by the reference signs 1351 to 1353 respectively. The value of the R signal 1351 generated at the interpolated pixel position 1341 is made equal to the average of the pixel values (that is, R signal value) of real pixels P[2, 3] and P[6, 3] in the source image 1251. That is, by mixing the pixel signals of the group of considered real pixels for the R signal 1351 in an equal ratio, the R signal 1351 is generated. A similar note applies to the R signals 1352 and 1353. That is, the value of the R signal 1352 generated at interpolated pixel position 1342 is made equal to the average of the pixel values (that is, R signal value) of real pixels P[6, 3] and P[6, 7], and the value of the R signal 1353 generated at interpolated pixel position 1343 is made equal to the average of the pixel values (that is, R signal value) of real pixels P[2, 3], P[2, 7], P[6, 3], and P[6, 7].

The R signals of real pixels P[x, y] in the source image 1251 are, as they are, taken as the R signals at positions [x, y] in the color-interpolated image 1261. That is, for example, the R signal at real pixel [6, 3] in the source image 1251 (that is, the R signals at position [6, 3] in the source image 1251) are taken as the R signal 1354 at position [6, 3] in the color-interpolated image 1261. A similar note applies to other positions (for example, position [2, 3]).

While attention is being paid to block 1241, three interpolated pixel positions 1341 to 1343 are set, and with respect to them, interpolated R signals 1351 to 1353 are generated. The block of attention is then, starting at block 1241, shifted four pixels in the horizontal or vertical direction at a time, and every time such a shift is done, similar generation of interpolated R signals is performed. In this way, R signals on the color-interpolated image 1261 as shown in the right portion of FIG. 67 are generated.

A description will now be given of color interpolation with respect to the source images of the second, third, and fourth binning patterns. The source images of the second, third, and fourth binning patterns will be identified by the reference signs 1252, 1253, and 1254 respectively, and the color-interpolated images generated from the source images 1252, 1253, and 1254 will be identified by the reference signs 1262, 1263, and 1264 respectively.

FIG. 61 is a diagram showing how G, B, and R signals of real pixels in the source image 1252 are mixed to generate the G, B, and R signals at interpolated pixel positions in the color-interpolated image 1262. FIG. 62 is a diagram showing G, B, and R signals on the color-interpolated image 1262. FIG. 63 is a diagram showing how G, B, and R signals of real pixels in the source image 1253 are mixed to generate the G, B, and R signals at interpolated pixel positions in the color-interpolated image 1263. FIG. 64 is a diagram showing G, B, and R signals on the color-interpolated image 1263. FIG. 65 is a diagram showing how G, B, and R signals of real pixels in the source image 1254 are mixed to generate the G, B, and R signals at interpolated pixel positions in the color-interpolated image 1264. FIG. 66 is a diagram showing G, B, and R signals on the color-interpolated image 1264.

In FIG. 61, solid black circles indicate interpolated pixel positions at which G, B, and R signals are to be generated in the color-interpolated image 1262; in FIG. 63, solid black circles indicate interpolated pixel positions at which G, B, and R signals are to be generated in the color-interpolated image 1263; in FIG. 65, solid black circles indicate interpolated pixel positions at which G, B, and R signals are to be generated in the color-interpolated image 1264. Arrows pointing to solid black circles indicate how a plurality of color signals are mixed to generate color signals at interpolated pixel positions. To avoid cluttering the diagrams, G, B, and R signals in the color-interpolated image 1262 are shown separately; in practice, one color-interpolated image 1262 is generated from the source image 1252. A similar note applies to the color-interpolated images 1263 and 1264.

The source images of the second to fourth binning patterns are subjected to color interpolation by a method similar to that by which the source image of the first binning pattern is subjected to it. The differences are: relative to the locations of real pixels in the source image of the first binning pattern, the locations of real pixels in the source image of the second binning pattern are shifted 2·Wp rightward and 2·Wp downward, the locations of real pixels in the source image of the third binning pattern are shifted 2·Wp rightward, and the locations of real pixels in the source image of the fourth binning pattern are shifted 2·Wp downward (see also FIG. 4A). Accordingly, relative to the locations of G, B, and R signals on the color-interpolated image 1261, the locations of G, B, and R signals on the color-interpolated image 1262 are shifted 2·Wp rightward and 2·Wp downward, the locations of G, B, and R signals on the color-interpolated image 1263 are shifted 2·Wp rightward, and the locations of G, B, and R signals on the color-interpolated image 1264 are shifted 2·Wp downward. Consequently, relative to interpolated pixel positions with respect to the color-interpolated image 1261, interpolated pixel positions with respect to the color-interpolated images 1262 to 1264 are shifted by amounts equivalent to the shifts just mentioned.

For example, as for the source image 1252 corresponding to the left portion of FIG. 61 etc., attention is paid to block 1242 encompassing positions [x, y] fulfilling the inequalities “4≦x≦9” and “4≦y≦9,” and from the G signals of real pixels belonging to block 1242, interpolated G signals are generated with respect to two interpolated pixel positions set on the color-interpolated image 1262. Of these two interpolated pixel positions, one is the center-of-gravity position [5.5, 7.5] of the pixel positions of real pixels P[4, 8], P[5, 9], P[5, 5], and P[8, 8] having G signals in the source image 1252, and the other is the center-of-gravity position [7.5, 5.5] of the pixel positions of real pixels P[8, 4], P[9, 5], P[5, 5], and P[8, 8] having G signals in the source image 1252.

The interpolated G signal at the interpolated pixel position set at position [5.5, 7.5] is the average of the pixel values of real pixels P[4, 8], P[5, 9], P[5, 5], and P[8, 8] in the source image 1252, and the interpolated G signal at the interpolated pixel position set at position [7.5, 5.5] is the average of the pixel values of real pixels P[8, 4], P[9, 5], P[5, 5], and P[8, 8] in the source image 1252. Moreover, the G signals of real pixels P[x, y] in source image 1252 are, as they are, taken as the G signals at positions [x, y] in the color-interpolated image 1262.

The block of attention is then, starting at block 1242, shifted four pixels in the horizontal or vertical direction at a time, and every time such a shift is done, similar generation of interpolated G signals is performed. In this way, G signals on the color-interpolated image 1262 as shown in the left portion of FIG. 68 are generated. In similar manners, by generating interpolated B and R signals, B and R signals on the source image 1262 as shown in the middle and right portions of FIG. 68 are generated.

FIG. 67 is a diagram showing locations of G, B, and R signals on the color-interpolated image 1261, and FIG. 68 is a diagram showing locations of G, B, and R signals on the color-interpolated image 1261. By a method similar to that by which the color-interpolated image 1261 (or 1262) is generated from the source image 1251 (or 1252), the color-interpolated images 1263 and 1264 are generated from the source images 1253 and 1254, though no diagrams like FIG. 67 etc. are given that correspond to the color-interpolated images 1263 and 1264.

In FIG. 67, G, B, and R signals on the color-interpolated image 1261 are indicated by circles, and the reference signs in the circles represent the G, B, and R signals corresponding to those circles. In FIG. 68, G, B, and R signals on the color-interpolated image 1262 are indicated by circles, and the reference signs in the circles represent the G, B, and R signals corresponding to those circles. G, B, and R signals in the color-interpolated image 1261 will be represented by the symbols G1_{i,j}, B1_{i,j,} and R1_{i,j} respectively, and G, B, and R signals in the color-interpolated image 1262 will be represented by the symbols G2_{i,j}, B_{1,j}, and R2_{1,j} respectively. Here, i and j are integers. G1_{i,j} and G2_{i,j} will also be used as symbols representing the values of G signals (a similar note applies to B1_{i,j}, B2_{i,j}, R1_{i,j}, and R2_{i,j}).

The i and j in the notation for the color signals G1_{1,j}, B1_{i,j}, and R_{i,j} of a pixel of attention in the color-interpolated image 1261 represent the horizontal and vertical pixel numbers, respectively, of the pixel of attention in the color-interpolated image 1261 (a similar note applies to the notation for color signals G2_{i,j}, B2_{i,j}, and R2_{i,j}).

A description will now be given of the array of color signals G1_{i,j}, B1_{i,j}, and R1_{i,j} in the color-interpolated image 1261.

As shown in the left portion of FIG. 67, at position [2, 2] in the color-interpolated image 1261, a G signal is present that is equal to the pixel signal at position [2, 2] in the source image 1251. This position [2, 2] is taken as the G signal reference position, and the G signal at the G signal reference position will be identified by G1_{1, 1}.

Starting at the G signal reference position (position [2, 2]), scanning G signals on the color-interpolated image 1261 rightward encounters color signals G1_{1, 1}, G1_{2,1}, G_{3, 1}, G1_{4, 1}, . . . in this order. It is here assumed that, in this rightward scanning, the scanning line has a width of Wp. Accordingly, the position [3.5, 1.5] at which G signal G1_{2,1} is supposed to be present lies on that scanning line.

Starting at the G signal reference position (position [2, 2]), scanning G signals on the color-interpolated image 1261 downward encounters color signals G1_{1, 1}, G1_{1, 2}, G1_{1, 3}, G1_{1, 4}, . . . in this order. It is here assumed that, in this downward scanning, the scanning line has a width of Wp. Accordingly, the position [1.5, 3.5] at which G signal G1_{1, 2} is supposed to be present lies on that scanning line.

Likewise, when an arbitrary position on the color-interpolated image 1261 at which a G signal G1_{i,j} is present is taken as a starting position, starting at that position, scanning G signals on the color-interpolated image 1261 rightward encounters color signals G1_{i,j}, G1_{i-1,j}, G1_{i+2,j}, G1_{i+3,j}, . . . in this order; and starting at the same position, scanning G signals on the color-interpolated image 1261 downward encounters color signals G1_{i,j}, G1_{i,j+1}, G1_{i,j+1}, G1_{i,j+3}, . . . in this order. It is here assumed that, in this rightward and downward scanning, the scanning line has a width of Wp.

As shown in the middle portion of FIG. 67, at position [1, 2] in the color-interpolated image 1261, a B signal is present that is generated from the B signals of a plurality of real pixels on the source image 1251. This position [1, 2] is taken as the B signal reference position, and the B signal at the B signal reference position will be identified by B1_{1, 1}.

Starting at the B signal reference position (position [1, 2]), scanning B signals on the color-interpolated image 1261 rightward encounters color signals B1_{1, 1}, B1_{2,1}, B1_{3, 1}, B1_{4, 1}, . . . in this order. Starting at the B signal reference position, scanning B signals on the color-interpolated image 1261 downward encounters color signals B1_{1, 1}, B1_{1, 2}, B1_{1, 3}, B1_{1, 4}, . . . in this order. Likewise, when an arbitrary position on the color-interpolated image 1261 at which a B signal B1_{i,j} is present is taken as a starting position, starting at that position, scanning B signals on the color-interpolated image 1261 rightward encounters color signals B1_{i,j}, B1_{i+1,j}, B1_{i+2,j}, B1_{i+3,j}, . . . in this order; and starting at the same position, scanning B signals on the color-interpolated image 1261 downward encounters color signals B1_{i,j}, B1_{i,j+1}, B1_{i,j+2}, B1_{i,j+3}, . . . in this order.

As shown in the right portion of FIG. 67, at position [2, 1] in the color-interpolated image 1261, an R signal is present that is generated from the R signals of a plurality of real pixels on the source image 1251. This position [2, 1] is taken as the R signal reference position, and the R signal at the R signal reference position will be identified by R1_{1, 1}.

Starting at the R signal reference position (position [2, 1]), scanning R signals on the color-interpolated image 1261 rightward encounters color signals R1_{1, 1}, R1_{2,1}, R1_{3, 1}, R1_{4, 1}, . . . in this order. Starting at the R signal reference position, scanning R signals on the color-interpolated image 1261 downward encounters color signals R1_{1, 1}, R1_{1, 2}, R1_{1, 3}, R1_{1, 4}, . . . in this order. Likewise, when an arbitrary position on the color-interpolated image 1261 at which an R signal R1_{i,j} is present is taken as a starting position, starting at that position, scanning R signals on the color-interpolated image 1261 rightward encounters color signals R1_{i,j}, R1_{i+1,j}, R1_{i+2,j}, R1_{i+3,j}, . . . in this order; and starting at the same position, scanning R signals on the color-interpolated image 1261 downward encounters color signals R1_{i,j}, R1_{i,j+1}, R1_{i,j+2}, R1_{i,j+3}, . . . in this order.

While the foregoing describes how color signals G1_{i,j}, B1_{i,j}, and R1_{i,j} are arrayed in the color-interpolated image 1261, color signals G2_{i,j}, B2_{i,j}, and R2_{i,j} in the color-interpolated image 1262 are arrayed in a similar manner. To determine how G2_{i,j}, B2_{i,j}, and R2_{i,j} are arrayed, all that needs to be done is to read, in the above description, the source image 1251 and the color-interpolated image 1261 as the source image 1252 and the color-interpolated image 1262 respectively and “G1”, “B1,” and “R1” as “G2”, “B2,” and “R2” respectively. The following, however, should be noted: as shown in FIG. 68, the G, B, and R signal reference positions in the color-interpolated image 1262 are positions [4, 4], [3, 4], and [4, 3] respectively, and thus the G signal at position [4, 4], the B signal at position [3, 4], and the R signal at position [4, 3] are G2_{1, 1}, B2_{1, 1} and R2_{1, 1} respectively.

The locations of color signals in the color-interpolated image 1261 will now be defined more specifically.

As shown in the left portion of FIG. 67, the color-interpolated image 1261 has G signals at positions [2+4n_{A}, 2+4n_{B}], [3+4n_{A}, 3+4n_{B}], [3.5+4n_{A}, 1.5′4ₗ_{B}], and [1.5+4n_{A}, 3.5+4n_{B}] (where n_{A} and n_{B} are integers).

In the color-interpolated image 1261,

the G signal at position [2+4n_{A}, 2+4n_{B}] is represented by G1_{i,j} with (i, j)=((2+4n_{A})/2, (2+4n_{B})/2);

the G signal at position [3+4n_{A}, 3+4n_{B}] is represented by G1₁, with (i, j)=((4+4n_{A})/2, (4+4n_{B})/2);

the G signal at position [3.5+4n_{A}, 1.5+4n_{B}] is represented by G1_{i,j} with (i, j)=((4+4n_{A})/2, (2+4n_{B})/2); and

the G signal at position [1.5+4n_{A}, 3.5+4n_{B}] is represented by G1_{i,j} with (i, j)=((2+4n_{A})/2, (4+4n_{B})/2).

Moreover, as shown in the middle and right portions of FIG. 67, the color-interpolated image 1261 has a B signal at position [2n_{A}−1, 2n_{B}], and has an R signal at position [2n_{A}, 2n_{B}−1] (where n_{A} and n_{B} are integers). In the color-interpolated image 1261, the B signal at position [2n_{A}−1, 2n_{B}] is represented by B1_{i,j} with (i,j)=(n_{A}, n_{B}), and the R signal at position [2n_{A}, 2n_{B}−1] is represented by R1_{i,j} with (i, j)=(n_{A}, n_{B}).

The location of color signals in the color-interpolated image 1262 will now be defined more specifically.

As shown in the left portion of FIG. 68, the color-interpolated image 1262 has G signals at positions [4+4n_{A}, 4+4n_{B}], [5+4n_{A}, 5+4n_{B}], [5.5+4n_{A}, 3.5′4n_{B}], and [3.5+4n_{A}, 5.5+4n_{B}] (where n_{A} and n_{B} are integers).

In the color-interpolated image 1262,

the G signal at position [4+4n_{A}, 4+4n_{B}] is represented by G2_{i,j} with (i, j)=((2+4n_{A})/2, (2+4n_{B})/2);

the G signal at position [5+4n_{A}, 5+4n_{B}] is represented by G2_{i,j} with (i, j)=((4+4n_{A})/2, (4+4n_{B})/2);

the G signal at position [5.5+4n_{A}, 3.5+4n_{B}] is represented by G2_{i,j} with (i, j)=((4+4n_{A})/2, (2+4n_{B})/2); and

the G signal at position [3.5+4n_{A}, 5.5+4n_{B}] is represented by G2_{i,j} with (i, j)=((2+4n_{A})/2, (4+4n_{B})/2).

Moreover, as shown in the middle and right portions of FIG. 68, the color-interpolated image 1262 has a B signal at position [2n_{A}−1, 2n_{B}], and has an R signal at position [2n_{A}, 2n_{B}−1] (where n_{A} and n_{B} are integers). In the color-interpolated image 1262, the B signal at position [2n_{A}+1, 2n_{B}+2] is represented by B2_{i,j} with (i, j)=(n_{A}, n_{B}), and the R signal at position [2n_{A}+2, 2n_{B}+1] is represented by R2_{i,j} with (i, j)=(n_{A}, n_{B}).

### [Motion Detection Section]

A description will now be given of the function of the motion detection section 153 in FIG. 58. As described previously, based on the image data of the (n−1)th and nth color-interpolated images, the motion detection section 153 finds an optical flow between the two color-interpolated images. In Example 1, the binning pattern used is changed from one to the next among a plurality of binning patterns on a frame-by-frame basis, and thus the binning patterns corresponding to the (n−1)th and nth color-interpolated images differ. For example, of the (n−1)th and nth color-interpolated images, one is generated from the source image of the first binning pattern, and the other is generated from the source image of the second binning pattern.

As an example, a description will be given of a method of deriving an optical flow between the color-interpolated image 1261 shown in FIG. 67 etc. and the color-interpolated image 1262 shown in FIG. 68 etc. As shown in FIG. 69, the motion detection section 153 first generates a luminance image 1261Y from the R, G, and B signals of the color-interpolated image 1261 and a luminance image 1262Y from the R, G, and B signals of the color-interpolated image 1261. A luminance image is a grayscale image containing luminance signals alone. The luminance images 1261Y and 1262Y are each formed by arraying pixels having a luminance signal at even intervals in both the horizontal and vertical directions. In FIG. 69, each Y indicates a luminance signal.

The luminance signal of a pixel of attention on the luminance image 1261Y is derived from G, B, and R signals located at or close to the pixel of attention on the color-interpolated image 1261. For example, to generate the luminance signal at position [4, 4] on the luminance image 1261Y, the G signal at position [4, 4] is calculated from G signals G1_{2, 2}, G1_{3, 3}, G1_{3, 2} and G1_{2, 3} in the color-interpolated image 1261 by linear interpolation, the B signal at position [4, 4] is calculated from B signals B1_{2, 2} and B1_{3, 2} in the color-interpolated image 1261 by linear interpolation, and the R signal at position [4, 4] is calculated from R signals R1_{2, 2} and R1_{2, 3} in the color-interpolated image 1261 (see FIG. 67). Then, from the G, B, and R signals at position [4, 4] as calculated based on the color-interpolated image 1261, the luminance signal at position [4, 4] in the luminance image 1261Y is calculated. The luminance signal calculated is handled as the luminance signal of the pixel present at position [4, 4] on the luminance image 1261Y.

To generate the luminance signal at position [4, 4] on the luminance image 1262Y, the B signal at position [4, 4] is calculated from B signals B2_{1, 1} and B2^{1, 1} in the color-interpolated image 1262 by linear interpolation, and the R signal at position [4, 4] is calculated from R signals R2_{1, 1} and R2_{1, 2} in the color-interpolated image 1262 by linear interpolation. As the G signal at position [4, 4], G signal G2_{1, 1} in the color-interpolated image 1262 is used as it is (see FIG. 68, left portion). Then, from G signal G2_{1, 1} and the B and R signals at position [4, 4] as calculated based on the color-interpolated image 1262, the luminance signal at position [4, 4] in the luminance image 1262Y is calculated. The luminance signal calculated is handled as the luminance signal of the pixel present at position [4, 4] on the luminance image 1262Y.

The pixel located at position [4, 4] on the luminance image 1261Y and the pixel located at position [4, 4] on the luminance image 1262Y correspond to each other. While the foregoing discusses a method of calculating the luminance signal at position [4, 4], the luminance signals at other positions are calculated by a similar method. In this way, the luminance signals at arbitrary positions [x, y] on the luminance image 1261Y and the luminance signals at arbitrary positions [x, y] on the luminance image 1262Y are calculated.

After generating the luminance images 1261Y and 1262Y, the motion detection section 153 then, by comparing luminance signals in the luminance image 1261Y with luminance signals in luminance image 1262Y, finds an optical flow between the luminance images 1261Y and 1262Y. Examples of methods for deriving an optical flow include a block matching method, a representative point matching method, and a gradient method. The found optical flow is expressed by a motion vector representing a movement of a subject (object), as observed on the image, between the luminance images 1261Y and 1262Y. The motion vector is a two-dimensional quantity representing the direction and magnitude of the movement. The motion detection section 153 takes the optical flow found between the luminance images 1261Y and 1262Y as an optical flow between the images 1261 and 1262, and records it as the result of motion detection to the memory 157.

As much of the results of motion detection between adjacent frames as necessary is stored in the memory 157. For example, the result of motion detection between the (n−3)th and (n−2)th color-interpolated images, the result of motion detection between the (n−2)th and (n−1)th color-interpolated images, and the result of motion detection between the (n−1)th and nth color-interpolated images are stored in the memory 157, so that by reading those results from the memory 157 and blending them, it is possible to find an optical flow (motion vector) between arbitrary two of the (n−3)th to nth color-interpolated images.

An “optical flow (or motion vector) between the luminance images 1261Y and 1262Y” denotes an “optical flow (or motion vector) between the luminance image 1261Y and the luminance image 1262Y.” Similar designations will be used when an optical flow, a motion vector, a movement, or anything related to any of those is discussed with respect to a plurality of images other than the luminance images 1261Y and 1262Y. Accordingly, for example, an “optical flow between the color-interpolated and blended images 1261 and 1262” denotes an “optical flow between the color-interpolated image 1261 and the blended image 1262.”

### [Image Blending Section]

A description will now be given of the function of the image blending section 154 in FIG. 58. The image blending section 154 generates an output blended image based on the color signals of the color-interpolated image outputted from the color interpolation section 151, the color signals of one or more other blended images stored in the frame memory 152, and the results of motion detection stored in the memory 157.

An output blended image is generated by referring to a plurality of color-interpolated images corresponding to different binning patterns, taking as a blending reference image one of those color-interpolated images referred to, and blending those color-interpolated images together. In the process, if the binning pattern corresponding to the color-interpolated image used as the blending reference image changes with time, even a subject that is stationary in the real space appears to be moving in a series of output blended images. To avoid this, when a series of output blended images is generated, the image data read from the frame memory 152 is so controlled that the binning pattern corresponding to the color-interpolated image used as the blending reference image remains the same. A color-interpolated image that is not used as a blending reference image will be called a non-blending-reference image.

Consider now a case where source images of the first and second binning patterns are shot alternately, color-interpolated images generated from source images of the first binning pattern are taken as blending reference images, and color-interpolated images generated from source images of the second binning pattern are taken as non-blending-reference images. Accordingly, when (n−3)th, (n−2)th, (n−1)th, and nth source images are source images of the first, second, first, and second binning patterns respectively, the color-interpolated images based on the (n−3)th and (n−1)th source images are taken as blending reference images, and the color-interpolated images based on the (n−2)th and nth source images are taken as non-blending-reference images. Moreover, in Example 1, it is assumed that there is no subject movement, as observed on the image, between two consecutive (temporally adjacent) color-interpolated images.

Under these assumptions, with reference to FIGS. 70, 71, and 72, a description will be given of the processing for generating one output blended image 1270 from the color-interpolated image 1261 shown in FIG. 67 and the color-interpolated image 1262 shown in FIG. 68. FIG. 70 is a diagram showing G, B, and R signals on the color-interpolated images 1261 and 1262 for generating G, B, and R signals on the output blended image 1270; FIG. 72 is a diagram showing the locations of G, B, and R signals on the output blended image 1270; and FIG. 71 is a diagram showing B and R signals on the color-interpolated images 1261 and 1262 for generating B and R signals on the output blended image 1270.

As shown in FIG. 72, the output blended image 1270 is a two-dimensional image having pixels (pixel positions) arrayed at even intervals in both the horizontal and vertical directions, and G, B, and R signals are present at each of the pixel positions at which the individual pixels of the output blended image 1270 are located. That is, as distinct from source images and color-interpolated images, in the output blended image 1270, G, B, and R signals, one each, are assigned to each pixel position at which one pixel is located. As shown in FIG. 72, the center position of a pixel on the output blended image 1270 is located at position [2i−0.5, 2j−0.5] on the image coordinate plane XY (see FIG. 4B) (where i and j are integers). The G, B, and R signals of the output blended image 1270 at position [2i−0.5, 2j−0.5] will be represented by Go_{i,j}, Bo_{i,j}, and Ro_{i,j} respectively. Go_{i,j} will also be used as a symbol representing the value of a G signal (a similar note applies to Bo_{i,j} and Ro_{i,j}).

The i and j in the notation for the color signals Go_{i,j}, Bo_{i,j}, and Ro_{i,j} of a pixel of attention in the output blended image represent the horizontal and vertical pixel numbers, respectively, of the pixel of attention in the output blended image.

As described previously with reference to FIGS. 67 and 68, as a result of the color-interpolated images 1261 and 1262 corresponding to different binning patterns, between those images, G signals are located at different positions, B signals are located at different positions, and R signals are located at different positions. Based on these differences, the image blending section 154 mixes the G, B, and R signals of the color-interpolated image 1261 and the G, B, and R signals of the color-interpolated image 1262 to generate the G, B, and R signals of the output blended image 1270.

Specifically, the G, B, and R signal values Go_{i,j}, Bo_{i,j}, and Ro_{i,j} of the output blended image 1270 are calculated through weighted addition of the G, B, and R signal values of the color-interpolated image 1261 and the G, B, and R signal values of the color-interpolated image 1262 according to Equations (E1) to (E3) below.

[Equation 14]

Go_{i,j}=(G1_{i,j}+G2_{i-1,j-1})/² (E1)

Bo_{i,j}=(3×B1_{i,j}+B2_{i,j-2})/⁴ (E2)

Ro_{i,j}=(3×R1_{i,j}+R2_{i-2,j})/⁴ (E3)

Instead of Equations (E2) and (E3), Equations (E4) and (E5) corresponding to FIG. 71 may be used to calculate the B and R signal values Bo_{i,j} and Ro_{i,j}.

[Equation 15]

Bo_{i,j}=(B1_{i+1,j-1}+3×B2_{i-1,j-1})/⁴ (E4)

Ro_{i,j}=(R1_{i-1,j+1}+3×R2_{i-1,j-1})/⁴ (E5)

As a specific example, FIGS. 70 and 71 show how color signals Go_{3, 3}, Bo_{3, 3} and Ro_{3, 3} located at position [5.5, 5.5] are generated. In FIGS. 70 and 71, the positions at which color signals Go_{3, 3}, Bo_{3, 3} and Ro_{3, 3} are supposed to be present are indicated by stars.

G signal Go_{3, 3} is generated, as shown in the left portion of FIG. 70, by mixing G signal G1_{3, 3} located at position [6, 6] and G signal G2_{2, 2} located at position [5, 5].

B signal Bo_{3, 3} is generated, as shown in the middle portion of FIG. 70, by mixing B signal B1_{3, 3} located at position [5, 6] and B signal B2_{3, 1} located at position [7, 4], or as shown in the left portion of FIG. 71, by mixing B signal B1_{4, 2} located at position [7, 4] and B signal B2_{2, 2} located at position [5, 6].

R signal Ro_{3, 3} is generated, as shown in the right portion of FIG. 70, by mixing R signal R1_{3, 3} located at position [6, 5] and R signal R2_{1, 3} located at position [4, 7], or as shown in the right portion of FIG. 71, by mixing R signal R1_{2, 4} located at position [4, 7] and R signal R2_{2, 2} located at position [6, 5]

The mixing ratio in which G1_{3, 3} and G2_{2, 2} are mixed to calculate Go_{3, 3},

the mixing ratio in which B1_{3, 3} and B2_{3, 1} are mixed to calculate Bo_{3, 3},

the mixing ratio in which B1_{4, 2} and B2_{2, 2} are mixed to calculate Bo_{3, 3},

the mixing ratio in which R1_{3, 3} and R2_{1, 3} are mixed to calculate Ro_{3, 3}, and

the mixing ratio in which R1_{2, 4} and R2_{2, 2} are mixed to calculate Ro_{3, 3}

are similar to the mixing ratio in which V_{G1} and V_{G2} are mixed to calculate V_{GT} as described with reference to Equation (A1) presented under the heading [Basic Method for Color Interpolation] in connection with Example 1 of Embodiment 1 (see also FIG. 12A).

For example, when B1_{3, 3} and B2_{3, 1} are mixed to generate signal Bo_{3, 3} located at position [5.5, 5.5], since the ratio of the distance d₁ from the position [5, 6] at which B1_{3, 3} is located to position [5.5, 5.5] to the distance d₂ from the position [7, 4] at which B2_{3, 1} is located to position [5.5, 5.5] is d₁:d₂=1:3, as given by Equation (E2), B1_{3, 3} and B2_{3, 1} are mixed in a ratio of 3:1. That is, the signal value at position [5.5, 5.5] is calculated by linear interpolation based on the signal values at positions [5, 6] and [7, 4].

By a method similar to that by which color signals Go_{3, 3}, Bo_{3, 3} and Ro_{3, 3} are calculated, color signals Go_{i,j,}, Bo_{i,j}, and Ro_{i,j} at other positions are calculated, and thereby the G, B, and R signals at individual pixel positions in the output blended image 1270 are calculated as shown in FIG. 72.

To follow is a discussion of the benefits of a technique, like the one described above, of generating an output blended image. If, for the sake of discussion, source images are obtained by an all-pixel reading method, as discussed earlier with reference to FIG. 6A etc., all that needs to be done to calculate the pixels of a pixel of attention by interpolation is to mix the pixel signals of pixels neighboring the pixel of attention in an equal ratio (at equal proportions); through this mixing, an interpolated pixel is generated at the position where a pixel signal is supposed to be located. Here, a “position where a pixel signal is supposed to be located” denotes a position [i, j] at which i and j are integers.

In Example 1, however, the source images actually fed from the AFE 12 to the color interpolation section 151 are source images obtained by use of the first, second, third, and fourth binning patterns. In this case, if equal-ratio mixing is performed as in a case where an all-pixel reading method is used, interpolated pixel signals are generated at positions (for example, the interpolated pixel position 1301 or 1302 in the left portion of FIG. 59) different from those at which pixel signals are supposed to be located, and in addition, on the color-interpolated image generated by the mixing, pixels having G signals are located at uneven intervals (see FIG. 67, left portion). In addition, on a single color-interpolated image, color signals are located at different positions among G, B, and R signals (see FIG. 67).

In the conventional technique corresponding to FIG. 84, to avoid such unevenness, first, interpolation is so performed as to make the pixel intervals even (see FIG. 84, blocks 902 and 903), and then demosaicing is performed. Here, performing interpolation to make the pixel intervals even inevitably invites degradation in perceived resolution (degradation in practical resolution). On the other hand, in Example 1 of the invention, the unevenness is exploited, that is, an output blended image is generated by use of a plurality of color-interpolated images in which color signals are located at uneven intervals. Even though color signals are located at uneven intervals in the color-interpolated images, the pixel intervals in the output blended image are even. Thus, as in an output image obtained by a conventional technique (see FIG. 84, block 905), jaggies and false colors are suppressed. In addition, in Example 1 of the invention, the omission of interpolation for making pixel intervals even (see FIG. 84, blocks 902 and 903) suppresses the degradation in perceived resolution. Thus, compared with the conventional technique shown in FIG. 84, enhanced perceived resolution is obtained.

Although the foregoing deals with a method of generating an output blended image by blending two color-interpolated images based on source images of the first and second binning patterns, the number of color-interpolated images used to generate one output blended image may be three or more (this applies equally to the other practical examples presented later). For example, one output blended image may be generated from four color-interpolated images based on source images of the first to fourth binning patterns. It should however be noted that, among the plurality of color-interpolated images for generating one output blended image, the corresponding binning patterns differ (this applies equally to the other practical examples presented later).

### Example 2

Next, a second practical example (Example 2) will be described. While Example 1 assumes that there is no subject motion whatsoever as observed on the image between two color-interpolated images obtained consecutively, Example 2 will discuss the configuration and operation of the image blending section 154 with consideration given to a subject motion. FIG. 73 is a block diagram of part of the imaging device 1 in FIG. 1 according to Example 2. FIG. 73 includes an internal block diagram of the video signal processing section 13A, which here serves as the video signal processing section 13 in FIG. 1, and in addition an internal block diagram of the image blending section 154.

The image blending section 154 in FIG. 73 includes a weight coefficient calculation section 161 and a blending section 162. Except for the weight coefficient calculation section 161 and the blending section 162, the configuration and operation within the video signal processing section 13A are the same as described in connection with Example 1, and accordingly the following description mainly deals with the operation of the weight coefficient calculation section 161 and the blending section 162. Unless inconsistent, any description given in connection with Example 1 applies equally to Example 2.

Consider now a case where, as in Example 1, source images of the first and second binning patterns are shot alternately, color-interpolated images generated from source images of the first binning pattern are taken as blending reference images, and color-interpolated images generated from source images of the second binning pattern are taken as non-blending-reference images. In Example 2, however, a subject, as observed on the image, can move between the two color-interpolated images obtained consecutively. Under these assumptions, a description will now be given of the processing for generating one output blended image 1270 from the color-interpolated image 1261 shown in FIG. 67 etc. and the color-interpolated image 1262 shown in FIG. 68 etc.

The weight coefficient calculation section 161 reads from the memory 157 the motion vector found between the color-interpolated images 1261 and 1262, and based on the magnitude |M| of the motion vector, calculates a weight coefficient w. At this time, the weight coefficient w is so calculated that the greater the magnitude |M|, the smaller the weight coefficient w. The upper limit (weight coefficient maximum value) and the lower limit of the weight coefficient w (and also w_{i,j} discussed later) are set at 0.5 and 0 respectively.

FIG. 74 is a diagram showing an example of the relationship between the weight coefficient w and the magnitude |M|. When this exemplary relationship is adopted, the weight coefficient w is calculated according to the equation “w=−L·|M|+0.5.” Here, within the range |M|>0.5/L, w=0. L is the gradient in the relational equation of |M| with respect to w, and has a predetermined positive value.

The optical flow found by the motion detection section 153 between the color-interpolated images 1261 and 1262 is composed of a bundle of motion vectors at different positions on the image coordinate plane XY. For example, the entire image region of each of the color-interpolated images 1261 and 1262 is divided into a plurality of partial image regions, and for each of these partial image regions, one motion vector is found. Consider now a case where, as shown in FIG. 75A, the entire image region of an image 1260, which may be the color-interpolated image 1261 or 1262, is divided into nine partial image regions AR₁ to AR₉, and for each of partial image regions AR₁ to AR₉, one motion vector is found. Needless to say, the number of partial image regions may be other than 9. As shown in FIG. 75B, the motion vectors found for partial image regions AR₁ to AR₉ between the color-interpolated images 1261 and 1262 will be represented by M₁ to M₉ respectively. The magnitudes of motion vectors M₁ to M₉ will be represented by |M₁| to |M₉| respectively.

Based on the magnitudes |M₁| to |M₉| of motion vectors M₁ to M₉, the weight coefficient calculation section 161 calculates weight coefficients w at different positions on the image coordinate plane XY. The weight coefficient w for the horizontal and vertical pixel numbers i and j will be represented by w_{i,j}. The weight coefficient w_{i,j} is the weight coefficient for the pixel (pixel position) that has color signals Go_{i,j}, Bo_{i,j}, and Ro_{i,j}, and is calculated from the motion vector with respect to the partial image region to which that pixel belongs. Accordingly, for example, if the pixel position [1.5, 1.5] at which G signal Go_{1, 1} is located belongs to partial image region AR₁, then the weight coefficient w_{1, 1} is calculated based on the magnitude |M₁| according to the equation “w_{1, 1}=−L·|M₁|+0.5” (though, in the range |M₁>0.5/L, w_{1, 1}=0). Likewise, if the pixel position [1.5, 1.5] at which G signal Go_{1, 1} is located belongs to partial image region AR₂, then the weight coefficient w_{1, 1} is calculated based on the magnitude |M₂| according to the equation “w_{1, 1}=−L·|M₂|+0.5” (though, in the range |M₂|>0.5/L, w_{1, 1}=0).

The blending section 162 blends the G, B, and R signals of the color-interpolated image with respect to the current frame as outputted from the color interpolation section 151 and the G, B, and R signals of the blended image with respect to the previous frame as stored in the frame memory 152 in a ratio commensurate with the weight coefficient w_{i,j} calculated at the weight coefficient calculation section 161, and thereby generates the output blended image 1270 with respect to the current frame.

As shown in FIG. 76A, in a case where the color-interpolated image with respect to the current frame is the color-interpolated image 1261 corresponding to FIG. 67 etc. and the color-interpolated image with respect to the previous frame is the color-interpolated image 1262 corresponding to FIG. 68 etc., the blending section 162 calculates the G, B, and R signal values Go_{i,j}, Bo_{i,j}, and Ro_{i,j} of the output blended image 1270 through weighted addition of the G, B, and R signal values of the color-interpolated image 1261 and the G, B, and R signal values of the color-interpolated image 1262 according to Equations (F1) to (F3) below. Instead of Equations (F2) and (F3), Equations (F4) and (F5) may be used to calculate the B and R signal values Bo_{i,j} and Ro_{i,j}.

[Equation 16]

Go_{i,j}=(1.0−w_{i,j})×G1_{i,j}+w_{i,j}×G2_{i-1,j-1} (F1)

Bo_{i,j}=((1.0−w_{i,j})×3×B1_{i,j}+w_{i,j}×B2_{i,j-2})/² (F2)

Ro_{i,j}=((1.0−w_{i,j})×3×R1_{i,j}+w_{i,j}×R2_{i-2,j})/² (F3)

[Equation 17]

Bo_{i,j}=((1.0−w_{i,j})×B1_{i+1,j-1}+w_{i,j}×3×B2_{i-1,j-1})/² (F4)

Ro_{i,j}=((1.0−w_{i,j})×R1_{i-1,j+1}+w_{i,j}×3×R2_{i-1,j-1})/² (F5)

On the other hand, as shown in FIG. 76B, in a case where the color-interpolated image with respect to the current frame is the color-interpolated image 1262 corresponding to FIG. 68 etc. and the color-interpolated image with respect to the previous frame is the color-interpolated image 1261 corresponding to FIG. 67 etc., the blending section 162 calculates the G, B, and R signal values Go_{i,j}, Bo_{i,j}, and Ro_{i,j} of the output blended image 1270 through weighted addition of the G, B, and R signal values of the color-interpolated image 1261 and the G, B, and R signal values of the color-interpolated image 1262 according to Equations (G1) to (G3) below. Instead of Equations (G2) and (G3), Equations (G4) and (G5) may be used to calculate the B and R signal values Bo_{i,j} and Ro_{i,j}.

[Equation 18]

Go_{i,j}=w_{i,j}×G1_{i,j}+(1.0−w_{i,j})×G2_{i-1,j-1} (G1)

Bo_{i,j}=(w_{i,j}×3×B1_{i,j}+(1.0−w_{i,j})×B2_{i,j-2})/² (G2)

Ro_{i,j}=(w_{i,j}×3×R1_{i,j}+(1.0−w_{i,j})×R2_{i-2,j})/² (G3)

[Equation 19]

Bo_{i,j}=(w_{i,j}×B1_{i+1,j-1}+(1.0−w_{i,j})×3×B₂_{i-1,j-1})/² (G4)

Ro_{i,j}=(w_{i,j}×R1_{i-1,j+1}+(1.0−w_{i,j})×3×R2_{i-1i,j-i})/² (G5)

When an output blended image is generated by blending together the color-interpolated image with respect to the current frame and the color-interpolated image with respect to the current frame, if a motion of a subject between the two color-interpolated images is comparatively large, the output blended image will have blurred edges, or double images. To avoid this, if a motion vector between the two color-interpolated images is comparatively large, the contribution factor of the previous frame in the output blended image is reduced. This suppresses occurrence of blurred edges and double images in the output blended image.

In the example described above, weight coefficients w_{i,j} at different positions on the image coordinate plane XY are set; instead, only one weight coefficient may be set for the blending together of two color-interpolated images, the one weight coefficient being used with respect to the entire image region. For example, the motion vectors M₁ to M₉ are averaged to calculate an average motion vector M_{AVE} representing an average motion of a subject between the color-interpolated images 1261 and 1262, and by use of the magnitude |M_{AVE}| of the average motion vector M_{AVE}, one weight coefficient w is calculated according to the equation “w=−L·|M_{AVE}|+0.5” (though, within the range |M_{AVE}|>0.5/L, w=0). Then, the signal values Go_{i,j}, Bo_{i,j}, and Ro_{i,j} can be calculated according to equations obtained by substituting the weight coefficient w thus calculated by use of |M_{AVE}| for the weight coefficient w_{i,j} in equations (F1) to (F5) and (G1) to (G5).

### Example 3

Next, a third practical example (Example 3) will be described. In Example 3, consideration is given to, in addition to a motion of a subject between different color-interpolated images, the contrast of an image as well. FIG. 77 is a block diagram of part of the imaging device 1 in FIG. 1 according to Example 3. FIG. 77 includes an internal block diagram of a video signal processing section 13B, which here serves as the video signal processing section 13 in FIG. 1.

The video signal processing section 13B includes blocks identified by the reference signs 151 to 153, 154B, 156, and 157, among which those identified by the reference signs 151 to 153, 156, and 157 are the same as those shown in FIG. 58. In FIG. 77, an image blending section 154B includes a contrast amount calculation section 170, a weight coefficient calculation section 171, and a blending section 172. Except for the image blending section 154B, the configuration and operation within the video signal processing section 13B are the same as those within the video signal processing section 13A described in connection with Examples 1 and 2, and accordingly the following description mainly deals with the configuration and operation of the image blending section 154B. Unless inconsistent, any description given in connection with Examples 1 and 2 applies equally to Example 3.

Consider now a case where, as in Example 1 or 2, source images of the first and second binning patterns are shot alternately, color-interpolated images generated from source images of the first binning pattern are taken as blending reference images, and color-interpolated images generated from source images of the second binning pattern are taken as non-blending-reference images. In Example 3, however, as in Example 2, a subject, as observed on the image, can move between the two color-interpolated images obtained consecutively. Under these assumptions, a description will now be given of the processing for generating one output blended image 1270 from the color-interpolated image 1261 shown in FIG. 67 etc. and the color-interpolated image 1262 shown in FIG. 68 etc.

The contrast amount calculation section 170 receives, as input signals, the G, B, and R signals of the color-interpolated image with respect to the current frame as currently outputted from the color interpolation section 151 and the G, B, and R signals of the color-interpolated image with respect to the previous frame as stored in the frame memory 152, and based on these input signals, calculates contrast amounts in different image regions of the current or previous frame. Suppose here that, as shown in FIG. 75A, the entire image region of an image 1260, which may be the color-interpolated image 1261 or 1262, is divided into nine partial image regions AR₁ to AR₉, and for each of partial image regions AR₁ to AR₉, a contrast amount is calculated. Needless to say, the number of partial image regions may be other than 9. The contrast amounts calculated for partial image areas AR₁ to AR₉ will be represented by C₁ to C₉ respectively.

The contrast amount Cₘ (where m is an integer fulfilling 1≦m≦9) used in the blending together of the color-interpolated image 1261 shown in FIG. 67 etc. and the color-interpolated image 1262 shown in FIG. 68 etc. is calculated in the following manner.

For example, attention is paid to the luminance image 1261Y or 1262Y (see FIG. 69) generated from the color signals of the color-interpolated image 1261 or 1262, and the difference between the minimum and maximum luminance values in partial image region ARₘ in the luminance image 1261Y, or the difference between the minimum and maximum luminance values in partial image region ARₘ in the luminance image 1262Y, is calculated, and the calculated difference is handled as the contrast amount Cₘ. Or the average of those differences is calculated as the contrast amount Cₘ.

For another example, the contrast amount Cₘ may be calculated by extracting a predetermined high-frequency component in partial image region ARₘ of the luminance image 1261Y or 1262Y with a high-pass filter. Specifically, for example, the high-pass filter is formed by a Laplacian filter with a predetermined filter size, and by applying the Laplacian filter to individual pixels in partial image region ARₘ of the color-interpolated image 1261 or 1262, spatial filtering is performed. The high-pass filter then yields, sequentially, output values according to the filtering characteristics of the Laplacian filter. The absolute values of the output values from the high-pass filter (the magnitudes of high-frequency components extracted with the high-pass filter) may be added up so that the sum total is taken as the contrast amount Cₘ. It is also possible to handle as the contrast amount Cₘ the average of the total sum calculated for partial image region ARₘ of the luminance image 1261Y and the total sum calculated for partial image region ARₘ of the luminance image 1262Y.

The contrast amount Cₘ calculated as descried above is larger the higher the contrast of the image in the corresponding image region is, and is smaller the lower it is.

Based on the contrast amounts C₁ to C₉, the contrast amount calculation section 170 calculates, for each partial image region, a reference motion value M_{O}, which is involved in the calculation of the weight coefficient. The reference motion value M_{O} calculated for partial image region ARₘ is specially represented by M_{Om}. As shown in FIG. 78A, the reference motion value M_{Om} is set at a minimum motion value M_{OMIN} when the contrast amount Cₘ equals zero, and at a maximum motion value M_{OMAX} when the contrast amount Cₘ is equal to or larger than a predetermined contrast threshold C_{TH}. In the range of 0<Cₘ<C_{TH}, as the contrast amount Cₘ increases from zero to the contrast threshold C_{TH}, the reference motion value M_{Om} increases from the minimum motion value M_{OMIN} to the maximum motion value M_{OMAX}. More specifically, for example, in the rage of 0<Cₘ<C_{TH}, the reference motion value M_{Om} is calculated according to the equation “M_{Om}=Φ·Cₘ+M_{OMIN}” Here, C_{TH}>0, 0<M_{OMIN}<M_{OMAX}, Φ=(M_{OMAX}−M_{OMIN})/C_{TH}.

Based on the reference motion values M_{O1} to M_{O9} calculated at the contrast amount calculation section 170 and the magnitudes |M₁| to |M₉| of motion vectors M₁ to M₉, the weight coefficient calculation section 171 calculates weight coefficients w_{i,j} at different positions on the image coordinate plane XY. The significance of the magnitudes |M₁| to |M₉| of motion vectors M₁ to M₉ is as described in connection with Example 2. The weight coefficient w_{i,j} is the weight coefficient for the pixel (pixel position) having color signals Go_{i,j}, Bo_{i,j}, and Ro_{i,j}, and is determined based on the reference motion value and the motion vector with respect to the partial image region to which that pixel belongs. As described in connection with Example 2, the upper and lower limits of the weight coefficient w_{i,j} are 0.5 and 0 respectively. The weight coefficient w_{i,j} is set within those upper and lower limits, based on the reference motion value and the motion vector. FIG. 78B shows an example of the relationship among the weight coefficient, the reference motion value M_{Om}, and the magnitude |Mₘ| of the motion vector.

Specifically, for example, if the pixel position [1.5, 1.5] at which G signal Go_{1, 1} is located belongs to partial image region AR₁, based on reference motion value M_{O1}, which is based on contrast amount C₁, and the magnitude |M₁| of motion vector M₁, weight coefficient w_{1, 1} is calculated according to the equation “w_{1, 1}=−L·(|M₁|−M_{O1})+0.5.” Here, within the range of |M₁|<M_{O1}, w_{1, 1}=0.5, and within the range of (|M₁|−M_{O1})>0.5/L, w_{1, 1}=0. For another example, if the pixel position [1.5, 1.5] at which G signal Go_{1, 1} is located belongs to partial image region AR₂, based on reference motion value M_{O2}, which is based on contrast amount C₂, and the magnitude |M₂| of motion vector M₂, weight coefficient w_{1, 1} is calculated according to the equation “w_{1, 1}=−L·(|M₂|−M_{O2})+0.5.” Here, within the range of |M₂|<M_{O2}, w_{1, 1}=0.5, and within the range of (|M₂|−M_{O2})>0.5/L, w_{1, 1}=0.

The blending section 172 mixes the G, B, and R signals of the color-interpolated image with respect to the current frame as currently being outputted from the color interpolation section 151 and the G, B, and R signals of the color-interpolated image with respect to the previous frame as stored in the frame memory 152 in a ratio commensurate with the weight coefficient w_{i,j} set at the weight coefficient calculation section 171, and thereby generates the output blended image 1270 with respect to the current frame. The method by which the blending section 172 calculates the G, B, and R signals of the output blended image 1270 is the same as that described in connection with Example 2 as adopted by the blending section 162.

An image region with a comparatively large contrast amount is one containing a large edge component; thus, there, jaggies are more notable, and therefore image blending exerts a marked effect of reducing jaggies. In contrast, an image region with a comparatively small contrast amount is considered to be a flat image region; thus, there, jaggies are less notable (that is, there is less sense in performing image blending). Accordingly, when an output blended image is generated by blending together the color-interpolated image with respect to the current frame and the color-interpolated image with respect to the previous frame, for an image region with a comparatively large contrast amount, the weight coefficient is set comparatively great to increase the contribution factor of the previous frame to the output blended image and, for an image region with a comparatively small contrast amount, the weight coefficient is set comparatively small to reduce the contribution factor of the previous frame to the output blended image. In this way, it is possible to obtain an adequate effect of reducing jaggies only in the part of an image where jaggies reduction is necessary.

### Example 4

Next, a fourth practical example (Example 4) will be described. In Example 4, it is assumed that the compression section 16 (see FIG. 1 etc.) compresses the video signal by use of a compression method conforming to MPEG as described in connection with Example 4 of Embodiment 1. Since an MPEG-conforming method has been described in connection with Example 4 of Embodiment 1, no overlapping description will be repeated (see FIG. 32).

Also in Example 4 of Embodiment 2, as in Example 4 of Embodiment 1, consideration is given to the fact the image quality of an I picture greatly affects the overall image quality of an MPEG movie. Specifically, the number of an image that has a comparatively great weight coefficient set at the image blending section and that is thus judged to have jaggies reduced effectively as a result is recorded to the video signal processing section 13 or the compression section 16, so that at the time of image compression, the output blended image corresponding to the recorded image number is preferentially used as the target of an I picture. In this way, it is possible to enhance the overall image quality of an MPEG movie obtained by compression.

Now, with reference to FIG. 79, a more specific example will be described.

As the video signal processing section 13 according to Example 4, the video signal processing section 13A or 13B shown in FIG. 73 or 77 is used. Consider now the following case: from nth, (n+1)th, (n+2)th, (n+3)th, (n+4)th, . . . source images, the color interpolation section 151 generates nth, (n+1)th, (n+2)th, (n+3)th, (n+4)th, . . . color-interpolated images 1450, 1451, 1452, 1453, 1454; then at the image blending section 154 or 154B, an output blended image 1461 is generated from the color-interpolated images 1450 and 1451, an output blended image 1462 is generated from the color-interpolated images 1451 and 1452, an output blended image 1463 is generated from the color-interpolated images 1452 and 1453, an output blended image 1464 is generated from the color-interpolated images 1453 and 1454, and so forth. For example, the nth, (n+1)th, (n+2)th, (n+3)th, and (n+4)th source images are source images of the first, second, first, second, and first binning patterns respectively. The output blended images 1461 to 1464 constitute a series of output blended images chronologically ordered in the order 1461, 1462, 1463, and 1464.

The technique of generating one output blended image from two color-interpolated images of attention is the same as the one described in connection with Example 2 or 3: through the mixing of color signals according to the weight coefficients ⱼ calculated for the two color-interpolated images of attention, the one output blended image is generated. Here, the weight coefficients w_{i,j} used in the generation of that one output blended image can take different values according to the horizontal and vertical pixel numbers i and j, and the average of those weight coefficients that can take different values is calculated as an overall weight coefficient. The overall weight coefficient is calculated, for example, by the weight coefficient calculation section 161 or weight coefficient calculation section 171 (see FIG. 73 or 77). The overall weight coefficients calculated for the output blended images 1461 to 1464 will be represented by w_{T1} to w_{T4} respectively. As described previously in connection with Example 2, only one weight coefficient may be set for two color-interpolated images of attention, in which case that one weight coefficient may be taken as the overall weight coefficient.

The reference signs 1461 to 1464 identifying the output blended images 1461 to 1464 represent the image numbers of the corresponding output blended images.

The image numbers 1461 to 1464 of the output blended images are, in a form associated with the overall weight coefficients w_{Ti} to w_{T4}, recorded within the video signal processing section 13A or 13B (see FIG. 73 or 77) so that the compression section 16 can refer to them.

An output blended image corresponding to a comparatively great overall weight coefficient is expected to be an image whose color signals are mixed to a comparatively large extent and that has comparatively greatly reduced jaggies and noise. Hence, the compression section 16 preferentially uses an output blended image corresponding to a comparatively great overall weight coefficient as the target of an I picture. Accordingly, out of the output blended images 1461 to 1464, the compression section 16 selects the one with the greatest overall weight coefficient among w_{T1} to w_{T4} as the target of an I picture. For example, if, among w_{T1} to w_{T4}, the overall weight coefficient w_{T2} is the greatest, the output blended image 1462 is selected as the target of an I picture, and based on the output blended image 1462 and the output blended images 1461, 1463, and 1464, P and B pictures are generated. A similar note applies in a case where the target of an I picture is selected from a plurality of output blended images obtained after the output blended image 1464.

The compression section 16 generates an I picture by encoding, by an MPEG-conforming method, an output blended image selected as the target of the I picture, and generates P and B pictures based on the output blended image selected as the target of the I picture and output blended images unselected as the target of the I picture.

### Example 5

Next, a fifth practical example (Example 5) will be described. In Examples 1 to 4, it is assumed that binning patterns P_{A1} to P_{A4} corresponding to FIGS. 7A, 7B, 8A, and 8B are used as the first to fourth binning patterns for acquiring source images. It is however also possible to use binning patterns different from binning patterns P_{A1} to P_{A4} as the binning patterns for acquiring source images. For example, it is possible to use the binning patterns described under the heading [Other Examples of Binning Patterns] in connection with Example 5 of Embodiment 1, namely binning patterns P_{B1} to P_{B4}, binning patterns P_{C1} to P_{C4}, and binning patterns P_{D1} to P_{D4}. Since these binning patterns have been described in connection with Example 5 of Embodiment 1, no overlapping description will be repeated (see FIGS. 35 to 40).

In this practical example, as described in connection with Examples 1 to 4, two or more of the first to fourth binning patterns are selected, and while the binning pattern used in binned reading is changed from one to the next among the selected two or more binning patterns, source images are acquired. For example, in a case where binning patterns P_{B1} to P_{B4} are used as the first to fourth binning patterns, by performing binned reading using binning pattern P_{B1} and binned reading using binning pattern P_{B2} alternately, source images of the binning patterns P_{B1}, P_{B2}, P_{B1}, P_{B2}, and so forth are sequentially acquired.

Moreover, as described in connection with Example 5 of Embodiment 1, a group of binning patterns consisting of binning patterns P_{A1} to P_{A4}, a group of binning patterns consisting of binning patterns P_{B1} to P_{B4}, a group of binning patterns consisting of binning patterns P_{C1} to P_{C4}, and a group of binning patterns consisting of binning patterns P_{D1} to P_{D4} will be represented by P_{A}, P_{B}, P_{C}, and P_{D} respectively.

### Example 6

Next, a sixth practical example (Example 6) will be described. In Example 6, based on the result of detection by the motion detection section, the binning pattern groups used in acquiring source images are switched.

First, the significance of the switching will be described. When a color-interpolated image is generated from a source image, depending on the pixel position, signal interpolation is performed. For example, when the G signal 1311 on the color-interpolated image 1261 shown at the left portion of FIG. 60 is generated, as described previously with reference to the left portion of FIG. 59, signal interpolation is performed by use of the G signals of four real pixels on the source image 1251. On the other hand, the G signal 1313 in the left portion of FIG. 60 is nothing but the G signal of one real pixel on the source image 1251. That is, when the G signal 1313 is generated, no signal interpolation is performed. Performing signal interpolation inevitably invites degradation in perceived resolution (practical resolution).

Accordingly, when a comparison is made between an image composed of color signals obtained through signal interpolation, like the G signal 1311, and an image composed of color signals obtained without signal interpolation, like the G signal 1313, the latter can be said to provide higher perceived resolution (practical resolution) than the former. Thus, in the color-interpolated image 1261 shown in the left portion of FIGS. 60 and 67, the perceived resolution in the direction pointing from upper left to lower right is higher than that in other directions (in particular, the direction pointing from lower left to upper right). This is because G signals G1_{1, 1} G1_{2, 2}, G1_{3, 3} and G1_{4, 4} arrayed in the direction pointing from upper left to lower right are obtained without signal interpolation (see FIG. 67, left portion). Put the other way around, in a color-interpolated image obtained by use of binning pattern P_{B} (see FIGS. 35 and 36), the perceived resolution in the direction pointing from lower left to upper right is higher than that in other directions (in particular, the direction pointing from upper left to lower right).

On the other hand, when there is a motion of a subject as observed on the image in a series of images, an edge perpendicularly intersecting the direction of the motion is likely to be blurred. Out of these considerations, in Example 6, to minimize such blur, based on the results of motion detection performed with respect to past frames, the binning pattern group to be used with respect to the current frame is dynamically selected from a plurality of binning pattern groups.

In connection with a color-interpolated image or a motion vector, the direction pointing from upper left to lower right denotes the direction pointing from position [1, 1] to position [10, 10] on the image coordinate plane XY, and the direction pointing from lower left to upper right denotes the direction pointing from position [1, 10] to position [10, 1] on the image coordinate plane XY. A straight line along the direction pointing from upper left to lower right or along a direction substantially the same as that direction will be called a rightward-down straight line, and a straight line along the direction pointing from lower left to upper right or along a direction substantially the same as that direction will be called a rightward-up straight line (see FIG. 80).

Now, with reference to FIG. 81, a specific description will be given of a switching technology according to Example 6, assuming that the binning patterns used are switched between binning pattern groups P_{A} and P_{B}. In Example 6, as the video signal processing section 13 in FIG. 1, the video signal processing section 13A or 13B shown in FIG. 58 or 73 is used.

In the period in which a source image is acquired by use of binning pattern group P_{A}, by performing binned reading using binning pattern P_{A1} and binned reading using binning pattern P_{A2} alternately, source images of binning patterns P_{A1}, P_{A2}, P_{A1}, P_{A2}, . . . are acquired sequentially, and from two color-interpolated images based on two consecutive source images, one output blended image is generated. Likewise, in the period in which a source image is acquired by use of binning pattern group P_{B}, by performing binned reading using binning pattern P_{B1} and binned reading using binning pattern P_{B2} alternately, source images of binning patterns P_{B1}, P_{B1}, P_{B1}, P_{B2}, . . . are acquired sequentially, and from two color-interpolated images based on two consecutive source images, one output blended image is generated

Consider now a case where, as shown in FIG. 81, from nth, (n+1)th, (n+2)th, (n+3)th, (n+4)th . . . source images 1400, 1401, 1402, 1403, 1404, the color interpolation section 151 generates nth, (n+1)th, (n+2)th, (n+3)th, (n+4)th, . . . color-interpolated images 1410, 1411, 1412, 1413, 1414 . . . .

As described in connection with Example 1, the motion detection section 153 finds a motion vector between consecutive frames. The motion vectors between the color-interpolated images 1410 and 1411, between the color-interpolated images 1411 and 1412, and between the color-interpolated images 1412 and 1413 will be represented by M₀₁, M₁₂, and M₂₃ respectively. It is here assumed that the motion vector M₀₁ is an average motion vector as described in connection with Example 2 which represents an average motion of a subject between the color-interpolated images 1410 to 1411 (a similar note applies to motion vectors M₁₂ and M₂₃).

Suppose that the initial binning pattern group used to acquire source images has been binning pattern group P_{A}, and the binning pattern group used to acquire source images 1400 to 1403 has been binning pattern group P_{A}. In this case, a pattern switching control section (not shown) provided within the video signal processing section 13 or the CPU 23 selects, based on a selection motion vector, the binning pattern group to be used to acquire the source image 1404 from binning pattern groups P_{A} and P_{B}. A selection motion vector is formed by one or more motion vectors obtained before the acquisition of the source image 1404. The selection motion vector includes, for example, motion vector M₂₃, and may further include motion vector M₁₂, or motion vectors M₁₂ and M₀₁. A motion vector obtained earlier than motion vector M₀₁ may further be included in the selection motion vector. Typically, the selection motion vector is formed of a plurality of motion vectors.

In a case where the selection motion vector is formed by a plurality of motion vectors (for example, M₂₃ and M₁₂), the pattern switching control section pays attention to those motion vectors; if all those motion vectors point parallel to a rightward-up straight line, the pattern switching control section switches the binning pattern group used to acquire the source image 1404 from binning pattern group P_{A} to binning pattern group P_{B}, and otherwise performs no such switching so that binning pattern group P_{A} remains as the binning pattern group used to acquire the source image 1404.

Under an assumption different from that described above where the binning pattern group used to acquire source images 1400 to 1403 has been binning pattern group P_{B} and in addition the selection motion vector is formed by a plurality of motion vectors (for example, M₂₃ and M₁₂), the pattern switching control section pays attention to those motion vectors; if all those motion vectors point parallel to a rightward-down straight line, the pattern switching control section switches the binning pattern group used to acquire the source image 1404 from binning pattern group P_{B} to binning pattern group P_{A}, and otherwise performs no such switching so that binning pattern group P_{B} remains as the binning pattern group used to acquire the source image 1404.

In a case where the selection motion vector is formed by motion vector M₂₃ alone, the pattern switching control section pays attention to motion vector M₂₃; for example, if motion vector M₂₃ points parallel to a rightward-up straight line, the pattern switching control section selects binning pattern group P_{B} as the binning pattern group used to acquire the source image 1404, and if motion vector M₂₃ points parallel to a rightward-down straight line, the pattern switching control section selects binning pattern group P_{A} as the binning pattern group used to acquire the source image 1404,

As described above, variably setting the binning pattern group used makes it possible to use the optimal binning pattern group according to a subject movement on the image, and thus to optimize the image quality of the series of output blended images.

Processing for inhibiting frequent change of the binning pattern groups used for acquisition of source images may be added. For example, as shown in FIG. 81, when the binning pattern group used to acquire a source image 1403 is binning pattern group P_{A} and the binning pattern group used to acquire the source image 1404 is changed from binning pattern group P_{A} to binning pattern group P_{B}, binning pattern group P_{B} may be kept being used for a prescribed number of source images that are acquired after the source image 1404.

The foregoing deals with a case where the binning pattern group used to acquire source images is switched between binning pattern groups P_{A} and binning P_{B}; it is however also possible to switch the binning pattern group used to acquire source images between binning pattern groups P_{A} and P_{C}, or between binning pattern groups P_{B} and binning P_{D}.

### Example 7

In Examples 1 to 6, the pixel signals of a source image are acquired by binned reading. Instead, skipped reading may be used to acquire the pixel signals of a source image. A practical example (seventh) in which the pixel signals of a source image are acquired by skipped reading will now be described as Example 7. Also in cases where the pixel signals of source images are acquired by skipped reading, any description given in connection with Examples 1 to 6 equally applies unless inconsistent.

As is well known, in skipped reading, the photosensitive pixel signals from the image sensor 33 are read in a skipping fashion. In Example 7, skipped reading proceeds while the skipping pattern used to acquire source images is changed from one to the next among a plurality of skipping patterns, and by blending together a plurality of color-interpolated images obtained by use of different skipping patterns, one output blended image is generated. For example, as skipping patterns, it is possible to use those described under the heading [Skipping Pattern] in connection with Example 6 of Embodiment 1, namely skipping patterns Q_{A1} to Q_{A4}, skipping patterns Q_{B1} to Q_{B4}, skipping patterns Q_{C1} to Q_{C4}, and skipping patterns Q_{D1} to Q_{D4}. Since these skipping patterns have been described in connection with Example 6 of Embodiment 1, no overlapping description will be repeated (see FIGS. 41 to 48).

Moreover, as described in connection with Example 6 of Embodiment 1, a group of skipping patterns consisting of skipping patterns Q_{A1} ^{to} Q_{A4}, a group of skipping patterns consisting of skipping patterns Q_{B1} to Q_{B4}, a group of skipping patterns consisting of skipping patterns Q_{C1} to Q_{C4}, and a group of skipping patterns consisting of skipping patterns Q_{D1} to Q_{D4} will be represented by Q_{A}, Q_{B}, Q_{C}, and Q_{D} respectively.

As an example, a description will be given of the processing for generating an output blended image by use of skipping pattern group Q_{A} consisting of skipping patterns Q_{A1} to Q_{A4}. As the video signal processing section 13 according to Example 7, it is possible to use the video signal processing section 13A shown in FIG. 58 or 73 or the video signal processing section 13B shown in FIG. 77.

As will be understood from FIGS. 42 and 9A to 9D, when a comparison is made between a source image acquired by skipped reading using skipping patterns Q_{A1} to Q_{A4} and a source image acquired by binned reading using binning patterns P_{A1} to P_{A4}, the locations of G, B, and R signals are the same between the two source images. A difference is that, relative to the latter source image, the locations of G, B, and R signals in the former source image are shifted Wp rightward and Wp downward (see FIG. 4A). Accordingly, whenever any of the description given above which assumes binned reading is applied to an imaging device that adopts skipped reading, all that needs to be done is to correct for those shifts.

Except for the presence of the shifts, the two source images (the source image corresponding to FIG. 42 and the source image corresponding to FIGS. 9A to 9D) can be handled as being equivalent, and therefore any description given in connection with Examples 1 to 4 applies, as it is, equally to Example 7. Basically, all that needs to be done is to read “binning patterns” and “binned reading” in the description of Examples 1 to 4 as “skipping patterns” and “skipped reading” respectively.

Specifically, for example, assuming that skipping patterns Q_{A1} and Q_{A2} are used as the first and second skipping patterns respectively, by use of the first and second skipping patterns alternately, source images of the first and second skipping patterns are obtained alternately. Then, the source images obtained by use of the skipping patterns are subjected to color interpolation as described in connection with Example 1 to generate color-interpolated images at the color interpolation section 151, and are also subjected to motion detection as described in connection with Example 1 to detect motion vectors between consecutive frames at the motion detection section 153. Then, based on those motion vectors detected, by one of the methods described in connection with Examples 1 to 3, one output blended image is generated from the plurality of color-interpolated images at the image blending section 154 or 154B. A series of output blended images based on a series of source images obtained by skipped reading may be subjected to an image compression technology as described in connection with Example 4.

Also when skipped reading is used, the technology described in connection with Example 6 functions effectively. In a case where the technology described in connection with Example 6 is applied to Example 7, which adopts skipped reading, all that needs to be done is to read “binning patterns” and “binning pattern groups” in the description of Example 6 as “skipping patterns” and “skipping pattern groups,” and accordingly to replace the symbols representing binning patterns and binning pattern groups with symbols representing skipping patterns and skipping pattern groups. Specifically, all that needs to be done is to read binning pattern groups P_{A}, P_{B}, P_{C}, and P_{D} in Example 6 as skipping pattern groups Q_{A}, Q_{B}, Q_{C}, and Q_{D} respectively, and to read binning patterns P_{A1}, P_{A2}, P_{B1}, and P_{B2} in Example 6 as skipping patterns Q_{A1}, Q_{A2}, Q_{B1}, and Q_{B2} respectively.

In this practical example, it is possible to adopt a binning-skipping pattern as described under the heading [Binning-Skipping Pattern] in connection with Example 6 of Embodiment 1. For example, as a binning-skipping pattern, the first binning-skipping pattern may be adopted. Since the first binning-skipping pattern was described in connection with Example 6 of Embodiment 1, no overlapping description will be repeated (see FIGS. 49 and 50).

Also in a case where a binning-skipping method is used, it is possible to set a plurality of different binning-skipping patterns, read photosensitive pixel signals while the binning-skipping pattern used to acquire source images is changed from one to the next among the plurality of binning-skipping patterns, and blend together a plurality of color-interpolated images corresponding to different binning-skipping patterns, to generate one blended image.

### Example 8

In the practical examples described above, a plurality of color-interpolated images are blended together, and an output blended image obtained by the blending is fed to the signal processing section 156. The blending here may be omitted, in which case the R, G, and B signals of one color-interpolated image may be fed, as the R, G, and B signals of one converted image, to the signal processing section 156. A practical example (eighth) involving no blending as just mentioned will now be described as Example 8. Unless inconsistent, any description given in connection with the practical examples described above applies equally to Example 8. Since no blending is involved, however, no technology related to blending is applied to Example 8.

As the video signal processing section 13 according to Example 8, a video signal processing section 13C shown in FIG. 82 can be used. The video signal processing section 13C includes a color interpolation section 151, a signal processing section 156, and an image conversion section 158. The functions of the color interpolation section 151 and the signal processing section 156 are the same as those described previously.

The color interpolation section 151 performs the color interpolation described above on the source image represented by the output signal from the AFE 12, and thereby generates a color-interpolated image. The R, G, and B signals of the color-interpolated image generated at the color interpolation section 151 are fed to the image conversion section 158. From the R, G, and B signals of the color-interpolated image fed to it, the image conversion section 158 generates the R, G, and B signals of a converted image. The signal processing section 156 converts the R, G, and B signals of the converted image generated at the image conversion section 158 into a video signal composed of a luminance signal Y and color difference signals U and V. The video signal (Y, U, and V signals) obtained by the conversion is delivered to the compression section 16, where it is compressed-encoded by a predetermined image compression method. By feeding the video signal of a series of converted images from the image conversion section 158 to the display section 27 in FIG. 1 or a display device not shown, it is possible to display the series of color-interpolated images as a moving image.

Whereas in the practical examples described above, the G, B, and R signals at position [2i−0.5, 2j−0.5] in the output blended image 1270 are represented by Go_{i,j}, Bo_{i,j}, and Ro_{i,j} respectively (see FIG. 72), in Example 8 the G, B, and R signals at position [2i−0.5, 2j−0.5] in the converted image from the image conversion section 158 will be represented by Go_{i,j , Bo}_{i,j}, and Ro_{i,j} respectively.

Now, with reference to FIG. 83, the operation of the video signal processing section 13C will be described by way of a specific example. Consider now a case where binning patterns P_{A1} and P_{A2} are used as the first and second binning patterns (see FIGS. 7A and 7B), and source images of the first and second binning patterns are shot alternately. nth, (n+1)th, (n+2)th and (n+3)th source images are acquired sequentially. It is here assumed that the nth, (n+1)th, (n+2)th and (n+3)th source images are source images of the first, second, first, and second binning patterns respectively, and in addition that the color-interpolated images generated from the nth and (n+1)th source images are the color-interpolated images 1261 and 1262 (see FIGS. 67 and 68). It is further assumed that the converted images from the image conversion section 158 as generated from the color-interpolated images 1261 and 1262 are converted images 1501 and 1502 respectively.

In Example 1, the G, B, and R signals of the color-interpolated image 1261 and the G, B, and R signals of the color-interpolated image 1262 are mixed with consideration given to the fact that, between the color-interpolated images 1261 and 1262, the locations of G signals differ, moreover the locations of B signals differ, and moreover the locations of R signals differ (see Equation (E1) etc.).

In Example 8, based on those differences, the image conversion section 158 calculates the G, B, and R signal values of the converted image 1501 according to Go_{i,j}=G1_{i,j}, Bo_{i,j}=B1_{i,j}, and Ro_{i,j}=R1_{i,j} and calculates the G, B, and R signal values of the converted image 1502 according to Go_{i,j}=G2_{i-1,j-1}, Bo_{i,j}=B2_{i-1,j-1}, and Ro_{i,j}=R2_{i-1,j-i}. When the color-interpolated image based on the (n+2)th source image also is the color-interpolated image 1261, the G, B, and R signal values of the converted image based on the (n+2)th source image also are calculated according to Bo_{i,j}=B1_{i,j} and Ro_{i,j}=R1_{i,j}. Likewise, when the color-interpolated image based on the (n+3)th source image also is the color-interpolated image 1262, the G, B, and R signal values of the converted image based on the (n+3)th source image also are calculated according to Go_{i,j}=G2_{i-1,j-1}, Bo_{i,j}=B2_{i-1,j-1} and Ro_{i,j}=R2_{i-1,j-1}.

Relative to the positions [2i−0.5, 2j−0.5] of the signals Go_{i,j}, Bo_{i,j}, and Ro_{i,j} in the converted images, the positions of the signals G1_{i,j}, B1_{i,j}, and R1_{i,j} in the color-interpolated image 1261 are slightly shifted, and the positions of the signals G2_{i-1,j-1}, B2_{i-1,j-1} and R2_{i-1,j-1} in the color-interpolated image 1262 also are slightly shifted.

These shifts cause degradation in image quality, such as jaggies, in the converted images so long as these are observed each independently as a still image. Since, however, the image conversion section 158 generates converted images sequentially at the frame period, when a series of converted images is observed as a moving image, the user perceives almost no such degradation in image quality, though depending on the frame period. This is for the same reason as one can hardly perceive any flickering of video in an interlaced moving image, owing to vision persistence in the human eye.

On the other hand, between the converted images 1501 and 1502, the color signals at the same position [2i−0.5, 2j−0.5] have different sampling points. For example, the sampling point (position [6, 6]) of G signal G1_{3, 3} in the color-interpolated image 1261, which will be used as G signal Go_{3, 3} at position [5.5, 5.5] in the converted image 1501, differs from the sampling point (position [5, 5]) of G signal G1_{2, 2} in the color-interpolated image 1262, which will be used as G signal Go_{3, 3} at position [5.5, 5.5] in the converted image 1502. When a series of converted images including these converted images 1501 and 1502 is displayed, owing to vision persistence in the eye, the user recognizes the image information at both sampling points simultaneously. This serves to compensate for degradation in image quality resulting from binned reading (in a case where skipped reading is performed, degradation in image quality resulting from skipped reading) of photosensitive pixel signals. In addition, the absence of interpolation for making pixel intervals even (see FIG. 84, blocks 902 and 903) helps suppress degradation in perceived resolution. Thus, compared with the conventional technique shown in FIG. 84, enhanced perceived resolution is obtained.

The processing for generating a series of converted images including the converted images 1501 and 1502 is beneficial when the frame period is comparatively high (for example, when the frame period is 1/60 seconds). When the frame period is low (for example, when the frame period is 1/30 seconds) beyond vision persistence in the eye, it is preferable to generate output blended images based on a plurality of color-interpolated images as described with respect to Examples 1 to 7.

A block that realizes the function of the video signal processing section 13C shown in FIG. 82 and a block that realizes the function of the video signal processing section 13A or 13B shown in FIG. 73 or 77 may be incorporated in the video signal processing section 13 in FIG. 1, so that whichever of the two blocks suits the frame period is used. Specifically, for example, when the frame period is longer than a predetermined reference period (for example, 1/30 seconds), the former block is brought into operation so that the image conversion section 158 outputs a series of converted images; when the frame period is equal to or shorter than the predetermined reference period, the latter block is brought into operation so that the image blending section 154 or 154B outputs a series of output blended images.

Although the foregoing deals with an example in which binning patterns P_{A1} and P_{A2} are used as the first and second binning patterns and source images of binning patterns P_{A1} and P_{A2} are acquired alternately, it is also possible to use binning patterns P_{A1} to P_{A4} as the first to fourth binning patterns and acquire source images of binning patterns P_{A1} to P_{A4} sequentially and repeatedly. In this case, source images are acquired by use of binning patterns P_{A1}, P_{A2}, P_{A3}, P_{A4}, P_{A1}, P_{A2}, . . . sequentially, and the image conversion section 158 sequentially outputs converted images based on the source images of binning patterns P_{A1}, P_{A2}, P_{A3}, P_{A4}, P_{A1}, P_{A2}, . . . . As a binning pattern group consisting of a first to a fourth binning pattern, instead of binning pattern group P_{A} consisting of binning patterns P_{A1} to PA₄, it is possible to use, binning pattern group P_{B} consisting of binning patterns P_{B1} to P_{B4}, binning pattern group P_{C} consisting of binning patterns P_{C1} to P_{C4}, or binning pattern group P_{D} consisting of binning patterns P_{D1} to P_{D4} (see FIG. 35 etc.).

The video signal processing section 13C may be additionally provided with the frame memory 152, the motion detection section 153, and the memory 157 shown in FIG. 58 so that, as described in connection with Example 6, the binning pattern groups used to acquire source images are switched according to the motion detection result from the motion detection section 153. For example, as described in connection with Example 6 (see FIG. 81), the imaging device 1 is so configured that the binning pattern group used is switched between binning pattern groups P_{A} and P_{B}. Then, assuming that color-interpolated images 1410 to 1414 are obtained from source images 1400 to 1404, the binning pattern group used to acquire the source image 1404 may be selected, by the method described in connection with Example 6, from binning pattern groups P_{A} and P_{B} based on a selection motion vector including motion vector M₂₃.

Moreover, as Examples 1 to 6 can be modified like Example 7, so can the configuration described above in connection with Example 8 be applied to skipped reading. In that case, all that needs to be done is to read “binning patterns” and “binning pattern groups” in the above description of Example 8 as “skipping patterns” and “skipping pattern groups,” and accordingly to replace the symbols representing binning patterns and binning pattern groups with symbols representing skipping patterns and skipping pattern groups (specifically, all that needs to be done is to read binning pattern groups P_{A}, P_{B}, P_{C}, and P_{D} as skipping pattern groups Q_{A}, Q_{B}, Q_{C}, and Q_{D} respectively, and to read binning patterns P_{A1}, P_{A2}, P_{B1}, and P_{B2} as skipping patterns Q_{A1}, Q_{A2}, Q_{B1}, and Q_{B2} respectively.

It should however be noted that, as described in connection with Example 7, when a comparison is made between a source image acquired by skipped reading using skipping patterns Q_{A1} to Q_{A4} and a source image acquired by binned reading using binning patterns P_{A1} to P_{A4}, the locations of G, B, and R signals are the same between the two source images, but, relative to the latter source image, the locations of G, B, and R signals in the former source image are shifted Wp rightward and Wp downward (see FIGS. 4A, 9A, 42, etc.). Similar shifts are present also between binning pattern group P_{B} and skipping pattern group Q_{B} etc. Accordingly, in a case where skipped reading is performed, the description given in connection with Example 8 above needs to be corrected for those shifts.

### <<Modifications and Variations>>

The specific values given in the description above are merely examples, which, needless to say, may be modified to any other values. In connection with Embodiments 1 and 2 described above, modified examples or supplementary explanations applicable to them will be given below in Notes 1 to 3. Unless inconsistent, any part of these notes may be combined with any other.

### [Note 1]

The binning patterns described above may be modified in many ways. In the binned reading method described above, four photosensitive pixel signals are added up to form one pixel on a source image. Instead, any other number of photosensitive pixel signals than four (for example, nine or sixteen photosensitive pixel signals) may be added up to form one pixel on a source image.

Likewise, the skipping patterns described above may be modified in many ways. In the skipping reading method described above, photosensitive pixel signals are skipped in groups of two in the horizontal and vertical directions. Instead, photosensitive pixel signals may be skipped in groups of any other number. For example, photosensitive pixel signals may be skipped in groups of four in the horizontal and vertical directions.

### [Note 2]

The imaging device 1 in FIG. 1 can be realized in hardware, or in a combination of hardware and software. In particular, all or part of the processing performed in the video signal processing section (13, 13a to 13c, 13A to 13C) may be realized in the form of software. Needless to say, the video signal processing section may be built in the form of hardware alone. In a case where the imaging device 1 is built on a software basis, a block diagram showing a part realized in software serves as a functional block diagram of that part.

### [Note 3]

For example, the following interpretations are possible. When a source image is acquired, the CPU 23 in FIG. 1 controls what binning pattern or skipping pattern to use; under this control, signals to become the pixel signals of the source image are read from the image sensor 33. Thus, the source image acquiring means for acquiring a source image may be thought of as being realized mainly by the CPU 23 and the video signal processing section 13, and the source image acquiring means may be thought of as incorporating reading means for performing binned or skipped reading. A binning-skipping method, which is a combination of a binned reading method and a skipped reading method, is, as described above, a kind of binned or skipped reading method, and therefore a binning-skipping pattern by a binned reading method may be thought of as a kind of binned or skipped pattern, and the reading of photosensitive pixel signals by a binned reading method may be thought of as a kind of binned or skipped reading.

### LIST OF REFERENCE SIGNS

1 Imaging Device

11 Image Shooting Section

12 AFE

13, 13a to 13c, 13A to 13C Video Signal Processing Section

16 Compression Section

33 Image Sensor

51, 151 Color Interpolation Section

52, 52c, 152 Frame Memory

53, 153 Motion Detection Section

54, 54b, 54c, 154, 154B Image Blending Section

55, 55c Color Reconstruction Section

56, 156 Signal Processing Section

157 Memory

158 Image Conversion Section

61, 71, 161, 171 Weight Coefficient Calculation Section

62, 72, 162, 172 Blending Section

70 Image Characteristics Amount Calculation Section

170 Contrast amount calculation section

1. An image processing device comprising:
a source image acquiring section which performs binned reading or skipped reading of pixel signals of a group of photosensitive pixels arrayed two-dimensionally in an image sensor for a single-panel configuration, and which thereby acquires source images sequentially;
a color interpolation section which, for each of the source images, mixes pixel signals of a same color included in a group of pixel signals of the source images, and which thereby generates color-interpolated images sequentially that have pixel signals obtained by the mixing; and
a destination image generation section which generates destination images based on the color-interpolated images,
wherein the source image acquiring section uses a plurality of reading patterns having different combinations of photosensitive pixels targeted by binning or skipping, so as to generate the source images sequentially such that pixel positions at which pixel signals are present differ between frames.

2. The image processing device according to claim 1, wherein
the destination image generation section comprises:
a storage section which temporarily stores a predetermined image inputted thereto and then outputs the predetermined image; and
an image blending section which blends together the predetermined image outputted from the storage section and the color-interpolated images, and which thereby generates preliminary images, and
the destination images are generated based on the preliminary images, or the preliminary images are taken as the destination images.

3. The image processing device according to claim 2, wherein
the destination image generation section further comprises a motion detection section which detects a motion of an object between the color-interpolated images and the predetermined image that are blended together at the image blending section, and
the image blending section generates the preliminary images based on magnitude of the motion.

4. The image processing device according to claim 3, wherein
the image blending section comprises:
a weight coefficient calculation section which calculates a weight coefficient based on the magnitude of the motion detected by the motion detection section; and
a blending section which generates the preliminary images by mixing pixel signals of the color-interpolated images and the predetermined image according to the weight coefficient.

5. The image processing device according to claim 4, wherein
the image blending section further comprises an image characteristics amount calculation section which calculates, with respect to the color-interpolated images, an image characteristics amount indicating a characteristic of pixels neighboring a pixel of attention, and
the weight coefficient calculation section sets the weight coefficient based on the magnitude of the motion and the image characteristics amount.

6. The image processing device according to claim 4, wherein
the image blending section further comprises a contrast amount calculation section which calculates a contrast amount of at least one of the color-interpolated images and the predetermined image, and
the weight coefficient calculation section sets the weight coefficient based on the magnitude of the motion of the object as detected by the motion detection section and the contrast amount.

7. The image processing device according to claim 2, wherein
the color-interpolated images and the preliminary images are images having one pixel signal present at every interpolated pixel position and, between the color-interpolated images and the preliminary images, locations of corresponding pixel signals within the images are equal or shifted by a predetermined magnitude,
the destination image generation section further comprises a color reconstruction section which applies color reconstruction to the preliminary images to make a plurality of pixel signals of different colors present at every interpolated pixel position, and which thereby generates the destination images,
the storage section temporarily stores the preliminary images as the predetermined image and then outputs the preliminary images to the image blending section, and
the image blending section mixes corresponding pixel signals of the color-interpolated images and the preliminary images, and thereby generates new preliminary images.

8. The image processing device according to claim 1, wherein
the color-interpolated images are images having one pixel signal present at every interpolated pixel position,
the destination image generation section further comprises:
a color reconstruction section which applies color reconstruction to the color-interpolated images to make a plurality of pixel signals of different colors present at every interpolated pixel position, and which thereby generates color-reconstructed images;
a storage section which temporarily stores the destination images outputted from the destination image generation section, and which then outputs the destination images; and
an image blending section which blends together the destination images outputted from the storage section and the color-reconstructed images, and which thereby generates new destination images,
between the color-reconstructed images and the destination images, locations of corresponding pixel signals within the images are equal or shifted by a predetermined magnitude, and
the image blending section mixes corresponding pixel signals of the color-reconstructed images and the destination images, and thereby generates the new destination images.

9. The image processing device according to claim 2, wherein
the color-interpolated images outputted from the color interpolation section are inputted to the image blending section, and are also inputted as the predetermined image to the storage section, and
the image blending section blends together the color-interpolated images outputted from the color interpolation section and the color-interpolated images outputted from the storage section, and thereby generates the destination images.

10. The image processing device according to claim 1, wherein
the destination image generation section comprises an image conversion section which applies image conversion to the color-interpolated images to make a plurality of pixel signals of different colors present at every interpolated pixel position, and thereby generates the destination images.

11. The image processing device according to claim 1, wherein
a group of pixel signals of the color-interpolated images includes pixel signals of a plurality of colors including a first color, and intervals of particular interpolated pixel positions at which pixel signals of the first color are present are uneven.

12. The image processing device according to claim 11, wherein
when one of the source images on which interest is currently being focused is called a source image of interest, the one of the color-interpolated images which is generated from the source image of interest is called a color-interpolated image of interest, and pixel signals of one color on which interest is currently being focused is called pixel signals of a color of interest,
the color interpolation section sets the particular interpolated pixel positions at positions different from pixel positions at which the pixel signals of the color of interest are present on the source image of interest, and generates as the color-interpolated image of interest an image having the pixel signals of the color of interest at the particular interpolated pixel positions,
when the color-interpolated image of interest is generated, based on a plurality of pixel positions on the source image of interest at which the pixel signals of the color of interest are present, a plurality of the pixel signals of the color of interest at those pixel positions are mixed, and thereby the pixel signals of the color of interest at the particular interpolated pixel positions are generated, and
the particular interpolated pixel positions are set at center-of-gravity positions of a plurality of pixel positions at which the pixel signals of the color of interest are present on the source image of interest.

13. The image processing device according to claim 12, wherein
the color interpolation section mixes a plurality of the pixel signals of the color of interest of the source image of interest in an equal ratio, and thereby generates the pixel signals of the color of interest at the particular interpolated pixel positions.

14. The image processing device according to claim 11, wherein
the destination image generation section generates each of the destination images based on a plurality of the color-interpolated images generated from a plurality of the source images,
the destination images have pixel signals of a plurality of colors at each of interpolated pixel positions arrayed evenly, and
the destination image generation section generates the destination images based on differences in the particular interpolated pixel positions among a plurality of the color-interpolated images due to a plurality of the color-interpolated images corresponding to different reading patterns.

15. The image processing device according to claim 1, wherein
acquisition of a plurality of the source images by use of a plurality of the reading patterns is performed repeatedly, and thereby a series of chronologically ordered destination images is generated at the destination image generation section, and
the image processing device further comprises an image compression section which applies image compression to the series of destination images, and which thereby generates a compressed moving image including an intra-coded picture and a predictive-coded picture, and
based on how the destination images constituting the series of destination images are generated, the image compression section selects from the series of destination images a destination image to be handled as a target of the intra-coded picture.

16. The image processing device according to claim 1, wherein
a plurality of the destination images generated by the destination image generation section are outputted as a moving image.

17. The image processing device according to claim 1, wherein
there are a plurality of groups each including a plurality of reading patterns having different combinations of photosensitive pixels targeted by binning or skipping,
the image processing device further comprises a motion detection section which detects a motion of an object between a plurality of the color-interpolated images, and
based on direction of the motion detected by the motion detection section, a group of reading patterns used to acquire the source images is set variably.

18. An imaging device comprising:
an image sensor for a single-panel configuration; and
the image processing device according to claim 1.

19. An image processing method comprising:
a first step of performing binned reading or skipped reading of pixel signals of a group of photosensitive pixels arrayed two-dimensionally in an image sensor for a single-panel configuration by use of a plurality of reading patterns having different combinations of photosensitive pixels targeted by binning or skipping, and thereby acquiring source images sequentially such that pixel positions at which pixel signals are present differ between frames;
a second step of mixing pixel signals of a same color included in a group of pixel signals of the source images obtained in the first step, and thereby generating color-interpolated images sequentially that have pixel signals obtained by the mixing; and
a third step of generating destination images based on the color-interpolated images generated in the second step.
